(19) United States
(12) Patent Application Publication
(10) Pub. No.: US 2003/0220867 A1
(43) Pub. Date: Nov. 27, 2003

(54) Systems and methods for trading and originating financial products using a computer network

(76) Inventors: Thomas R. Goodwin, Hamilton, MA (US); J. Kingsley Greenland, Norfolk, MA (US); Bruce K. Hounsell, Boston, MA (US); William J. Jakubowski, Boston, MA (US)

Correspondence Address: SONG K. JUNG, McKenna Long & Aldridge LLP, 1900 K Street, NW, Washington, DC, 20006, US

(21) Appl. No.: 10/371,226

(22) Filed: Feb. 24, 2003

Related U.S. Application Data
(63) Continuation-in-part of application No. 09/928,109, filed on Aug. 10, 2001.
(60) Provisional application No. 60/224,240, filed on Aug. 10, 2000.

(51) Int. Cl. G06F 17/60

(52) U.S. Cl. 705/37

(57) ABSTRACT

The invention relates to systems and methods for trading products and services over a computer network, such as the Internet. In one embodiment, the invention provides a method for trading financial products over a computer network. The item information is received from a seller, the item information is displayed to an interested user, and a bid is displayed to users if the bid is acceptable. The close of the bidding is extended by a predetermined amount of time if a new bid is entered within a certain period of time. Users of the system receive updates of the status of the bidding on an item. Items can be offered to bidders by each individual component of the item or the components can be offered in aggregate. The system can selectively display the bid history of an item to selected users, and the system can track the users by certain user information, as well as block a certain user's access to the system based on the user's information.

### CROSS REFERENCE TO RELATED APPLICATION

This application is a continuation-in-part of U.S. Non-Provisional application Ser. No. 09/928,109 entitled “System and Method for Trading and Originating Commercial Loans Using a Computer Network” filed Aug. 10, 2001, which claims priority to U.S. Provisional Application Serial No. 60/224,240 entitled “System and Method for Trading and Originating Commercial Loans Using a Computer Network” filed Aug. 10, 2000, the contents of both of which are incorporated herein by reference in their entirety.

### FIELD OF THE INVENTION

Embodiments of the present invention generally relate to systems and methods for trading or auctioning products, such as commercial loans or real assets such as boats, and services such as software development. More specifically, embodiments of the present invention are directed to a data processing system for buying, selling, trading, originating and providing information on such products and services over a computer network, such as the Internet. More specifically, embodiments of the present invention are directed to a data processing system which contains improved operating abilities which aid the bidder, the seller and the trading entity, such as an auction house, in the conduct of that auction.

### BACKGROUND OF THE INVENTION

Auctions have long been held as a way for a seller of a product or service to obtain the highest price for the item they are selling. There are many types of auctions, such as a closed auction, a Dutch auction and an English forward auction. An English forward auction allows bidders to submit successively increasing bids until the auction closes. The bidder holding the highest bid at the close of the auction, wins the offering or item being auctioned. A typical English forward auction begins with the seller setting a reserve price and a minimum bid. The reserve price is the minimum amount the seller will accept in return for the item being offered, and the minimum bid is the smallest increase in a bid a new bidder must make for an item in order for the bid to be accepted by the seller and/or the auction house. Next a bidder makes a bid for the item being offered. If the bid offered meets the minimum bid, that bid will typically be accepted and automatically becomes the current high bid subject to existing proxy bids as explained herein.

After the first bid is accepted, the next bid in an English forward auction will be accepted only if it meets or exceeds the minimum bid. At this point the new bid must at least equal if not exceed the amount of the current high bid plus the amount of the bid increment. For example, if the current high bid is $15,000, and the bid increment is set at $1,000, a bidder must bid at least $16,000 to become the current high bidder. Bids are typically ranked in order of the amount bid. However, if two bidders submit acceptable bids that are equal in amount, the bidder who first submitted the acceptable bid will be awarded the status of current high bidder. Simply because a bidder is the current high bidder when an auction closes does not mean that bidder will necessarily win that auction. Rather the current high bid must also meet or exceed the seller's reserve price in order to win the auction. If the current high bid fails to meet the reserve price when the auction closes, the seller is typically under no obligation to sell that item to that bidder.

An absolute bid is a single, static bid. Therefore, if a second bidder places a bid that is higher than a first bidder's absolute bid, and the second bidder then becomes the current high bidder, the first bidder must manually submit a new acceptable bid in order to become the current high bidder. Alternatively, the auction entity could provide for a proxy feature, which allows the bidder to specify the maximum amount that he is willing to bid for an offering. For example, in an auction where the reserve price is set at $15,000 and the minimum bid is set at $1,000, Bidder B will replace Bidder A (who opened the bidding at $17,000) as the current high bidder if Bidder B bids $18,000.

However, if Bidder A had previously submitted a proxy bid of $35,000, the auction house or auction system will automatically execute a $19,000 bid on behalf of Bidder A. That $19,000 bid represents an amount equal to the current high bid plus the minimum bid, thereby overtaking Bidder B and making Bidder A the current high bidder. Thereafter, each time another bidder properly outbids Bidder A, the auction house or auction system will place another proxy bid on behalf of Bidder A until Bidder A's maximum of $35,000 is reached. In order to thereafter become the current high bidder again, Bidder A would have to manually submit a new bid. However, Bidder A would not know of this need to manually submit a new bid in excess of his proxy maximum unless he was not only monitoring the progress of the bidding, but also continually executed a screen refresh of the auction house or auction system's bid status web page.

Therefore, it would be advantageous to have a system which automatically refreshed a bidder's bid status web page with the current status of the bidding in which any bidder was tracking or participating when either there was a change in the bidding status, or when a bidder's proxy maximum had been outbid or upon expiration of a predetermined time period. It would also be advantageous if the auction house or auction system sent alerts to a bidder who was tracking or bidding on an item being auctioned off, but not monitoring that auction live.

Another problem with current auction systems is that an offering with a larger number of items will not obtain as high a price as possible if the items were offered individually. For example, a car collector owns a large collection of rare cars and desires to sell them via an auction. Because of limited available time the seller could only monitor a single aggregate sale of all the cars. While advantageous in terms of time for the seller, it is not advantageous in terms of maximizing her pricing premium because only bidders with large financial resources can participate in the auction. However, smaller bidders who could bid on one or two items contained in the aggregate offering, could serve to drive up the price of the entire offering if their bids could be accepted as a single bid.

Therefore, it would be advantageous if an auction system existed where a number of similar items could be offered both individually and aggregately, whereby the seller could accept the largest total bid, regardless of whether it came from a single bidder on the aggregate offering, or from the sum of all the individual bidders combined.

In certain automated auction systems, the auction house presents parties interested in the auction of a certain item with the bid history of that offering. The bid history typically displays to the other bidders or to interested parties at least the bidder's name, the amount bid by each bidder and the time the bidder placed their bid. However, by providing all the bidders interested in an offering with information regarding the other parties also interested in that offering, such as their user name or handle, the bidders could collude with each other against the seller. Such collusion results in the seller not receiving the absolute highest possible bid for each item they offered for auction. Therefore, it would be advantageous to have an auction system that allowed the seller or the auction system to block single bidder or all bidders from viewing or receiving any or all information regarding the other bidders bidding on a given offering.

Another problem with current auction systems is that although bidders must log onto an auction system using a log-in name and password, that password is typically not secure. For example, competitors for the same item being auctioned off might somehow determine the password of another competitor. They might then use that password to withdraw their competitor's bid, thereby leaving the unscrupulous bidder with the winning bid. Therefore, it would be advantageous to have an auction system which knows the IP address of a given user, and only grants that user access to the auction system if the user's log-in and password are submitted from a previously registered IP address. Even if the IP address were randomly assigned by the Internet provider it would still be advantageous to track the user by that IP address assigned by the Internet provider for the reasons discussed herein.

Similarly, it would be advantageous to be able to track a user by their IP address or other identifiers assigned by the auction system as the users move throughout the auction web site. Tracking the user through the web site allows the auction house to gather data regarding products of interest to the user, and allows subsequent data mining of the data gathered. Additionally, employing a user's IP address or other identifier to determine their identity and whether they are logging in from a pre-approved location, thereby boosting security for all users and the auction house.

When bidders are interested in bidding on a certain offering or item, they typically log onto the auction system and find their way to the web page detailing that specific offering or item. However, once the user receives that information as it exists at that time, the user is not presented any updated information regarding that offering afterwards. Therefore, if the potential bidder wanted to bid on a selected offering, but wanted to wait until the last possible second to do so, he might be lulled into thinking that a certain bid could successfully win the auction. For example, Bidder D pulls up the web page for Offering #443, and that web page lists the current high bid at $550, and states that the time remaining is 1 minute and 20 seconds. Because the figure displayed as the current high bid is not updated by the auction system, Bidder D might be lulled into thinking it is safe to wait until 5 seconds before the close of the auction on Offering #443 to submit a bid of $560. Unfortunately for Bidder D, other bidders could have been placing bids during that last 1 minute and 20 seconds without Bidder D's knowledge. This scenario might result in Bidder D submitting her bid of $560 at 5 seconds prior to the auction closing, but the current high bid with 5 seconds to go before the auction closes is actually $595. Accordingly, Bidder D would lose that auction. Therefore, it would be advantageous if the web page of all bidders interested in the auction of a certain item or offering be updated either after a predetermined amount of time, or each time a new bid is placed on that item or offering.

Another problem with current auction systems is that the seller or auction house will set a date and/or time at which the auction will end. In order to aid the bidders to ensure that their bid is placed prior to the auction's close, the seller or auction entity may choose to display the time remaining during which bids will continue to be accepted by the auction entity. However, bidders will often wait until the last possible second to submit their bid. Doing so presents various disadvantages. For example, if a Bidder G waits until the last possible second to submit his bid, it might not be processed and accepted before the auction period ends. Accordingly, Bidder G will not have his higher bid accepted by the auction system, and loses the auction. Similarly, even if Bidder G's last second bid is accepted by the auction system, Bidder G might still lose the auction to Bidder H if Bidder H had previously submitted a proxy bid with a limit higher than Bidder G's last-second bid. Such an auction system which automatically ends and accepts no more bids after a certain point in time is also disadvantageous to the seller because she could have received a higher price for the item being auctioned if the auction had not ended until every bidder that wished to participate submitted their best and final bid and that bid was accepted.

Therefore, it would be advantageous if an auction system existed which extended the closing of an auction by a predetermined amount of time each time a bidder attempted to submit a new bid, thereby ensuring that every entity submitted their best and final bid.

### SUMMARY OF THE INVENTION

There are several significant problems with current systems which auction off products and services. One problem is that the auction systems fail to refresh a first bidder's web page displaying bid status information either automatically, or after a second bidder places a new bid. Moreover, the current auction systems do not allow for the auctioning of items as either individual offerings or as aggregated offerings. Furthermore, the current auction systems do not provide for the ability to limit the display to a given bidder of the pertinent information regarding the other bidders who are also bidding on the same offering. Nor do the current auction systems provide for either the ability to only allow user's access from a predetermined IP address, or track the users of that system by their IP address as they move throughout the auction system. Furthermore, the current auction systems do not provide for the ability to set the amount of time an auction is automatically extended by if a new bid is received on a given offering.

In at least one embodiment, the present invention provides an auction system which automatically refreshes and updates the bid status web page of all bidders that are interested in a particular offering, either automatically or each time a new bid is placed on that offering. In this embodiment, the refresh of the information screen occurs regardless of whether the new bid was placed by a live bidder, or the bid was a proxy bid placed by the auction system. Moreover, an embodiment of the present invention provides users not actively tracking the auction with remote updates on the progress of bidding so that they can remotely update their bids if necessary.

In at least one embodiment, the present invention provides an auction house with the ability to selectively auction offerings as either individual offerings, or as an aggregate offering, and allows the auction house to accept the highest bid regardless of the format. In this embodiment, the user is informed whether or not a specific individual offering is part of an aggregated offering, thereby allowing the bidder to modify his bidding.

In at least one embodiment, the present invention provides an auction house with the ability to selectively display or not display to a bidder, information regarding other bidders that are bidding on the same offering. Additionally, this embodiment also allows the auction house to view the past bidding history of any given bidder.

In at least one embodiment, the present invention provides an auction system which determines when a new bid is placed on an offering prior to the closing of that offering, and extends the closing period for that specific offering, as well as all its related offerings, by a predetermined period of time.

These and other embodiments of the present invention help to ensure that bidders are not foreclosed from bidding on an offering simply because the time to do so was about to run out. These embodiments also ensure that the seller obtains the highest possible price for its offering or offerings. Moreover, these embodiments prevent bidders from colluding against a seller on a given offering. Furthermore, these embodiments allow the auction house

Furthermore, in at least one embodiment the present invention provides a method for trading products or services of interest over a computer network. The items are offered in an auction by a seller, a bid is received for the item being offered, the bid is displayed to all users of the auction, and the closing of the auction is extended by a period of time if a new bid is received during a predetermined period of time prior to the closing of the auction.

In at least one embodiment, the above method which includes offering an item for sale further includes allowing a bidder to bid on only a portion of the item being offered for sale, or bid on the entire item in aggregate. In another aspect, at least one embodiment of the invention further comprises updating the display of the received bid to display the current highest bid. In another aspect, at least one embodiment of the invention displays a received bid further comprises revealing the bid history for the item to selected users. In another aspect, at least one embodiment of the invention comprises tracking a bidder by their identifying information

In another aspect, in at least one embodiment, the invention comprises a computerized exchange or system for trading items, wherein the exchange is accessible using a computer network, comprising a server in operable communication with a bidder, the server is programmed for receiving requests from a bidder to accept a bid for an item offered for sale, a product and service information database in communication with the server for retrieving information on items meeting the bidder's search criteria, and customer application components for accepting and displaying bids received from the bidder on the items meeting the bidder's search criteria.

In another aspect, in at least one embodiment, the invention comprises a computerized system for trading financial products, comprising means for receiving information about at least one item for sale, the information, including due diligence information capable of fulfilling at least a portion of a request for due diligence on the financial product, means for displaying the information about the item to parties interested in purchasing items that match certain criteria, means for determining whether the bid on the item is acceptable, means for displaying the bid information to users of the system once the bid has been accepted on the item, means for updating the display of users of the system either periodically or when new bid has been accepted, means for extending the close of the exchange or auction of the item being sold by a predetermined amount of time when a new bid has been entered during a predetermined period of time prior to the closing of the exchange or auction; means for offering the item being sold on the exchange or auction either piecemeal (e.g., as components) or offering the item in aggregate; means for selectively displaying the bid history of a certain item being sold on the exchange or auction, and means for tracking a user or blocking the user's access to the exchange or auction based on their user information.

The foregoing and other objects, aspects, features, and advantages of the invention will become more apparent from the following description and from the appendices.

### BRIEF DESCRIPTION OF THE FIGURES

The advantages and aspects of the present invention will be more fully understood in conjunction with the following detailed description and accompanying drawings, wherein:

FIG. 1 is an illustration of a computer system in which at least one embodiment of the present invention can be embodied.

FIG. 2 is a block diagram giving an architectural overview in accordance with one embodiment of the invention.

FIG. 3 is a block diagram providing an overview of the interaction of the system of an embodiment of the invention with buyers, sellers, and third parties.

FIG. 4 is a flow chart illustrating a process for pricing financial product, in accordance with an embodiment of the invention.

FIGS. 5A through 5D are representative screen shots illustrating a form for sellers to list a financial product, in accordance with an embodiment of the invention.

FIG. 6 is a flow chart illustrating a process for searching for a financial product, in accordance with an embodiment of the invention;

FIG. 7 is a representative screen shot illustrating an input form used to search for a financial product, in accordance with an embodiment of the invention;

FIG. 8 is a representative screen shot illustrating the results of a search for a financial product, in accordance with an embodiment of the invention;

FIG. 9 is a representative screen shot illustrating the financial product information provided to a user, in accordance with an embodiment of the invention;

FIG. 10 is another representative screen shot illustrating the financial product information provided to a user, in accordance with an embodiment of the invention;

FIG. 11 is a representative screen show illustrating financial product summary information provided to a user, in accordance with an embodiment of the invention;

FIG. 12 is a representative screen show illustrating financial product statistical information provided to a user, in accordance with an embodiment of the invention;

FIG. 13 is a representative screen show illustrating financial product information provided to a user, in accordance with an embodiment of the invention;

FIG. 14 is a representative screen shot showing an example of a portion of the mortgage note documentation available to a user, in accordance with an embodiment of the invention;

FIG. 15 is a representative screen shot showing an example of a portion of the title insurance documentation available to a user, in accordance with an embodiment of the invention;

FIG. 16 is a representative screen shot showing an example of a picture of a property associated with a financial product for sale, which picture is available to a user, in accordance with an embodiment of the invention;

FIG. 17 is a representative screen shot showing an example of third party information available to a user in accordance with an embodiment of the invention;

FIG. 18 is a flowchart illustrating a process for searching a database of financial products, in accordance with an embodiment of the invention;

FIG. 19 is a flowchart illustrating a process for pricing a financial product, in accordance with an embodiment of the invention;

FIG. 20 is a representative screen shot illustrating a form for pricing a financial product, in accordance with an embodiment of the invention;

FIG. 21 is a representative screen shot illustrating a form for performing a computation on a financial product, in accordance with an embodiment of the invention;

FIG. 22 is a representative screen shot illustrating the results of the computation requested in the screen shot of FIG. 21, in accordance with an embodiment of the invention;

FIG. 23 is a representative screen shot illustrating a spreadsheet showing yearly cash flow, in accordance with an embodiment of the invention;

FIG. 24 is a representative screen shot illustrating a form for performing a foreclosure computation on a financial product, in accordance with an embodiment of the invention;

FIG. 25 is a representative screen shot illustrating the results of the computation requested in the screen shot of FIG. 23, in accordance with an embodiment of the invention;

FIG. 26 is a representative screen shot illustrating a form for performing an extension/restructure computation on a financial product, in accordance with an embodiment of the invention;

FIG. 27 is a representative screen shot illustrating the results of the computation requested in the screen shot of FIG. 25, in accordance with an embodiment of the invention;

FIG. 28 is a representative screen shot illustrating a form for performing a DPO/Early Payoff computation on a financial product, in accordance with an embodiment of the invention;

FIG. 29 is a representative screen shot illustrating the results of the computation requested in the screen shot of FIG. 27, in accordance with an embodiment of the invention;

FIGS. 30A and B are a flowchart illustrating a process for bidding on a financial product, in accordance with an embodiment of the invention.

FIG. 31 is a representative screen shot illustrating loans that are available for bidding, in accordance with an embodiment of the invention;

FIG. 32 is a representative screen shot illustrating the proxy bid form, in accordance with an embodiment of the invention;

FIG. 33 is a representative screen shot illustrating the submit a bid form used by bidders to submit a bid, in accordance with an embodiment of the invention;

FIG. 34 is a representative screen shot illustrating the bid verification form used by bidders to verify their bid, in accordance with an embodiment of the invention;

FIG. 35 is a representative screen shot illustrating the bid not accepted form informing a bidder that their bid had not been accepted, in accordance with an embodiment of the invention;

FIG. 36 is a representative screen shot illustrating that a bid had been accepted and that the bidder was the current high bidder, in accordance with an embodiment of the invention;

FIG. 37 is a representative screen shot illustrating the bid status form, in accordance with an embodiment of the invention;

FIG. 38 is a representative screen shot illustrating the bid status form prior to submitting a bid, in accordance with an embodiment of the invention;

FIG. 39 is a representative screen shot illustrating the bid status form after an new bid had been accepted on an offering, in accordance with an embodiment of the invention;

FIG. 40 is a representative screen shot illustrating the results of a search for given search criteria, in accordance with an embodiment of the invention;

FIG. 41 is a representative screen shot illustrating an aggregate offering, in accordance with an embodiment of the invention;

FIG. 42 is a representative screen shot illustrating the a single offering, in accordance with an embodiment of the invention;

FIG. 43 is a representative screen shot illustrating the status of related items being auctioned, in accordance with an embodiment of the invention;

FIG. 44 is a representative screen shot illustrating a bid form, in accordance with an embodiment of the invention;

FIG. 45 is a representative screen shot illustrating the auction status portion of the bid status form, in accordance with an embodiment of the invention;

FIG. 46 is a representative screen shot illustrating the status of a bidder's best bid on a specific offering and illustrating the bid history link, in accordance with an embodiment of the invention;

FIG. 47 is a representative screen shot illustrating the operation of the bid history link and form, in accordance with an embodiment of the invention; and

FIG. 48 is a flowchart illustrating the operation of the automatic extension of the closing of an auction, in accordance with an embodiment of the invention.

FIG. 49 is a representative screen shot of the summary view of the Auction Monitor Form, in accordance with an embodiment of the present invention.

FIG. 50 is a representative screen shot of the detailed view of the bidding history of a specific auction, in accordance with an embodiment of the present invention.

FIG. 51 is a representative screen shot of the detailed view of the Setup Form, in accordance with an embodiment of the present invention.

The drawings are not necessarily to scale, emphasis instead generally being placed upon illustrating the principles of the invention.

### DETAILED DESCRIPTION

Although any one of the available auction methods could be used to auction various products and services, such as a closed auction, the present invention as it pertains to an English forward auction is the preferred method because sellers realize a premium in the pricing of their offerings when using an online English forward auction format. For example, in the auction of commercial loans, sellers have realized a 13% pricing premium when using the inventive online English auction format, as compared to when the offerings were conducted by sales representatives using other methods or means of selling, such as telephones, faxes and email.

The pricing premium is the amount of proceeds a seller receives that is in excess of an offering's reserve price. This pricing premium has been maximized for items that are uniform or homogenous in nature and that can be valued with relative accuracy. For example, in regard to an offering class of commercial loans, the pricing premium is greater for loan packages that are clean performing loans.

The inventive embodiment achieves an increased pricing premium because the online English auction format enhances competition by increasing the bidder's level of control and ability to compete. Specifically, the inventive embodiment in an online English auction format garners an increased number of bidders and bidder activity on comparison to a closed auction format. This increased bidding results in subsequent increased pricing premiums. Although simply increasing the number of bidders will not necessarily lead to higher proceeds, the increased level of participation will positively impact other competitive issues, thereby driving up the pricing premium.

Typically, the bidding in an English forward auction is open. Therefore, in other auction systems all the participants bidding on a specific offering or item know the cover bid and the bidder's identity or handle, at any time they access the offering's web page. Additionally, every bidder can view how other bidders are participating in a specific offering by viewing the bid history web page, which displays the history for all bidders. Such market feedback allows each bidder to validate their own level of participation and provides a comfort level that their own bid is not out of market. However, too much information about other bidders may cause a bidder to suspend their bidding. In the preferred embodiment the bidding is anonymous. Therefore, a bidder can only learn limited information about the auction, such as the current high bid. By not providing the bidder with other bidders' bid histories for a given item, each bidder only knows that she is competing against at least one or more bidders, but cannot determine where any other bidder dropped out of the bidding competition. This satisfies the requirement that allows the bidder know that her bid is not out of market, but prevents a bidder from experiencing “buyer's remorse” by comparing her own bid to those bidders who dropped out of the competition at a lower bid amount. Because of this, the present invention results in higher pricing premiums. The present invention also creates higher pricing premiums by preventing the bidders from learning each other's identity. Therefore, collusion among the bidders is prevented. Similarly, by extending the close of the auction each time a new bid is received, the present invention ensures that each bidder submits their best and final offer. Consequently, the offering is sold to the genuine highest bidder, thereby increasing the pricing premium.

The present invention accomplishes these and other improvements by employing the system described herein and in the cross-referenced applications. As used herein, the Internet refers at least to a collection of networks and gateways that use the transmission control protocol/Internet protocol (TCP/IP) suite of protocols to communicate with one another. The World Wide Web (WWW) refers at least to a set of inter-linked hypertext documents residing on hypertext transport protocol (HTTP) servers. As used herein, the WWW also refers at least to documents accessed on secure servers, such as HTTP servers (HTTPS), which provide for encryption and transmission through a secure port. WWW documents, which may be referred to herein as web pages, can, for example, be written in hypertext markup language (HTML). As used herein, the term “web site” refers at least to one or more HTML documents and associated files, scripts, and databases that may be presented by an HTTP or HTTPS server on the WWW. The term “web browser” refers at least to software that lets a user view HTML documents and access files and software related to those documents. The term “web page” refers to the display of one page of a web site which displays one or more of the HTML documents and/or data from the associated files, scripts and databases.

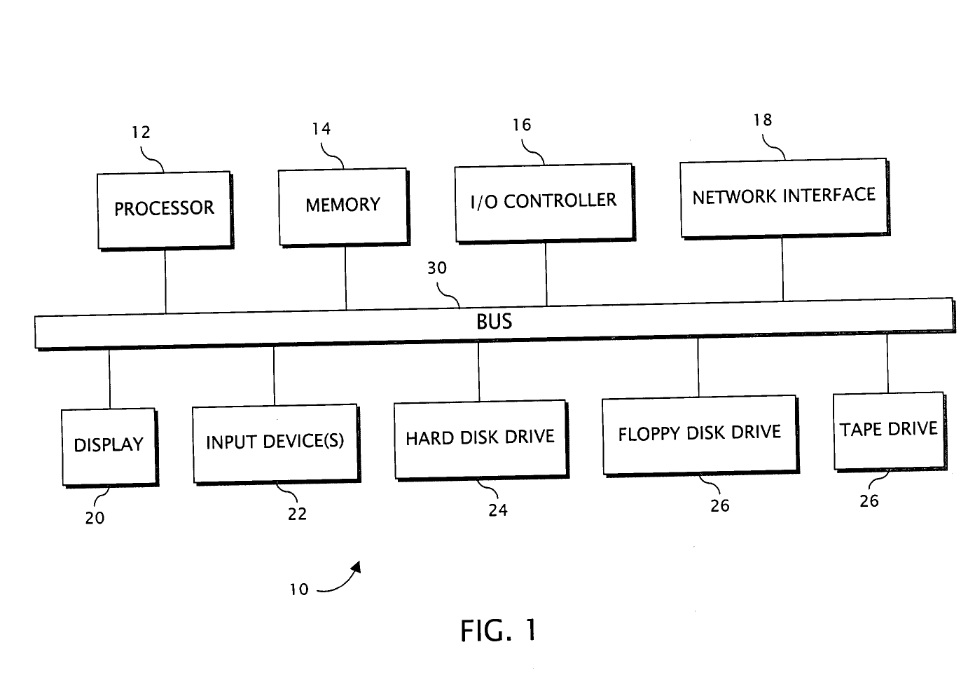

Systems and methods in accordance with the invention can be implemented using any type of general purpose computer system, such as a personal computer (PC), laptop computer, server, workstation, personal digital assistant (PDA), mobile or wireless communications device, interconnected group of general purpose computers, and the like, running any one of a variety of operating systems. An example of a general-purpose computer system 10 usable with at least one embodiment of the present invention is illustrated in FIG. 1.

Referring briefly to FIG. 1, the general purpose computer system 10 includes a central processor 12, a main memory unit 14 for storing programs and/or data, an input/output controller 16, a network interface 18, a display device 20, one or more input devices 22, a fixed or hard disk drive unit 24, a tape drive unit 26, a tape drive unit 28, and a data bus 30 coupling these components to allow communication therebetween.

The central processor 12 can be any type of microprocessor, such as a PENTIUM processor, made by Intel of Santa Clara, Calif. The display device 20 can be any type of display, such as a liquid crystal display (LCD), cathode ray tube display (CRT), light emitting diode (LED), and the like, capable of displaying, in whole or in part, the outputs generated in accordance with the systems and methods of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that provides the computer system 10 with network access to a computer or other device, such as a printer. In one embodiment of the present invention, the network interface 18 enables the computer system 10 to connect to a computer network such as the Internet.

Those skilled in the art will appreciate that computer systems embodying the present invention need not include every element shown in FIG. 1, and that equivalents to each of the elements are intended to be included within the spirit and scope of the invention. For example, the computer system 10 need not include the tape drive 28, and may include other types of removable media drives, such as compact disk read-only memory (CD-ROM) drives. CD-ROM drives can, for example, be used to store some or all of the databases described herein.

In at least one embodiment of the invention, one or more computer programs define the operational capabilities of the computer system 10. These programs can be loaded into the computer system 10 in many ways, such as via the hard disk drive 24, the floppy disk drive 26, the tape drive 28, or the network interface 18. Alternatively, the programs can reside in a permanent memory portion (e.g., a read-only-memory (ROM)) chip) of the main memory 14. In another embodiment, the computer system 9 can include specially designed, dedicated, hard-wired electronic circuits that perform all functions described herein without the need for instructions from computer programs.

In at least one embodiment of the present invention, the computer system 10 is part of a client-server system, in which a client sends requests to a server and a server responds to requests from a client. That is, the computer system 10 can be either a client system or a server system. In one embodiment, the invention is implemented at the server side and receives and responds to requests from a client, such as a reader application running on a user computer.

The client can be any entity, such as a the computer system 10, or specific components thereof (e.g., terminal, personal computer, mainframe computer, workstation, hand-held wireless device, electronic book, personal digital assistant, peripheral, etc.), or a software program running on a computer directly or indirectly connected or connectable in any known or later-developed manner to any type of computer network, such as the Internet. For example, a representative client is a personal computer that is x86-, PowerPC.R™., PENTIUM-based, or RISC-based, that includes an operating system such as IBM.R™, LINUX, OS/2.R™. or MICROSOFT WINDOWS (made by Microsoft Corporation of Redmond, Wash.) and that includes a Web browser, such as MICROSOFT INTERNET EXPLORER, NETSCAPE NAVIGATOR (made by Netscape Corporation, Mountain View, Calif.), having a Java Virtual Machine (JVM) and support for application plug-ins or helper applications. A client may also be a notebook computer, a handheld computing device (e.g., a PDA), an Internet appliance, a telephone, an electronic reader device, or any other such device connectable to the computer network.

The server can be any entity, such as the computer system 10, a computer platform, an adjunct to a computer or platform, or any component thereof, such as a program that can respond to requests from a client. Of course, a “client” can be broadly construed to mean one who requests or gets the file, and “server” can be broadly construed to be the entity that downloads the file. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions and the like.

Embodiments of the invention can be implemented using computer technologies such as software applications, computer-readable program media, data structures, carrier wave signals, user interfaces, and application program interfaces. For example, software embodying the present invention, in one embodiment, resides in at least one application running on the computer system 10. In at least one embodiment, the present invention is embodied in a computer-readable program medium usable with the computer system 10. In at least one embodiment, the present invention is embodied in a data structure stored on a computer or a computer-readable program medium. In addition, in one embodiment, the present invention is embodied in a transmission medium, such as one or more carrier wave signals transmitted between the computer system 10 and another entity, such as another computer system, a server, a wireless network, etc. The present invention also is embodied in an application programming interface (API) or a user interface. In addition, the present invention, in one embodiment, is embodied in a data structure.

In at least one embodiment, the invention provides a system that enables interaction between a number of parties that can participate in transactions involving auctions or involving financial products, such as debt transactions. In accordance with at least one embodiment of the invention, analysts, bidders and sellers of products or services, as well as other interested parties can access a computerized system via a website or portal, over a computer network to access a variety of debt related features and functions. At least some embodiments of the invention provide features and functions whereby potential buyers can search for, view information about, obtain documentation for, originate, and bid on, products and services. These products can include by way of example and limitation, boats, stamps or tickets to sporting events, which are offered for auction to bidders by sellers. These products can also include financial products such as commercial loans, offered for sale by sellers. The services offered for auction can include development of software, or medical services.

In addition, at least some embodiments of the invention provide features and functions whereby potential sellers can upload information about their offering. These embodiments also allows potential sellers to list, compute a price for, provide documentation for, originate, and accept bids on the offered products and services, which include commercial loans. Further, at least some embodiments of the invention permit users, including buyers, sellers, and entities that are neither buyers nor sellers, to search for, price, and obtain information about the offerings put up for auction, which include financial products.

Throughout this disclosure, the terms “buyer” and “bidder” are used interchangeably, although it should be understood that at least some embodiments of the invention, as described herein, the “buyer” is the “bidder” that wins the bidding process. Also throughout this disclosure the term “auction house” and auction system are used interchangeably, and mean the entity which accepts offerings from sellers and provides bidders with the opportunity to bid on those offerings.

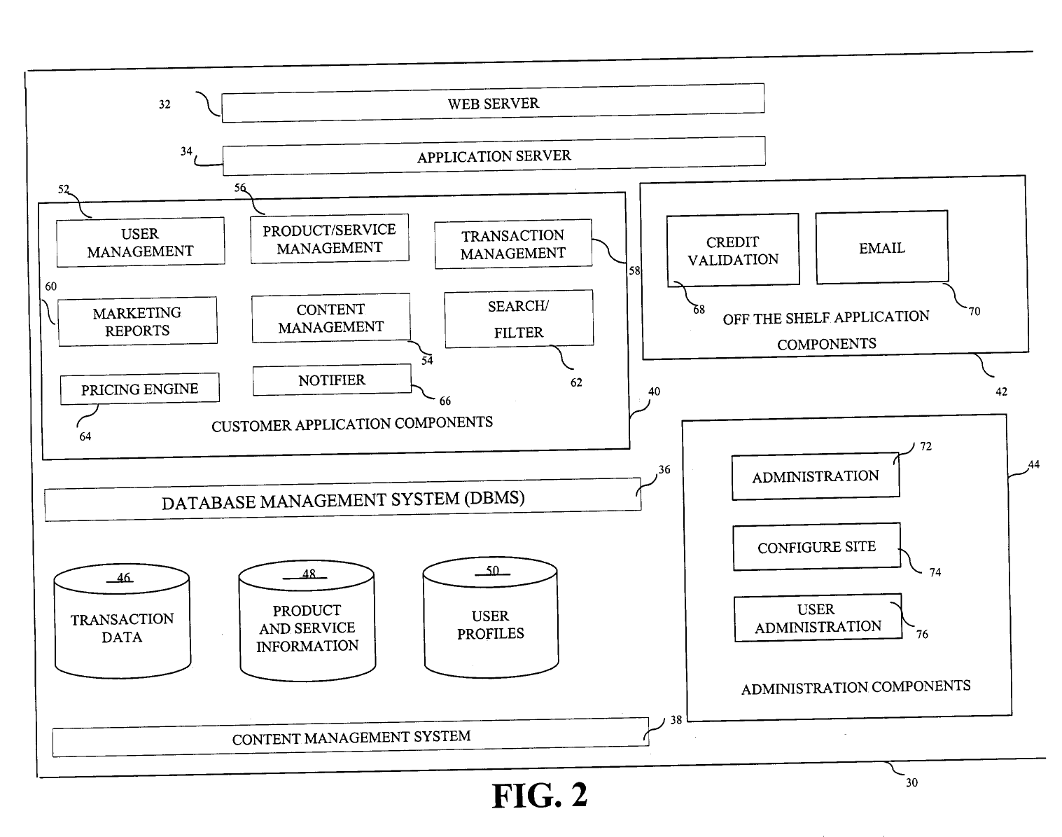

FIG. 2 is a block diagram giving an architectural overview of a system 30 implemented in accordance with one embodiment of the present invention. The system 30 of FIG. 2 is made available to potential bidder, sellers and other users, in at least one embodiment, through a web site accessible to users of a global information network such as the Internet. The system 30, in one embodiment, includes a set of infrastructure components which include but are not limited to a Web Server 32, an Application Server 34, a database management system (DBMS) 36, and a Content Management System 38. The system 30 also includes Application Components such as Custom Application Components 40 and Off-The-Shelf Shelf Application Components 42, as well as includes Administration Components 44. Moreover, the system 30 also includes Database Components, which include Transaction Data 46, Product and Service Information database 48, and User Profiles 50. Each component or subsystem of the system 30 can be in operable communication with at least one other component of the system 30, as necessary.

In one embodiment of the invention, the Web Server 32 includes the Microsoft Internet Information Server (IIS), manufactured by Microsoft Corporation, Redmond, Wash. The server software for the Microsoft IIS uses HTTP to deliver WWW documents, incorporates various functions for security, permits common gateway interface (CGI) programs, and provides for Gopher and file transfer protocol (FTP) services. However, those skilled in the art will recognize that other types of web server software may be used for the Web Server 32 in accordance with the invention. The Application Server 34, in at least one embodiment, includes Microsoft Active Server Pages (ASP), which enable server side scripting (versus client-side scripting). An ASP can, for example, contain code written in visual basic script (VB Script) or JavaScript (Jscript). The Application Server 34 can also comprise other types of application server programs such as Unix-based CGI scripts.

The DBMS 36, in one embodiment, is achieved using the Microsoft structured query language (SQL) system, but other DBMS systems, such as those manufactured by Oracle and Sybase, are of course usable in accordance with the invention. The content pages of the Content Management System 38, in one embodiment, include a plurality of content pages, such as content pages displaying financial product information, due diligence documents, and third party information. Examples of some of these content pages are provided herein. In one embodiment, the web pages display various type of information in various formats. For example, the web pages displaying content include HTML templates, as well as and pages for dynamic and static content pages, a splash page, pages for each of the present invention's products or capabilities (e.g., user registration, viewing loan documents, etc.), link pages, and general content pages. This list of web content pages is not limiting; those skilled in the art will of course recognize that many other types of content pages can be provided in accordance with the invention.

Referring again to FIG. 2, the Custom Application Components 40 includes components developed to accomplish some of the functions of the system 30 performed by the present invention as described herein. In at least one embodiment, the Custom Application Components 40 includes components such as User Management 52, Content Management 54, Product/Service Management 56, Transaction Management 58, Marketing Reports 60, Search/Filter 62, Pricing Engine 64, and a Notifier 66.

User Management 40 is a subsystem providing user management functions for users of the system 30. These users can include buyers and sellers of any type of product or service that can conceivably be sold at auction. In at least one embodiment, these users can be sellers and potential sellers of financial products, buyers and potential buyers of financial products, so-called market observers (users who can view the transactions occurring on the site and/or the financial products available on the site, but who are not necessarily participating in any transactions), visitors, “guest” users, auditing personnel, etc. For example, in at least one embodiment, the User Management 40 subsystem provides an interface to data such as user profile data, user preference data, stored search/filter results, lists of financial products for which a user has purchased due diligence or other information, a user registration component to handle initial site registration, login/authentication functions, an interface that allows a system administrator or quality control person to “activate” the ability for a Buyer or Seller to conduct transactions, and the like.

Content Management 54 is a subsystem providing interface to the Content Management System (CMS) 38 that allows for the management of all of the content related to the items listed within the system 30 which are being auctioned off. In the preferred embodiment, the Content Management System 38 manages all of the content related to the financial products listed with the system 30. Content Management 54, in at least one embodiment, includes a dynamic data-driven user content display component to handle access to and display of the site content based on the type of user (buyer, Seller, Quality Control Rep, Admin, etc.). In addition, Content Management 54, in one embodiment, includes an interface permitting the management and download of templates used by Sellers to prepare the documentation for financial products they want to sell, along with the ability to upload this information to the site. Examples of this interface are provided herein.

Product/Service Management 56 is a subsystem for allowing a Seller to specify a product or service that they wish to offer for auction. In the preferred embodiment the Product/Service Management 56 subsystem allows the Seller to specify the financial product they wish to offer for auction (e.g., loan, security, certificate of deposit, mutual fund, etc.). The Product/Service Management 56 subsystem also allows a Buyer to specify the type of product or service that they are interested in bidding on. In the preferred embodiment the Product/Service Management 56 subsystem allows the Buyer to select or specify the type of financial product she is interested in buying. The Product/Service Management 56 subsystem also matches Buyers to Sellers based on the criteria specified by each.

Product/Service Management 56 subsystem, in at least one embodiment, includes screens and forms used to collect information about the product or service being offered for auction by the Seller. For example, if the item being offered for auction by the Seller was a car, the Product/Service Management 56 subsystem can include features such as vehicle registration reports from every Department of Motor Vehicles from every state it was ever registered in, accident reports for the entire time the vehicle was owned by any particular user, as well as any other information which can be provided by the Seller, a third party, and/or, the administrator of the system 30, including pricing of the product or service being offered. In the preferred embodiment the Product/Service Management 56 subsystem can include features such as financial product summaries, detailed financial product information (such as pictures, maps, text and spreadsheets), which can be provided by the Seller, a third party, and/or, the administrator of the system 30, and financial product pricing. In addition, the Product/Service Management 56 subsystem, in one embodiment, includes all screens and logic to display financial product information to potential Buyers. These features and functions are illustrated and described more fully herein and in the cross-referenced applications.

The pricing of a product or service can be provided in a number of ways. For example, if the product is a car, the most commonly accepted method of pricing that car would be to have the Seller enter certain characteristics of the car, and compare those characteristics to a similarly situated car in the Blue Book. Once a similarly situated car was located in the Blue Book, the Pricing Engine subsystem 64 could suggest to the Seller that they offer their car for about the same price as the Blue Book value. Alternatively, if the product being auctioned off was a package of commercial loans, the financial product pricing in accordance with the preferred embodiment of the present invention can be determined by using the Pricing Engine subsystem 64, described more fully herein and in the cross-referenced applications. In at least one embodiment, the financial product pricing is determined by an analyst (i.e., a person). In at least one embodiment, the financial product price is determined using a combination of information from both the Pricing Engine 64 and the analyst. However, in at least one embodiment, the Pricing Engine 64 is entirely automatic.

In one embodiment of the invention, the characteristics of the car being sold and the Seller's offering price are provided to a prospective Buyer or other user. In a preferred embodiment of the present invention, financial product information pertaining to the commercial loan package is provided in summary form to a prospective Buyer or other user. In one embodiment the summary form of the commercial loan package is generated automatically, using templates a user receives from information provided in forms filled out by a Seller. In at least one embodiment, the summary form of financial product information is created at least in part by an individual accessing the information.

Buyers can obtain detailed information and/or materials about a product or service as well. For example, in regard to a financial product the potential Buyer could find certain due diligence information, such as certificates of insurance. Alternatively, the potential Buyer of a medical service could find out whether the doctor had ever been charged with malpractice, or ever had her license revoked by a state licensing board. In at least one embodiment, a fee can be charged for at least some of the detailed information about the product or service being auctioned off. In addition, in one embodiment of the invention, Buyers cannot bid on or purchase a financial product for sale unless the system 30 has proof that the Buyer has at least been provided with the appropriate due diligence information. This feature, provided in at least one embodiment of the invention, can help to satisfy National Association of Securities Dealers (NASD) requirements. For example, in one embodiment, this proof is satisfied by a Buyer's purchasing the due diligence materials. Examples of these materials and this process are discussed in more detail either herein or in the cross-referenced applications.

In at least one embodiment, Product/Service Management subsystem 56 includes an interface permitting a Seller to upload data and materials related to the product or service offered for auction. In at least one embodiment, a user can request the generation of a detailed summary of the product or service the Seller is offering for sale, so that potential buyers can have access to that information. As noted previously, the generation of the detailed product or service summary can be automated, can be accomplished by one or more persons, or a combination of the two. In at least one embodiment, selected individuals (called “Quality Control” representatives and managers) are assigned to manage and monitor one or more products or services associated with one or more Sellers. Therefore, in at least this embodiment, the Product/Service Management subsystem 56 includes screens and logic to allow a Quality Control Representative to view the list of products and/or services they are responsible for. In at least this embodiment the Quality Control Manager can allocate and assign loans to Quality Control Representatives.

For example, a Quality Control Representative can assist a bidder with questions about a financial product for sale, any information regarding or documentation for the financial product being auctioned off, questions about the bidding process, or questions about the Seller offering a certain financial product. Quality Control Representatives, in one embodiment, have access to at least a portion, if not all, of the Seller and Buyer information (including, for example, lists of financial products that a Buyer has bid on, lists of documentation associated with a given financial product, etc.), and can monitor the bidding process for one or more financial products. Quality Control Managers, in one embodiment, have access to at least a portion of the Seller and Buyer information, as well, and further have access to and can monitor the actions of the Quality Control Representatives.

Transaction Management 58, in one embodiment, is a subsystem that provides for the handling and tracking of transactions, such as between Buyers and Sellers. In the preferred embodiment, the Transaction Management subsystem 58 handles and tracks among other things, which Bidder won a certain offering and what price the bidding closed at. Transaction Management subsystem 58 includes substantially all screens and logic to allow a Buyer to bid on or to buy a specific product or service offered by a Seller. The Transaction Management subsystem 58 also allows the Seller to accept or reject a specific bid from a Buyer. In at least one embodiment, the Transaction Management subsystem 58 includes logic and/or rules that permit the system 30 to take action on behalf of a Buyer or a Seller. For example, Transaction Management subsystem 58 can include logic whereby it is authorized to accept a bid from a Buyer on behalf of a Seller if a specified condition (e.g., price) is met. In a similar example, Transaction Management subsystem 58 can include logic whereby it is authorized to place bids for a financial product on behalf of a Buyer, in accordance with one or more conditions.

In one embodiment, Transaction Management subsystem 58 includes logic to implement one or more types of auctions of a financial product offered for sale, including sealed- bid format and English forward auction format. In one embodiment, the sealed bid format presents the bidder with a form with which to enter the bid, and provide any contingencies attached to the bid. Such a contingency would state “This bid is valid if the seller can substantiate that the borrower is willing to close on September 19, 2001.” In the English auction format, bids are accepted without contingencies.

In one embodiment, the Transaction Management subsystem 58 can also include the logic and screens required to allow Buyers and Sellers to end or close the transaction (either by completing it or aborting it) using the system 30. In at least one embodiment, however, closing the transaction is accomplished outside of the system 30.

Referring again to FIG. 2, the Marketing Reports subsystem 60 includes logic and forms to interface with tools such as Crystal Reports (available from Crystal Decisions, Inc. of Palo Alto, Calif.) and the like to generate ad hoc marketing reports. In one embodiment, the Marketing Reports subsystem 60 includes design and implementation within Crystal Reports or similar tool containing approximately twelve standard marketing reports.

The Search/Filter subsystem 62 is a component that matches search criteria provided by a user, such as a Buyer or third party, with information provided by a Seller regarding the product or service to be auctioned off. Preferably the Seller provided information would have been previously uploaded into the system 30. In one embodiment, searches (also referred to herein as a product or service “filter,” e.g., “a loan filter”) are filtered by one or more criteria. For example, the Search/Filter subsystem 62 of one embodiment can filter a search for a boat by criteria which include Make, Model, Year Built, Length, Condition and Geographic Location. Similarly, the preferred embodiment can filter a search for a certain package of loans according to Geographical Location, Loan Type, Loan Amount, Interest Rate Range, Maturity Status, Loan Quality (four subcategories), and/or other criteria, as those skilled in the art will appreciate. Examples of searches and filtering in accordance with an embodiment of the invention are provided herein and/or in the cross-referenced applications. In one embodiment, the Search/Filter subsystem 62 includes substantially all forms and logic to perform the search function and present the information back to the user (e.g., a Buyer) conducting the search.

The Pricing Engine 64 is a subsystem that computes a price for the object being auctioned off, and offers that computed price to Sellers, Buyers, Analysts or Quality Control Reps. In one embodiment, the Pricing Engine subsystem 64 would accept from the Seller the characteristics of the car being offered at auction, compare those characteristics to similarly situated cars which are stored in the Product and Service Information database 48, and suggest a price that modifies the Blue Book price according to the characteristics that differ from the car being auctioned off. In the preferred embodiment where a loan is being offered for auction, the Pricing Engine subsystem 64 uses loan data received from the Seller, information (such as the current prime interest rate) obtained from third parties, historical financial product trade information, and/or information provided by an Analyst to generate data that is used to compute a price for the offered loan. For example, in one embodiment, such data is provided to a spreadsheet program, such as MICROSOFT EXCEL (available from Microsoft Corporation of Redmond, Wash.), to price the loan. The resulting calculations are stored in the Product and Service Information database 48 and thereby made available to the Buyers, the Seller, Analysts or Quality Control Reps.

The Pricing Engine subsystem 64, in one embodiment, includes substantially all screens and logic to allow a user to specify the loan to “price.” In one embodiment, the Pricing Engine 64 also bases its computations on additional loan pricing parameters, such as those provided by a Seller or an Analyst. In one embodiment, the Pricing Engine 64 includes a “back-end” process that runs an instance of MICROSOFT EXCEL using the loan data, captures the MICROSOFT EXCEL output, and stores the information in the Product and Service Information database 48. Examples of the operation of the Pricing Engine 64, in accordance with an embodiment of the invention, are provided herein and in the cross-referenced applications. The Pricing Engine subsystem 64, in one embodiment, includes logic to generate notifications to parties (e.g., Buyers, Sellers, etc.) to a transaction or potential transaction.

In at least one embodiment, the Pricing Engine 64 can provide a substantially “quick” estimate of the value of the product or service being offered. This feature is referred to in the example embodiment shown herein and in the cross-referenced applications as “Quick Price”. The price estimate is based at least in part on one or more assumptions. For example, the assumption might be that car being auctioned is in good and working order. Similarly, an assumption for another embodiment is that a given financial product being auctioned off will perform according to its stated terms. This feature is explained more fully herein and/or in the cross-referenced applications.

In one embodiment, a Notifier subsystem 66 generates these and other notifications. For example, Sellers can be notified, such as by a telephone call, letter, electronic mail message (“email”), wireless transmission, facsimile (“fax”), automated message, or other appropriate notification whenever a Buyer has expressed interest in a financial product that the Seller is selling, such as when a Buyer has ordered due diligence materials relating to a financial product that the Seller is auctioning. In another example, when a Buyer who has viewed a product or service being auctioned off and ordered information corresponding to that product or service can be notified as to the closing date for bids on the desired product or service. In still another example, a bidder who has bid on a financial product can receive notifications as to who has “won” or “lost” the bidding process.

Referring again to FIG. 2, the Off-the-Shelf Application Components 42 can include virtually any type of application component, including those regularly used in electronic commerce web sites, such as Credit Validation 68 and E-Mail 70. The Credit Validation subsystem 68, on one embodiment, is an interface to an off-the-shelf credit card validation system used to handle the acceptance of payment for information about the product or service being auctioned off. For example, if the product being auctioned off is a car, the Bidder can pay for and obtain the vehicle's accident history and/or odometer readings for every year the car registered at a given department of motor vehicles. The Bidder can also pay, via the Credit Validation subsystem 68 for detailed financial product summaries, due diligence information, and other information provided to a Buyer or potential Buyer. Credit Validation subsystem 68, in one embodiment, includes substantially all forms and logic to allow the Buyer to initiate the interaction with the Credit Validation 68, and to authorize the purchase, such as via a credit card or other suitable payment mechanism.

In accordance with one embodiment of the invention, E-Mail 70 is an off-the-shelf component (such as MICROSOFT OUTLOOK) employed to allow a Buyer, Seller, or other entity to receive alerts from the system 30 when events impacting a product or service being auctioned off occurs. For example, a Buyer can receive notification when a new contingency has been added to the boat they might be interested in. Alternatively, a Bidder can receive notification when new due diligence materials become available, when a condition to the loan (e.g., term) has changed, when a bid higher than the Buyer's bid has been submitted, etc. The E-Mail subsystem 70, in one embodiment, includes logic that detects these events and includes software to generate the e-mail using the commercial e-mail package.

The Administration Components 44 of at least one embodiment of the invention include Administration 72, Configure Site 74, and User Administration 76. The Administration subsystem 72 is the administration tools used with the system 30. For example, in one embodiment the administration tools are the standard administrative tools provided with the Web Server 32, Application Server 34, DBMS 36, and Off-the-Shelf Components 42. In another embodiment, depending on the final reporting requirements, Administration Components 44 include tools such as third party site monitoring or usage analysis/reporting tools.

The Configure Site subsystem 74 is, in one embodiment, a site configuration component. This is a set of tools to enable an entity such as a Site Administrator to configure the web site associated with the system 30. Depending on specific requirements, these tools can be developed as a web-based application or as a standalone client/server application.

User Administration 76 is, in one embodiment, a user administration component and includes a set of tools to enable an entity such as a Site Administrator to administer users. User Administration 76 provides add, delete, and modify functions. Depending on specific requirements, User Administration 76 can, for example, be a web-based application or can operate as a standalone client/server application.

The components of the database for the system 30, in accordance with one embodiment of the invention, include databases for Transaction Data 44, Product and Service Information 48, and User Profiles 50. The Transaction Data database 44 contains information used to track all transactions that occur on the site between Bidders and Sellers of the products and services being auctioned off. The Transaction Data database 44 allows entities such as Quality Control personnel to obtain transaction history of any product or service offered for sale in connection with the system 30. As will be explained herein and/or in the cross-referenced applications, the transaction history is, in one embodiment, used to help compute a price for the offered product or service.

The Product and Service Information database 48 contains information on each product or service being auctioned which was submitted to the site and, in at least one embodiment, includes links to all associated supporting materials for a given product or service. These supporting materials can include, for example, due diligence materials, summary information, related third party information such as maps and demographic profiles.

The User Profiles database 50 contains user profile information. In at least one embodiment, User Profiles 50 stores “site-wide” user attributes such as username, associated passwords, Buyer preferences, Seller preferences, payment information, etc. This information may vary depending on the type of user (e.g., Buyer vs. Seller vs. Quality Control, etc.).

In one embodiment, the configuration of FIG. 2 is implemented using at least one web server, one application server, and one database server. In this embodiment, this configuration can be used regardless of whether NT or UNIX is used as the technology platform. This configuration has the ability to scale by adding additional web servers, application servers, database servers and bandwidth. Moreover, these technology platforms have the ability to scale by adding additional processors, memory and disk space. In addition, in another embodiment, each database is segmentable and scaleable.

In yet another embodiment, the invention is implemented with fault tolerant features. For example, failure of the web servers and application servers of the system 30 are covered by complete machine redundancy (each of the initial machines is identical) coupled with an appropriate load balanced solution (such as the LOCAL DIRECTOR available from Cisco Systems of San Jose, Calif.).

In another example, failure of the database servers of the system 30 is covered by use of reliable components with built in redundancy (power supplies, CPUs, memory) as well as complete machine redundancy. In still another example, using a redundant array of independent disks (RAID) for the database and disk mirroring for the Web servers covers disk failure. In still another embodiment, the system of the invention is hosted at an appropriate data center (such as NaviSite or the like) with firewall services, load balancing services, burstable bandwidth, room for growth and appropriate network/infrastructure redundancy.

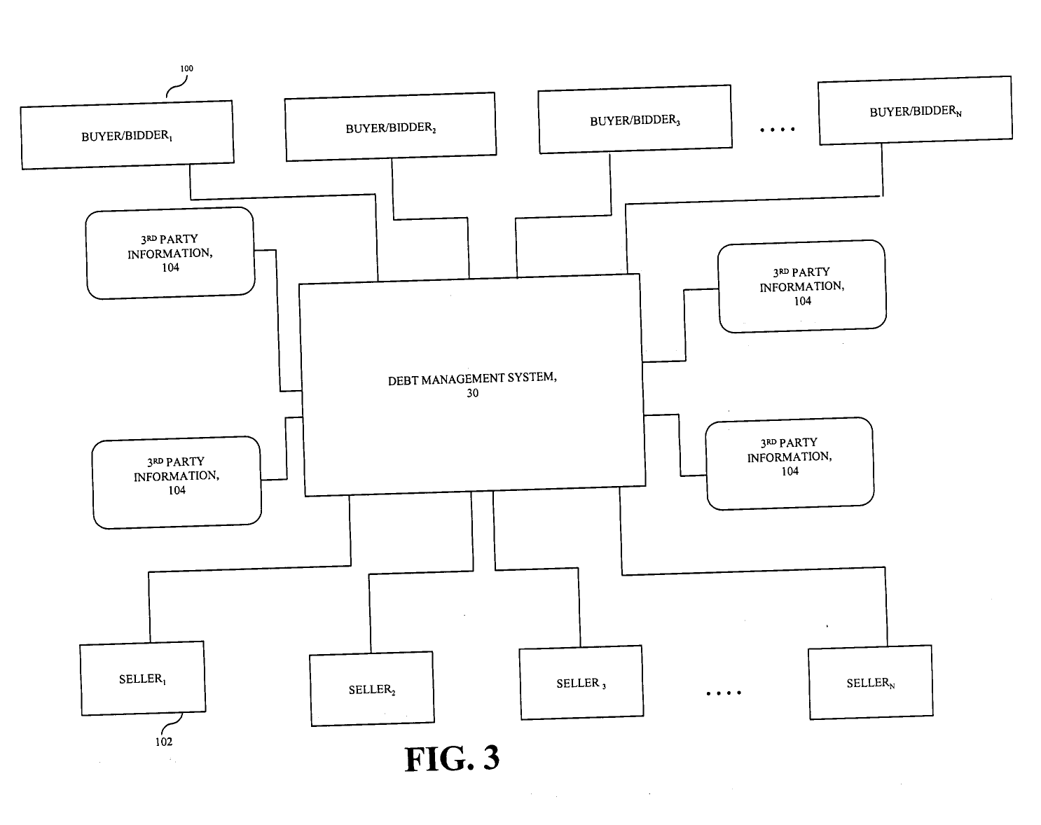

FIG. 3 is a block diagram providing a perspective of how an embodiment of the system 30 of the present invention operates in an environment of Bidders 100 (referred to herein interchangeably as “Buyers” and “Bidders”), Sellers 102, and third parties 104. The Bidders 100 are entities, such as individuals or organizations, which want to buy or bid on the product or service being offered by the Seller 102.

In accordance with one embodiment of the invention, a Bidder 100 is an entity, such as a person, organization, or other user of the system 30, who is interested in getting information about (and possibly purchasing) a product or service, such as a boat or a loan, which is being sold by a Seller via an auction. A Buyer can bid on financial products available for sale by Sellers 102 via the auction house's system 30. In one embodiment, the category of Buyers 100 includes both those entities that have registered with the system 30 (“registered Buyers”) and those who have not (“Guests”). In one embodiment of the invention, Guests have limited ability to access the information that is available to registered Buyers. Also, FIG. 3 illustrates, the auction house's system 30 is capable of interacting with any number of Bidders 100 and Sellers 102. Although only four third parties 104 are illustrated in FIG. 3, any number of third parties 104 can interact with the system.

In accordance with one embodiment of the invention, a Seller 102 is an entity, such as a person or organization, offering one or more products or services, such as cars, boats, baseball cards, commercial loans, legal services, for sale. A Seller 102 also can be an entity, such as a broker or agent, authorized to act on behalf of another entity selling a given product or service.

A third party 104, in accordance with one embodiment of the invention, is an entity, such as a person or organization, that provides information to the system 30 which is usable and/or useful to a Buyer 100 or a Seller 102 either contemplating or actively bidding on an offering. Some of this information can, for example, include “background” information of interest to a Buyer 100. For example, such background information can include whether a doctor auctioning off his services has ever been sanctioned by a state medical board. Such information can also include statements and documents from insurance companies insuring a Seller 102, as well as demographic organizations providing information about a physical location associated with a given financial product. Third parties 104 also can include suppliers of information used to price financial products. For example, such a supplier of financial information could include a website that provides information regarding Federal Money Funds rates. Those skilled in the art will recognize that, depending on the product or service being auctioned off, many different types of third parties can provide information that is relevant to that auction.

Other parties and entities (not shown in FIG. 3) that can interact with the system 30 include Analysts, Marketing personnel, Quality Control Personnel, and Site Administrators.

An Analyst is an entity that, in at least one embodiment, computes prices for the products or services being auctioned off by Sellers. The Analyst's computations can be based on factors that can include the profile of the loan, historical information, and external information. In one embodiment of the invention, the Analyst also can use a “black box” pricing calculator, such as one provided by another third party, or even the Pricing Engine 64 of FIG. 2. In another embodiment of the present invention, the system 30 does not employ an Analyst, but instead automatically computes prices for the product or service being auctioned off. This feature is described more fully herein and/or in the cross-referenced applications.

Marketing is, in one embodiment, an internal user associated with the administrator/owner of the system 30 and/or its associated website. This party can monitor Buyer/Seller activity and interests with an existing contact management system, such as ACT!, which is available from Internet Commerce Corporation of Scottsdale, Ariz.

Quality Control Personnel, in one embodiment of the invention, includes Quality Control Representatives and Quality Control Managers. The Quality Control Representative is an internal user associated with the administrator/owner of the system 30, who can, if necessary, facilitate the relationship between Buyers 100 and Sellers 102. This facilitation can, in one embodiment, include contacting the parties to resolve questions and disputes either may have. The Quality Control Manager is an entity, such a person, that can allocate loans among Quality Control Representatives.

In accordance with at least one embodiment of the invention, analysts, Buyers 100 and Sellers 102 of financial products, and other interested parties can access the system 30 via a website or a portal, over a computer network to access a variety of financial products, related features and functions. For example, in the case of a loan for sale, a Buyer 100 can view a Loan Summary page (described more fully below or in the cross-referenced applications), to view summaries of available loans and to get news related to loans, both specifically and generally. The Buyer 100 can also search for loans using one or more criteria.

Table 1 describes at least some of the types of features and services provided by a system implemented in accordance with one embodiment of the invention. In the example of Table 1, the feature or function is shown along with the parties that can use the feature or function. These features and functions can, for example, be implemented as functions accessible to a user via “buttons,” pull-down menus, links, and the like, provided on a web page. Many of these features and functions are illustrated and described in greater detail herein.

It should be understood, however, that Table 1 is not intended to limit the scope of the types financial product-related functions and features provided in accordance with the invention. Those skilled in the art will recognize that the features and functions of Table 1 are merely representative of the types of features and functions that can be provided and that many other features and functions will occur to those skilled in the art. In addition, those skilled in the art recognize that, in some embodiments, a given feature or function may not be accessible to a given type of user, or may be accessible to more or different users than listed.

TABLE 1
Services Offered in one embodiment of the invention

| Actor | Feature | Description/Action |
|---|---|---|
| Buyer | Financial | View financial product summaries. Get general |
| | product | financial product-related News. |
| | Summary | |
| | Page | |
| Buyer | Financial | Search for financial product by: Geographic loca- |
| | product | tion, Financial product Type, Financial product |
| | Search | Quality (four subcategories), Financial product |
| | | Amount, interest rate, Maturity status, other dimen- |
| | | sions as understood by those skilled in the art. The |
| | | search criteria can be stored for each registered user |
| | | and can become part of the profile. |
| Buyer | Price a | View financial product information within preset |
| | Financial | templates determined by business rules. Information |
| | product | presented can be filtered by profile and search |
| | | criteria. |
| Buyer | Buyer | Collect information such that manual buyer |
| | Profile | qualification process can be performed by personnel |
| | | associated with the owner/administrator of the portal |
| | | of the invention. |
| Buyer | Detailed | Views an overview of the information about a |
| | Financial | financial product they may be interested in purchas- |
| | product | ing. This information can be in the form of pictures, |
| | | maps, text, and spreadsheets and can be available |
| | | for view by a registered Buyer after the Buyer's |
| | | payment is approved (for example, by credit card |
| | | debit or payment plan confirmation). |
| Buyer | Detailed | Views online detailed financial product documents, |
| | Docu- | which may be in PDF-format or any other usable |
| | ments | document format. In one embodiment, this infor- |
| | | mation can be available in preview form (the first |
| | | few pages of the detailed document) or in its |
| | | entirety. |
| Buyer | Submit | Allow a Buyer to submit all information required to |
| | Bid | bid on the specified financial product. |
| Buyer | Closure | Provide ability for Buyer to close the financial |
| | | product by receiving an Invoice and Wiring and/or |
| | | payment information. |
| Buyer | Alerts | Provide an alerting capability to send alerts to the |
| | | Buyer when events impact his (potential) bid on |
| | | financial products. For example, the alerts may |
| | | include: a matching of Buyer criteria to an available |
| | | financial product, updates in bid status, updates in |
| | | financial product terms, Seller response (filtered by |
| | | QC), existence of competing bids. |
| Seller | Request to | Allows a Seller to create a financial product profile |
| | Price a | and enter criteria about the financial product for |
| | Financial | pricing by an Analyst. In one embodiment, this |
| | product | feature includes a calculator with counts (like that |
| | | on Stock Xchange). |
| Seller | List a | Establish an intent to sell a financial product by |
| | Price | establishing a price for the financial product and |
| | | specifying a means of payment. |
| Seller | Seller | Collect information such that personnel associated |
| | Profile | with the owner/administrator of the debt manage- |
| | | ment system, website, or portal can perform a |
| | | manual seller qualification. |
| Seller | Download | Mechanism for Seller to download standard |
| | Financial | financial product data templates that they can use to |
| | product | provide standard information about a financial |
| | Templates | product. In one embodiment, these templates can be |
| | | templates associated with word processing and/or |
| | | spreadsheet applications, such as Microsoft Word |
| | | and Microsoft Excel templates. |
| Seller | Upload | Ability of a Seller to upload standard financial |
| | Financial | product information data in a predetermined format, |
| | product | such as PDF format. In one embodiment, the data |
| | Data | uploaded to the site is in PDF format files built from |
| | | Microsoft Word and Microsoft Excel templates |
| | | downloaded from the site. For example, this data |
| | | can be original Financial product data or updates |
| | | to Financial product data (if the Seller resells the |
| | | Financial product). One reason for providing this |
| | | material is so that the system (and/or an Analyst) |
| | | can assemble a Detailed Summary Document after a |
| | | request to do so is received from the Seller. |
| Seller | Request | Ability of a Seller to request an Analyst to create a |
| | Detailed | Detailed Financial product Summary of the financial |
| | Summary | product the Seller is offering, so that it is available |
| | Document | to potential Buyers. |
| Seller | Closure | Provide ability for Seller to close the financial |
| | | product deal. |
| Seller | Alerts | Provide an alerting capability to send alerts to the |
| | | Seller when events impact his financial product. In |
| | | one embodiment, these alerts include: changes in |
| | | valuation, confirmation of financial product pricing |
| | | by the Analyst, queries from Buyers, and Bids made |
| | | (current highest Bid related information). |
| Analyst | Generate | Generates a financial product's Detailed Summary |
| | Detailed | Document at the request of a Seller and thereby |
| | Summary | makes the financial product available for sale to |
| | Document | Buyers. |
| Analyst | Price | Calculates the price range of a financial product |
| | Financial | using the financial product profile provided by the |
| | product | Seller and a “black box” calculator associated with |
| | | the owner/administrator of the web site. This |
| | | process can be performed manually or |
| | | automatically. |
| Market- | Run | Runs reports that compare the Buyer/Seller activity |
| ing | Reports | against the existing contact management tool (such |
| | | as ACT!). |
| QC Rep | Qualify | Use Seller-provided profile information and manual |
| | Seller | process to verify identity and billing information of |
| | | a Seller. Perform an action on the site that |
| | | “activates” a Seller who has previously registered |
| | | on the site. |
| QC Rep | Qualify | Use Buyer-provided profile information and manual |
| | Buyer | process to verify identity and billing information of |
| | | a Buyer. Perform an action on the site that |
| | | “activates” a Buyer who has previously registered |
| | | on the site. |
| QC Rep | Financial | Simple-to-do list used to track the financial products |
| | product | the QC Rep is responsible for. |
| | Queue | |
| QC Rep | Report | Report capability to monitor the status of financial |
| | | products. |
| QC Rep | Overview | Capability to track and monitor detailed financial |
| | Process | product status to moderate Buyer/Seller interaction. |
| QC Rep | QC Log | Ability to view the activity log for a given financial |
| | | product in order to track dependencies and |
| | | Buyer/Seller interaction. |
| QC | Manage | Allocates and assigns financial products to Quality |
| Man- | Financial | Control Reps and tracks their status. |
| agement | product | |
| | Assign- | |
| | ments | |
| Site | Adminis- | Suite of administrative tools to enable site admin- |
| Admin- | tration | istrator to operate and monitor system. One |
| istration | | embodiment includes basic site controls (e.g. start, |
| | | stop, etc.), basic monitoring, usage reporting, etc. |
| Site | User Ad- | Add, delete, or modify User Profiles. |
| Admin- | ministra- | |
| istration | tion | |

Although the examples for pricing, trading, analyzing, buying, and selling products and services described herein and in the cross-referenced applications are provided using the example of a commercial loan, the example of loans is not limiting. As noted previously, the type of product or service includes cars, boats, stamps, legal services, medical services and software development services. Moreover, the financial product auctioned off using the financial products described herein can be virtually any type of financial product, including commercial and residential loans, lines of credit, savings accounts, securities, bonds, insurance products, annuities, certificates of deposit, student loans, personal loans, and the like. The financial product can be a single product (e.g., a single loan) or a group of products (e.g., a group of loans, or a group of various types of financial products). Moreover, as described herein, at least some of the other types of actions provided by systems and methods of the present invention (such as pricing a financial product and bidding on a financial product) are similarly usable with at least some of these types of financial products.

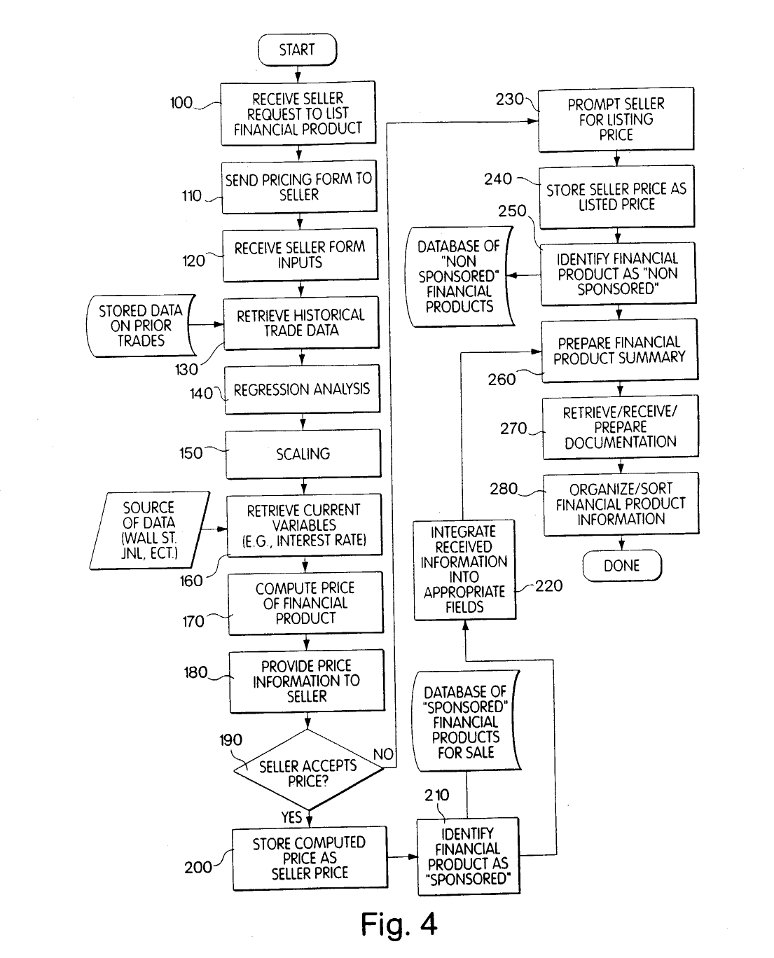

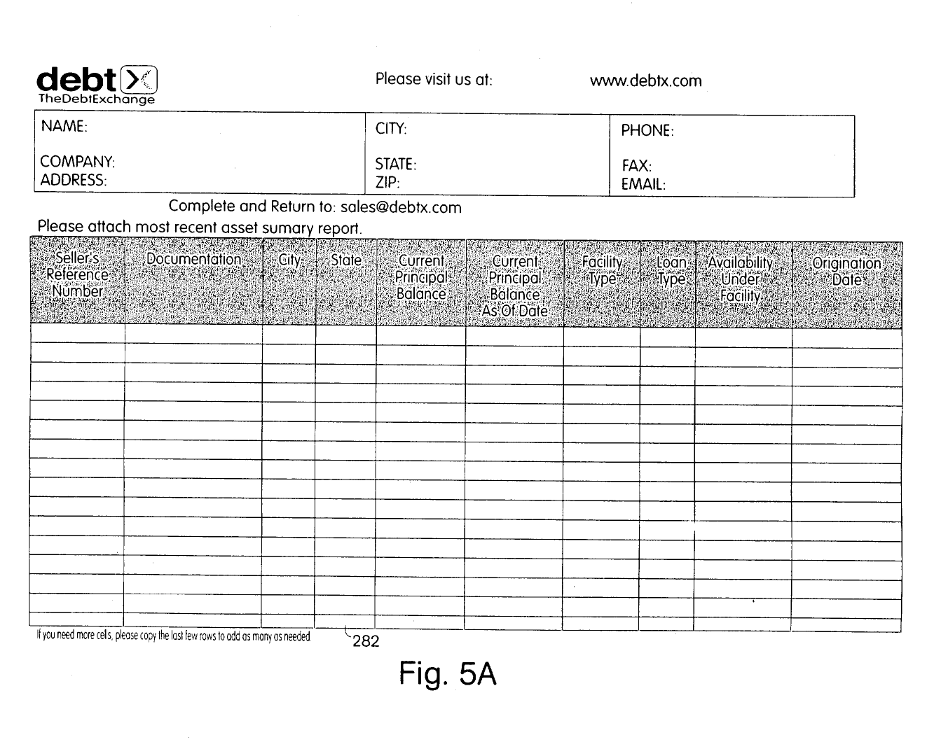

FIG. 4 is a flow chart illustrating one embodiment of a process for pricing a product or service, in accordance with the present invention. A Seller 102 can use this process to determine a price for the product or service he is auctioning off. Although FIG. 4 illustrates one particular embodiment that pertains to auctioning a financial product, FIG. 4 is applicable to any product or service that can be auctioned. Referring to FIGS. 2, 3 and 4, the process of FIG. 4 begins when the system 30 receives the request of a Seller 102 to list a financial product for sale (step 100). The Seller 102 can send the request to the system by sending a message from a computer, such as a personal computer or workstation, over a computer network or via a wireless device to the system 30. In one embodiment, this is done by the Seller 102 going to a web page associated with the system 30, and accessing various functions on the web page using links, buttons, pull down menus, etc., located on the web page.

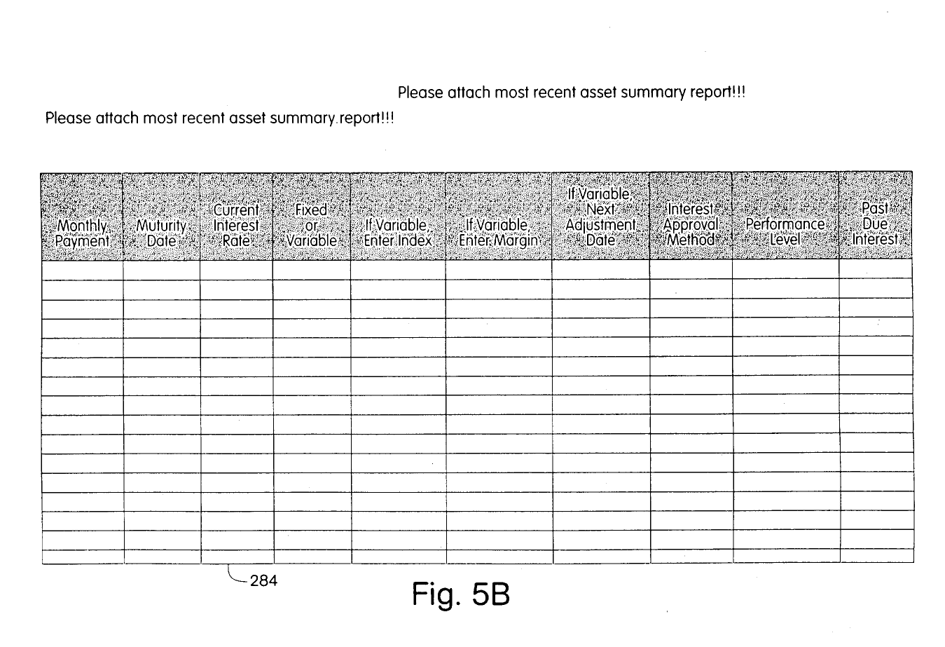

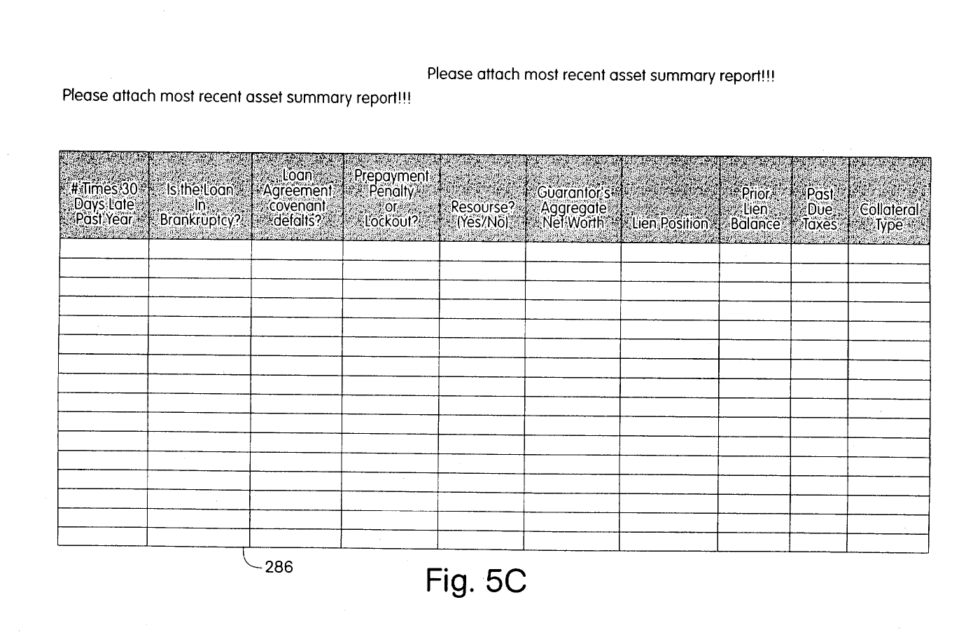

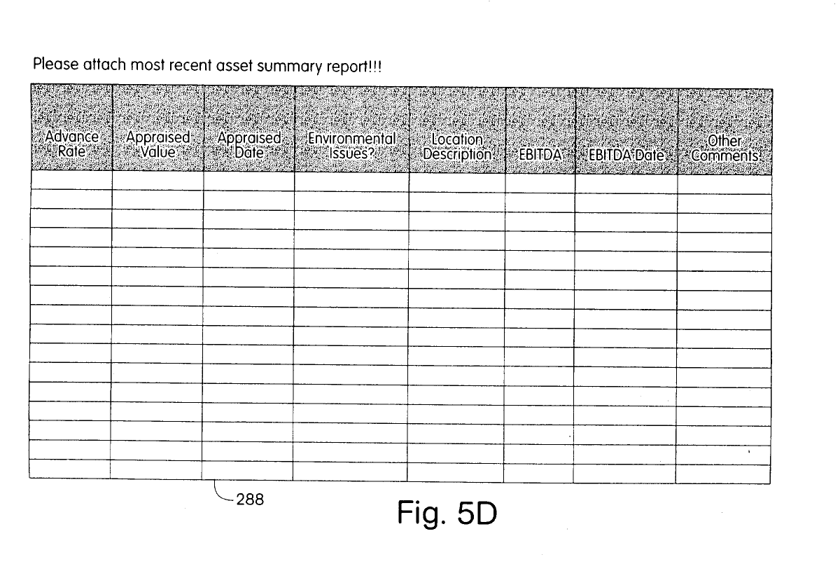

When the system 30 receives the request (step 100), it provides one or more forms to the Seller 102, such as pricing forms, so that the Seller 102 can provide the system 30 with some of the information needed to compute a price for the financial product. FIGS. 5A through 5D are representative screen shots illustrating forms 282, 284, 286, 288 that the system 30 provides to the Seller 102, in accordance with an embodiment of the invention. In one embodiment, the forms 282, 284, 286, 288 are constructed and arranged to automatically upload information that a Seller 102 has stored in another file, such as a spreadsheet file. In one embodiment, the system 30 stores a profile of the Seller 102, such that portions of the forms 282, 284, 286, 288 can be “filled out” by the system in advance (e.g., “Seller's reference Number, Seller's name, etc.). The profile of a Seller 102, in one embodiment, also stores other information provided by a Seller 102, such as preferences, criteria for accepting bids, restrictions on bids (e.g., certain users may be prohibited from bidding), restrictions on access to information (bidders may be required to sign on and/or acknowledge specific conditions before receiving information), specification of type of bidding to occur (e.g., type of auction), permission for the system 30 to accept bids on behalf of the Seller 102, etc. This type of information also can be provided in the forms 282, 284, 286, 288.

Referring again to FIG. 4, after the system 30 sends the forms 282, 284, 286, 288 to the Seller 102 (step 110) and receives a response (step 120), the system 30 can compute a price for the financial product. In at least one embodiment, the Pricing Engine 64 uses data and characteristics about the financial product to compute the price for the financial product. The data and characteristics can include, but are limited to, parameters such as terms, time periods, conditions, locations, appraisals, discounts, liens, status, sponsors, servicing type, status, maturity, principal balance, financial product type, origination date, monthly payment, maturity date, interest rate, interest accrual method, and performance level.

As part of the price computation, the system 30 retrieves historical trade data (step 130) that it has stored relating to prior trades. For example, the system 30 can use the Transaction Management subsystem 58 and query its Transaction Data database 46 (FIG. 2) to retrieve this data. This data helps the system 30 to analyze the relationship and similarity between the financial product being offered for sale and previous trades of financial products having one or more similar characteristics. For example, a Seller 102 may be listing a residential mortgage for a property with an outstanding loan balance of $310,000, an interest rate of 8.65%, a 30-year term, with an excellent payment history, which is located in a suburban community. The system 30 could then search for prior trades of other residential mortgages sharing some or all of these characteristics. The prior trade history could, for example, provide data, such as cents on the dollar that the mortgage sold for on the secondary market, as well as provide what factor or factors had the greatest impact on the price of the previously sold mortgage.

Based on the retrieved historical trade data, the system performs regression analysis (step 140) using both the historical trade data and the seller's inputs, to get an estimate for how at least a portion of the various characteristics of the financial product affects the price of the financial product.

Based on the results of the regression analysis, the system 30 then assigns a scaling factor (step 150) to at least a portion of the characteristics (i.e., the various fields on the forms 282, 284, 286, 288). The system 30 also takes into account external variables (step 150), such as the U.S. Federal Funds rate, U.S. prime rate, bond rate, U.S. Treasury bill rate, U.S. Treasury bond rate, U.S. Treasury note rate, S&P 500 index, Dow Jones Industrial Average, and NASDAQ Combined Composite Index. The system 30 can be provided with external variables from virtually any known source of the information, including trade journals such as the Wall Street Journal, Bloomberg Business News, etc. In one embodiment, the system 30 can automatically retrieve the information from a known location (such as on a computer network). In one embodiment, a user such as a system administrator also can provide the information to the system 30 via manual input.

Referring again to FIG. 4, the system 30 computes a price for the financial product (step 180) and provides the price to the Seller 102 (step 180). If the Seller 102 accepts the computed price (step 190), the system 30 stores the computed price as the selling price (step 200) of the financial product. In at least one embodiment, if the Seller 102 has accepted the computed price, the financial product is identified as a “sponsored” product (step 210) and is stored as such. “Sponsored,” in one embodiment, indicates to potential Buyers 100 at least that the price of the financial product can be relied on as having the approval of the entity sponsoring the website of the system 30. This entity that is sponsoring the website on which the auction is taking place is also referred to herein as the auction house.

The price computed in FIG. 4 can, in one embodiment, provide a benchmark for a Seller 102 to determine what price is appropriate for the financial product being auctioned off, given current market conditions and historical trade data. Sellers 102 can revisit the process of FIG. 4 at any time and can get a price appropriate to the market conditions and trade history then in existence. This feature may help Sellers 102 recognize the true market value of their financial products.

If, however, the Seller 102 does not accept the computed price, the system 30 prompts the Seller 102 for their own price (step 230), which the system 30 receives and stores as the listed price for the financial product (step 240). In at least one embodiment of the present invention, financial products having seller-provided prices are identified in such a manner. Identifying financial products as having seller-provided prices allows potential Buyers 100 to determine that the financial product is not “sponsored” (step 250) by the auction house. In at least one embodiment, products with seller-provided prices are labeled as “direct events.”

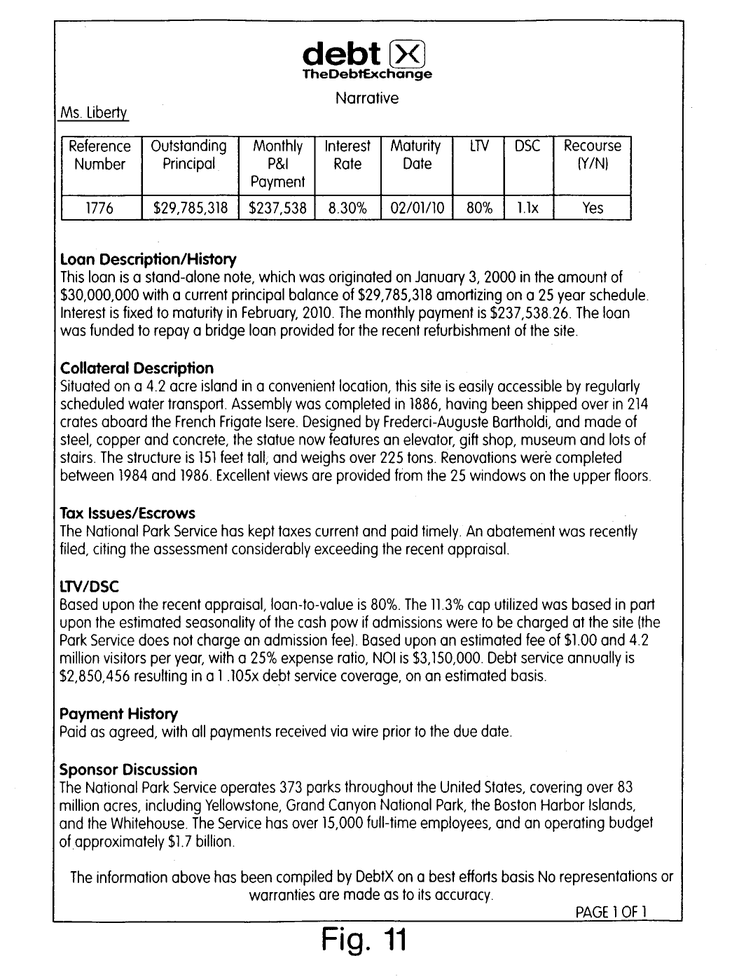

After the system 30 has a price for the financial product (whether the system 30 computes it or whether the Seller 102 provides it), the system 30 prepares a summary of the financial product based on the information it has about the financial product (step 260). In one embodiment, the summary is created by taking selected inputs from the forms 282, 284, 286, 288 and putting them into a predetermined template. In at least one embodiment, the financial product summary is created automatically by the system 30, without human intervention. In one embodiment, the summary is created in whole or in part by a person, such as an Analyst (as described previously) who reviews the information to create the financial product summary. Examples and illustrations of the loan summary are provided herein. For example, FIG. 11 illustrates an example screen shot of a loan summary for an example loan for sale, in accordance with an embodiment of the invention.

The system 30 also prepares a set of documentation on the financial product being auctioned off (step 280), so that potential Buyers 100 can view the documents and conduct any necessary due diligence. These documents include, for example, documents, such as those shown in Table 2 (which by way of example only shows documents used or relied upon in the sale of a loan):

TABLE 2
Documents provided for a Financial Product
Document

| | |
|---|---|
| 1: | TABLE of Contents |
| 2: | Narrative |
| 3: | Statistics For Purchase |
| 4: | Note |
| 5: | Mortgage/Security Agreements |
| 6: | Guaranty |
| 7: | Assignments |
| 8: | UCC |
| 9: | Title Insurance |
| 10: | Environ. Indemnity Agreement |
| 11: | Property Condition Asses. |
| 12: | Appraisal |
| 13: | Environ. Site Assessment |
| 14: | Other Collateral Information |
| 15: | Other Sponsor Information |

By comparison, a boat being auctioned off by an embodiment of the present invention would include at least the following documentation:

TABLE 3
Documents provided for a Boat
Document

| | |
|---|---|
| 1: | TABLE of Contents |
| 2: | Narrative |
| 3: | Statistics For Purchase |
| 4: | Title to Boat |
| 5: | Mortgage/Security Agreements |
| 6: | Warranty |
| 7: | Mechanic's Assessment |
| 8: | UCC |
| 9: | Title Insurance |
| 10: | Picture of Harbor |
| 11: | Property Condition Asses. |
| 12: | Appraisal |
| 13: | Environ. Site Assessment |
| 14: | Other Collateral Information |
| 15: | Other Sponsor Information |

Unlike known systems and web sites that simply act as “bulletin boards,” in at least one embodiment, the present invention provides the unique ability to perform the entire due diligence and auction process online. Buyers 100 and other investors are immediately able to review complete, original loan documentation and other critical information directly through the system 30 of the invention, eliminating the time and costs associated with traditional due diligence methods. These traditional methods of due diligence include traveling to the location where all the due diligence information is held; manually searching for needed due diligence material; copying and/or scanning the due diligence material so that it can be reviewed at a later date at a remote location; as well as traveling to the location of the product, property or service being offered and inspecting it to ensure it actually exists.

In addition to immediate information access, the features and advantages of the some embodiments of the invention (including at least the Quick Price feature, the financial product computation tools module, the Forward Loan workflow tools, and automated email alerts that notify users when information on a selected financial product is updated,) as described herein, may facilitate the evaluation and workflow processes associated with trading products and services.

In one embodiment, the system 30 queries the Seller 102 for the necessary documents, which the Seller 102 can provide to the system in many different ways, including electronic transmission, or physically mailing the actual documents (in paper form, on diskette or CD-ROMs, etc). In at least one embodiment, the Seller 102 can upload some or all of the information, which can include standard financial product information data, to the system 30 in predetermined formats such as Microsoft Word, Microsoft Excel, Adobe ACROBAT, and the like. In at least one embodiment, the seller-provided information includes due diligence information that is capable of fulfilling at least a portion of a buyer's need for due diligence on the financial product. In at least one embodiment, the due diligence information comprises an electronic representation of a physical due diligence document, such as an electronic image substantially replicating the physical due diligence document. This is accomplished, in at least one embodiment, by using a document format such as PDF. In at least one embodiment, the due diligence information is scanned to create electronic image files representing the physical due diligence documents.

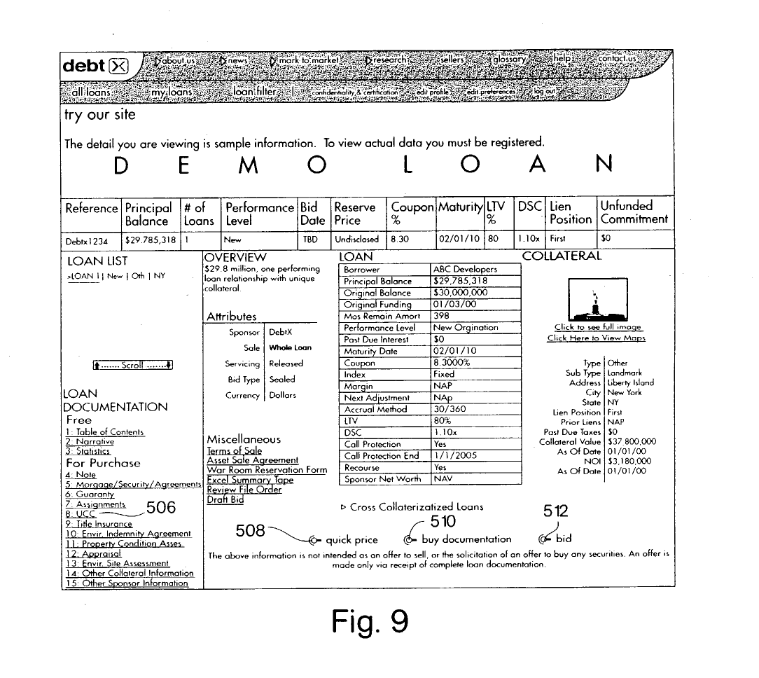

In one embodiment, the data uploaded to the site is in PDF format files built from Microsoft Word and Microsoft Excel templates downloaded from the system 30. For example, this data can be original product data or updates to product data (if the Seller 102 resells the product). After the necessary documentation and financial product information is received, the system 30 organizes the information (step 280) for viewing and/or purchase by entities such as by potential Buyers 100. In at least one embodiment, the system 30 uses a standardized format to organize the documents and/or the product or services summary, so that those accessing products, such as financial products, have a consistent view and interface. The system 30 also can, if applicable, add links to information from third parties 104 that is of interest and/or relevant to the product or service being auctioned off. Examples of these documents are provided and described herein (see, for example, FIGS. 9-17).

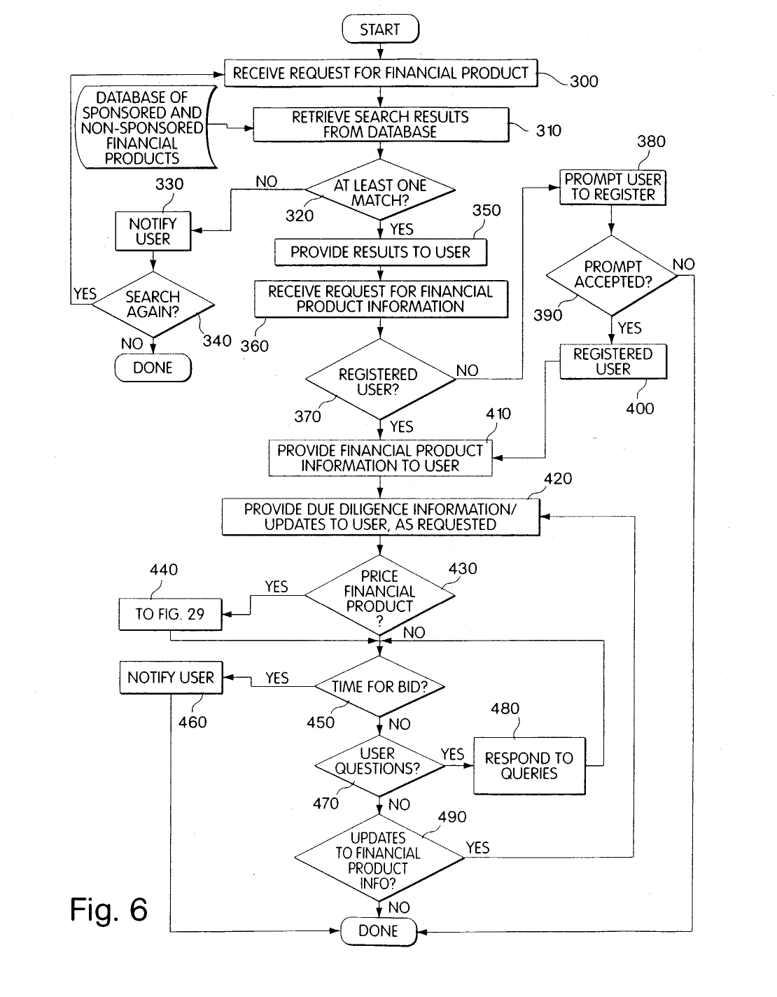

FIG. 6 is a flow chart illustrating an embodiment of the present invention which searches for a specific product or service. Any user of the system 30, including Buyers 100, Sellers 102, third parties 104, visitors, and site administrators can conduct this search. The search can locate, for example, financial products listed with the system 30 using the process of FIG. 4.

Referring to FIGS. 2, 3, and 6, and by way of illustration only, the system 30 receives a request from a user for a financial product (step 300). In another embodiment of the present invention, the user's request could be directed at a boat or legal services. The request can be for all listed financial products, or the request can be for financial products meeting one or more criteria. For example, in one embodiment, when a user accesses the system 30, if the user has a profile stored on the system 30, and the profile lists loan criteria, the system 30 can automatically bring up financial products meeting the stored criteria. Although not shown here, in one embodiment, a user may store the results of previous searches and bring those searches up, as part of step 300.

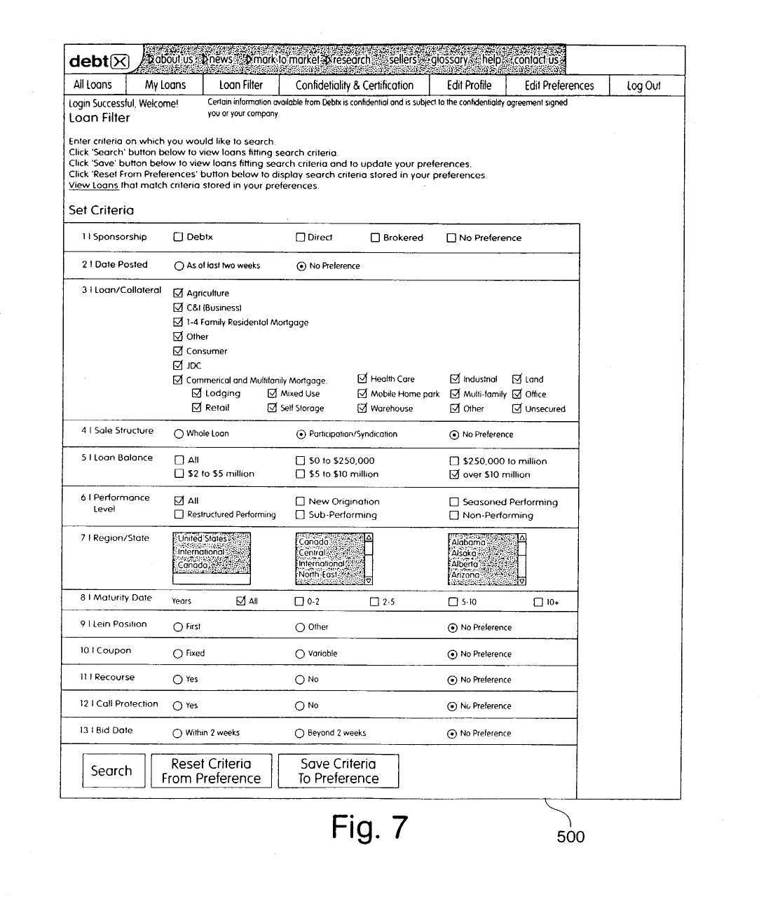

The request of step 300, in one embodiment, is in the form of a search form, presented to the user as part of a graphical user interface (GUI). For example, in one embodiment, the system 30 displays a search form capable of receiving user inputs. FIG. 7 illustrates a representative screen shot of a search input form 500 used to search for a financial product, in accordance with an embodiment of the invention. The search form 500 shown in FIG. 7 is provided by way of example only. Those skilled in the art will appreciate that many different types of form and inputs can be used for querying for a product or service which satisfies a user's requirements. For example, in one embodiment, the system 30 can store a profile of a given user, where the profile specifies criteria that a user may have concerning financial products of interest and, based on that profile, conduct a search for products or services automatically or upon request by a user.

Referring again to FIG. 6, based on the search criteria, the system 30 retrieves search results from its databases (step 310) which match the search criteria. If there are no matches (step 320), the system notifies the user (step 330) and, if the user wants to search again (e.g., using different criteria) (step 340), the system 30 conducts the search again. If the user does not want to search again, the process ends.

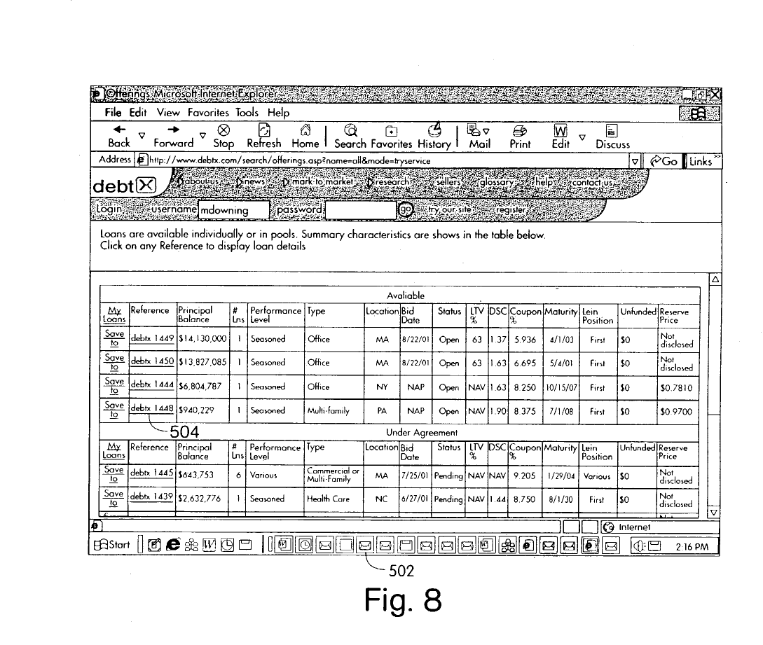

If there were matches to the search (step 320), the system provides the results to the user (step 350). FIG. 8 is a representative example screen shot illustrating the search results 502 resulting from a search for a financial product, in accordance with an embodiment of the invention. As FIG. 8 illustrates, selected information is provided about the financial products for sale, including the status of the financial product (e.g., “Available” or “Under Agreement”), the loan balance, the type, etc. In this example, a price for the financial product is not provided. As explained further herein, users are able to compute a price for the financial product based on specific requirements and terms. As with the processes of computing a price for Sellers 102, Buyers 100 can use at least one embodiment of the invention to determine an appropriate price for a given financial product, given the current market conditions and the trade history of that offering, or in regard to similarly situated offerings. As discussed herein, the trade history of a particular offering can alternately be available and unavailable to a Bidder.

Referring again to FIG. 6, a user can request further information, including due diligence materials, about any financial product listed in the search results (step 360). In at least one embodiment of the invention, if the user making such a request is not registered with the system 30 (step 370), the user is prompted to register (step 380) and, if the prompt is accepted (step 390), the appropriate steps are taken to register the user (step 400). If the user declines to register, the process ends and further information about the financial product is not provided. Registration can require the user to provide specific types of information and may require the user to agree to, execute or otherwise acknowledge certain obligations, such as confidentiality obligations, relating to the information to be provided to the user.

Registration can include the user reviewing the terms of his or her registration, and, if desired, can review the terms in another format, such as PDF. At this point, the newly registered user can be added to the system 30 using various techniques. For example, the user might be required to print out a form, fill it in, and return it to the administrator of the system 30. Alternatively, the system 30 can automatically enroll the user to the system, or the user can be added to the system using a combination of automatic enrollment and filling out forms. Those skilled in the art will appreciate that many different methods for registering users and assigning corresponding authentication information (for example, a username and password) are within the spirit and scope of the invention.

The process shown in steps 370,380, 390, and 400 also can be used in one embodiment to obtain additional information from users (registered or otherwise) where applicable. For example, a Seller 102 may have as a condition of its listing the requirement that the system obtain certain additional information from a user before providing some or all of its product or service information to a user.

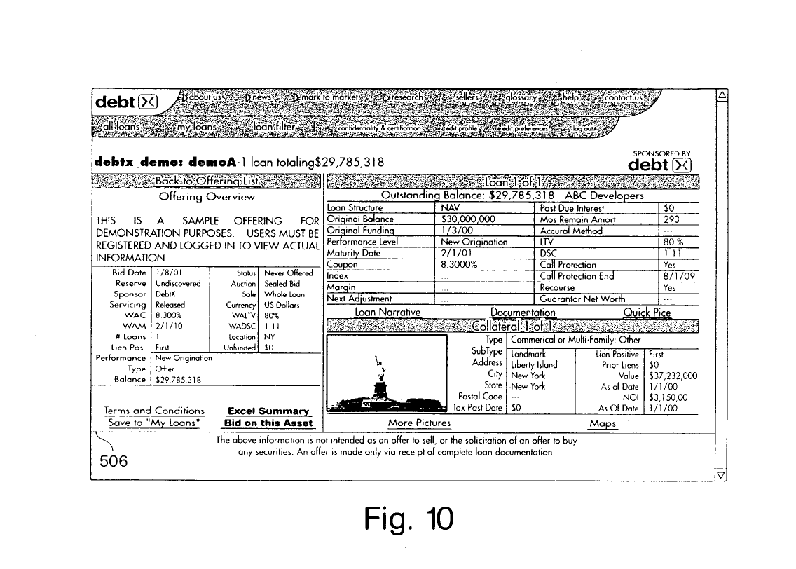

Referring to FIG. 6, when the necessary conditions (e.g., registration or other conditions) are met, the system 30 provides information about the product or service to the user (step 410). A user can, in one embodiment, request this information by “clicking” on a specific listing 504 in the results 502. FIGS. 9 and 10 are representative screen shots illustrating examples of the financial product information provided to a user, in accordance with an embodiment of the invention. As FIGS. 9 and 10 illustrate, the types of information include (but are not limited to) an overview of the financial product, a summary of key information about the financial product, images of collateral (where applicable), a list of documentation available for the financial product (for free or for purchase), and terms of the sale or auction. Of course, those skilled in the art recognize that the information provided in the examples of FIGS. 9 and 10 is not limiting.

In one embodiment, a user can obtain a “Quick Price” 508 (FIG. 9) on the product or service. One example of the system 30 providing this “Quick Price” can be found when the system 30 performs a computation similar to the pricing computation performed in the process of FIG. 4. If the product being auctioned is a boat the system 30 could provide a dollar figure, while if the service being auctioned is a legal service, the system 30 could provide a billable hour and an accompanying estimate of the number of hours required to complete the task, or any combination thereof. Alternatively, if the product is a loan the system 30 can give a loan price to a user cents on the dollar, basis points, or other suitable measure.

In one embodiment of the invention, the financial product information includes listings for financial products called “Brokered events.” Brokered events are identified by the specific broker sponsoring the deal and are subject to that broker's parameters, including bid type, setting the Reserve Price (if any) documentation, disclosure, and Asset Sale Agreement. Each broker that lists a financial product provides the system 30 with a written statement describing its offering philosophy. That statement can be posted on-line and accessed by an interested party.

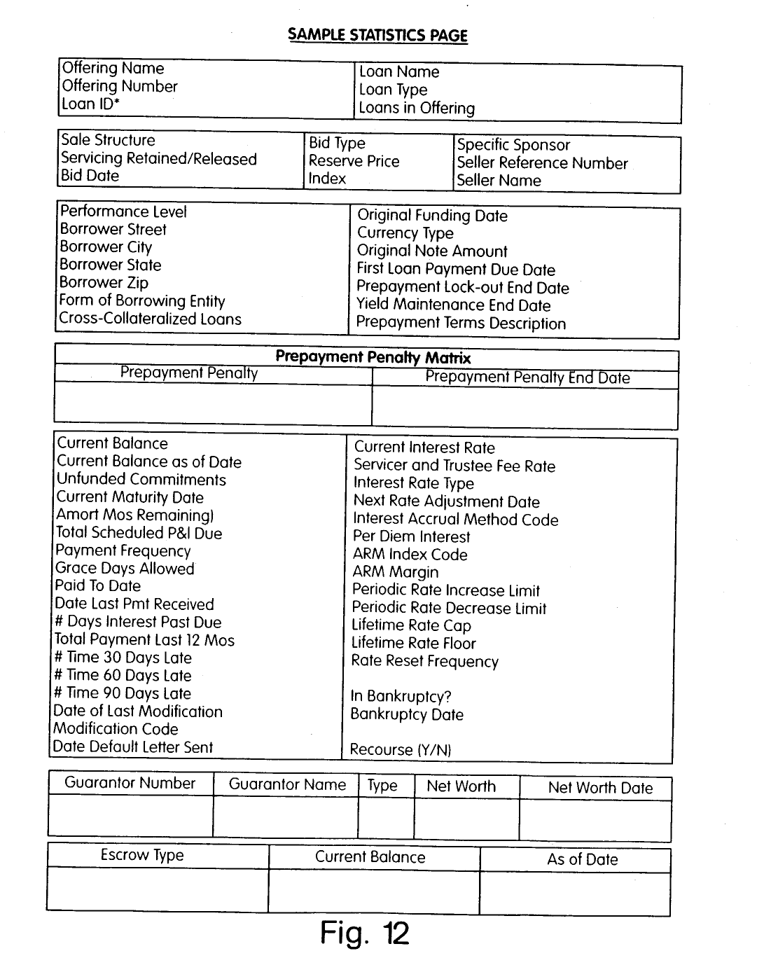

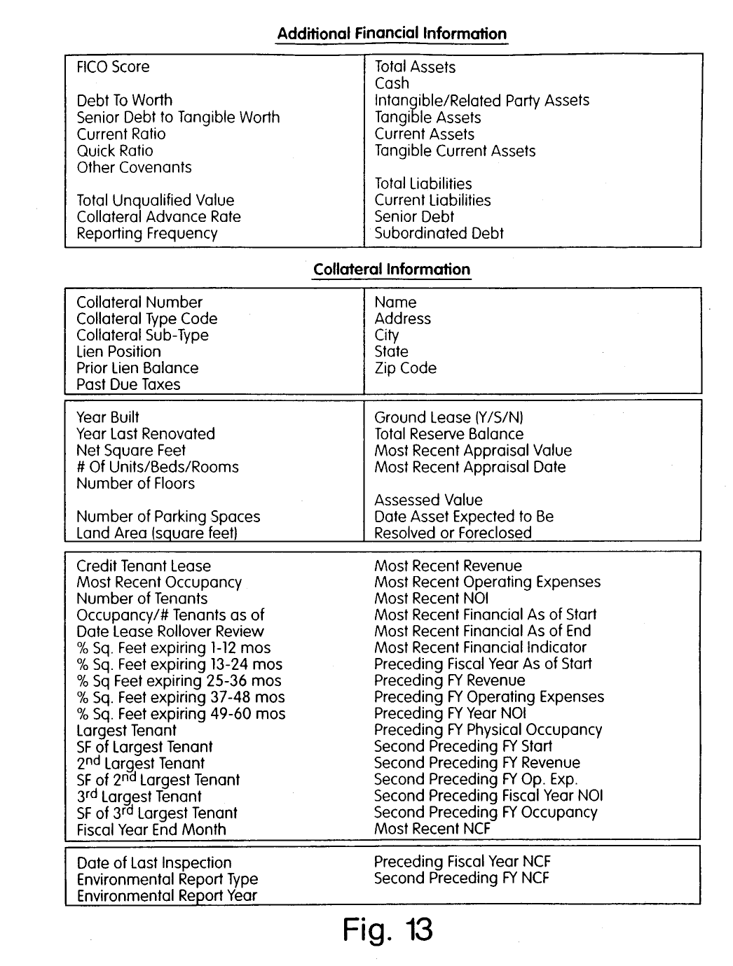

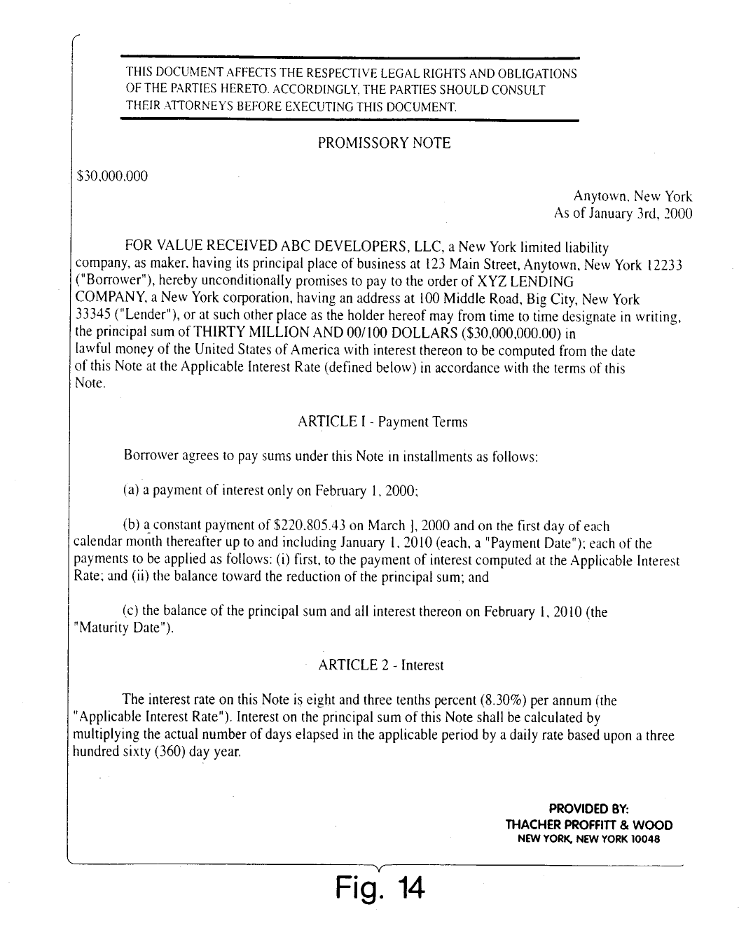

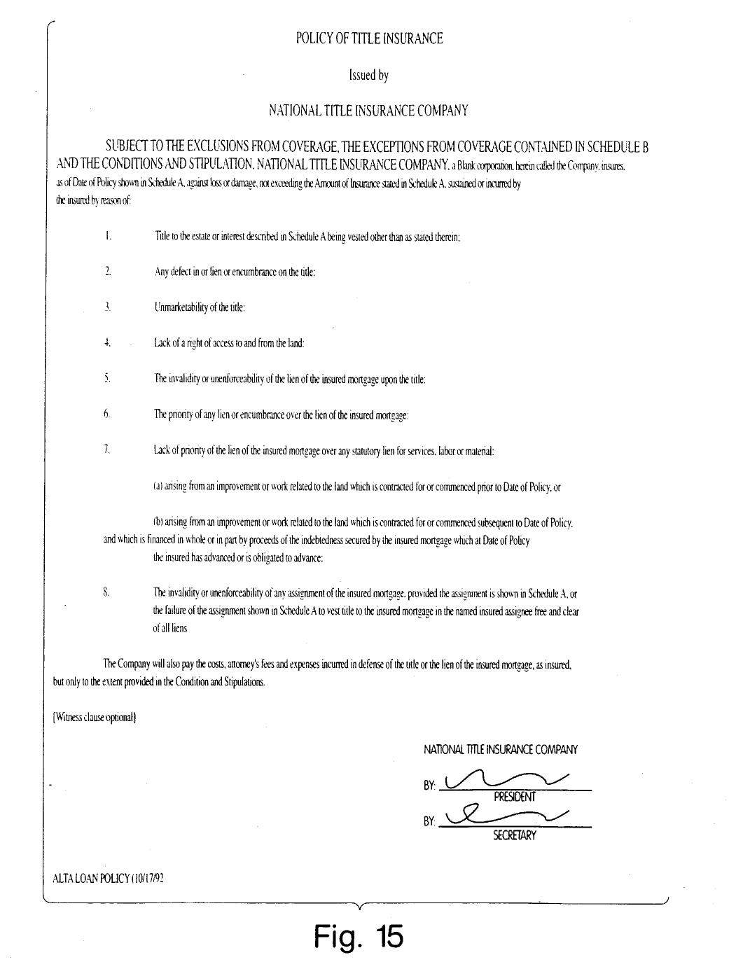

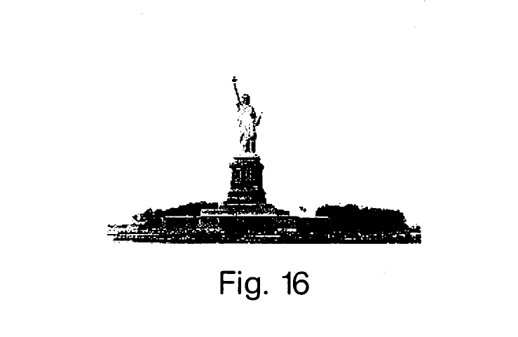

Referring again to FIG. 6, the system 30 also can provide more information to the user about the listed product or service, such as loan documentation (step 420) necessary for a buyer's due diligence. A user can obtain this information by clicking on the “buy documents” link 510 shown in FIG. 9. In some embodiments, the system 30 charges the user a fee for these documents. FIGS. 11 through 17 are representative screen shots illustrating some of the types of information that can be provided as a due diligence document. FIG. 11 is a representative screen shot illustrating a financial product's summary information provided to a user, in accordance with an embodiment of the invention. FIG. 12 is a representative screen shot illustrating a financial product's statistical information provided to a user, in accordance with an embodiment of the invention. FIG. 13 is a representative screen show illustrating a financial product's collateral information provided to a user, in accordance with an embodiment of the invention. FIG. 14 is a representative screen shot showing an example of a portion of the mortgage note documentation available to a user, in accordance with an embodiment of the invention. FIG. 15 is a representative screen shot showing an example of a portion of the title insurance documentation available to a user, in accordance with an embodiment of the invention. FIG. 16 is a representative screen shot showing an example of a picture of a property associated with a financial product for sale, which picture is available to a user, in accordance with an embodiment of the invention.

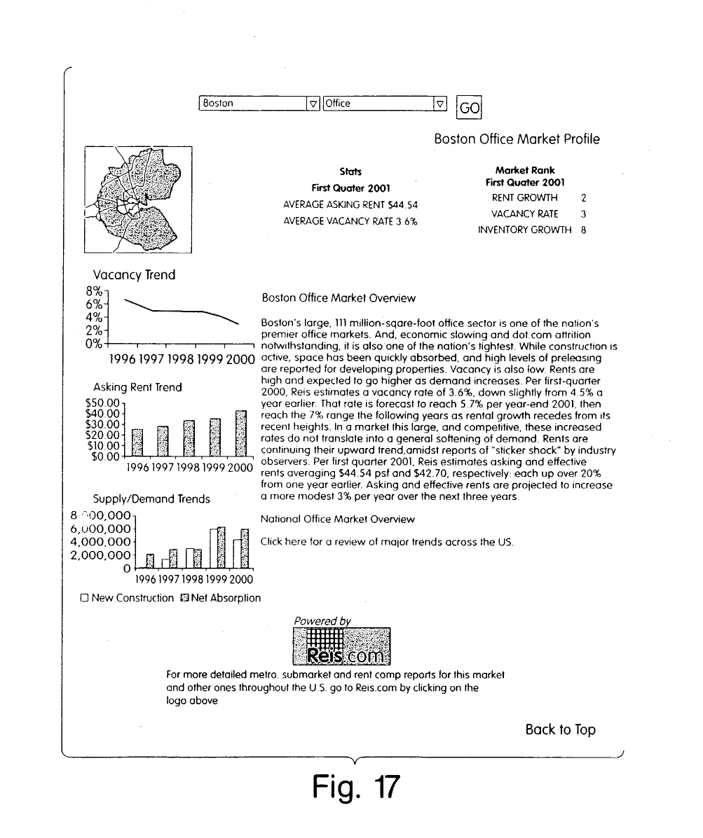

In addition, in at least one embodiment of the invention, the financial product information provided by a Seller 102 is supplemented with value-added information provided by another entity, such as the administrator of the system 30 and/or third party information. FIG. 17 is a representative screen shot showing an example of third party information available to a user in accordance with an embodiment of the invention. In FIG. 17, the example third party information includes general information provided relating to a geographic area where the collateral for a given financial product may be located.

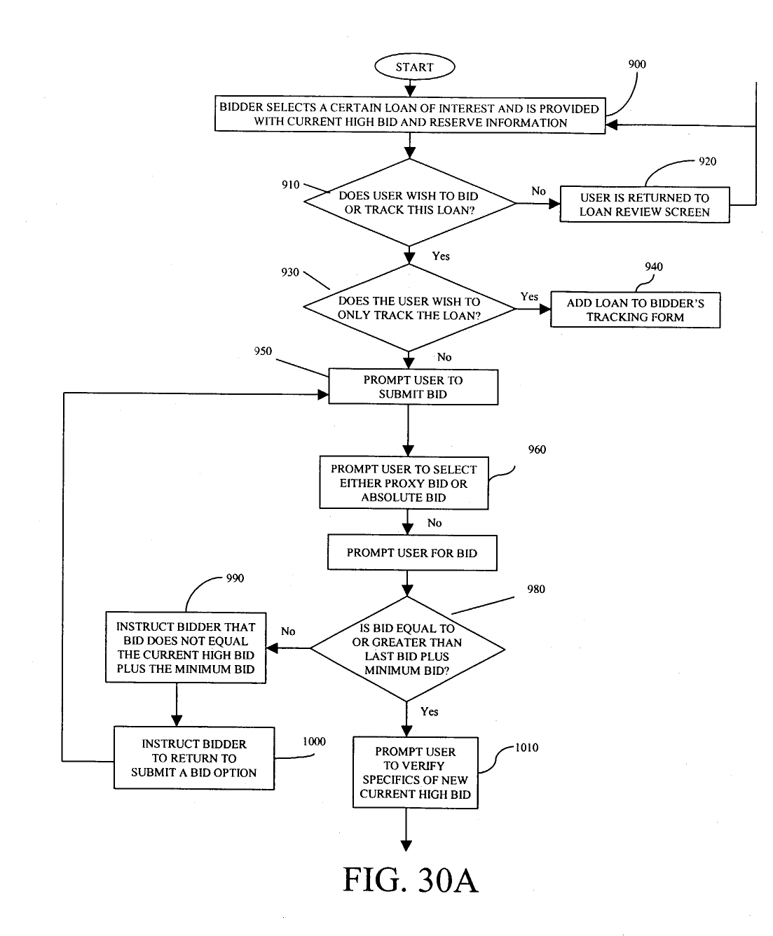

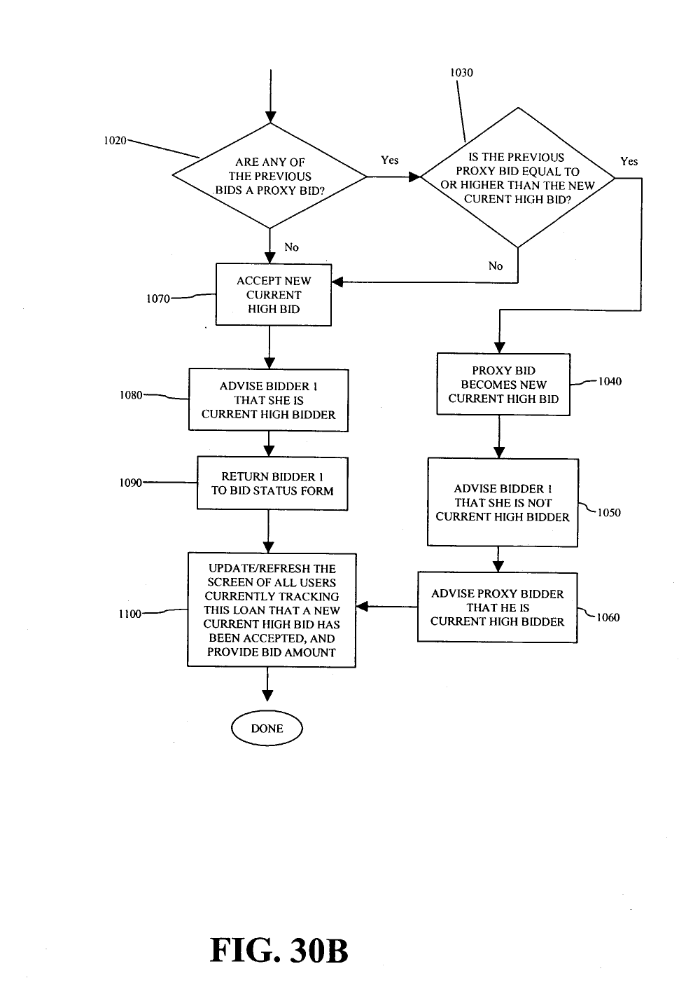

Referring again to FIG. 9, when appropriate, a user can go from the financial product summary page to a bid process (such as that described in the process of FIG. 30), using the bid link 512. However, in at least one embodiment of the invention, the system 30 tracks whether or riot a Bidder 100 who is attempting to bid on a financial product has obtained the due diligence materials. One reason for doing this is to insure that the Seller 102 and/or the system 30 have satisfied NASD requirements for disclosure prior to the sale of a financial product.

In at least one embodiment of the invention, if a user has obtained loan information, such as due diligence materials, the system 30 can provide the user with automatic updates for any additional information relevant to (or that the system 30 receives) about the loan. The updates can, for example, be provided periodically, or as needed, or at the request of a Seller 102, or at the request of a Buyer 100. Similarly, if the user obtained a report on a particular physician from a state licensing board, if the system 30 receives additional relevant information about that physician, the system can provide those updates to the user or potential Bidder 100.

Referring again to FIG. 6, the user can take other actions after receiving the results of the search (step 310). For example, the user can compute a price for a listed financial product (step 430), which is explained more fully herein and in the cross-referenced applications. This can be a quick price as described herein, or can be another pricing mechanism, such as that described below. However, if the time to bid for a financial product is approaching, or the time for bidding is a predetermined amount of time away (e.g., three days), the system 30 notifies the user reviewing the information (steps 450 and 460).

A user can also submit questions to the system 30 about a product or service, and/or submit questions to the system 30 about any documentation that the user received about the services or products being auctioned off (step 470). The queries can be submitted in many different ways, including via a message sent over a computer network, such as an email, via a telephone call or fax to an administrator of the system 30, via a letter, or any other suitable means of communication. The system 30 can respond to the queries (step 480) in similarly varied ways, and need not respond to the user in the manner in which a query was received. If necessary, in at least one embodiment, although not illustrated in FIG. 6, the system 30 can query a Seller 102 for any information or responses needed to respond to the query of a user. If the system 30 has updated financial product information (step 490) to provide to a user, it can do so.

In at least one embodiment, the user can perform actions on the search results not illustrated here, such as “HIDE” and “UNHIDE”. With the “HIDE” function, a user may filter the list of search results further by “hiding” any products or services that are not of interest. In this situation, if the user filters out boats over ten years old, subsequent user searches will “hide” all boats that are older than ten years. At any time, a user can “UNHIDE” search results to view all products and services that meet his search criteria.

It should be understood that, in accordance with various embodiments of the invention, steps 410 through 490 can be done in virtually any order and need not be completed in the order shown.

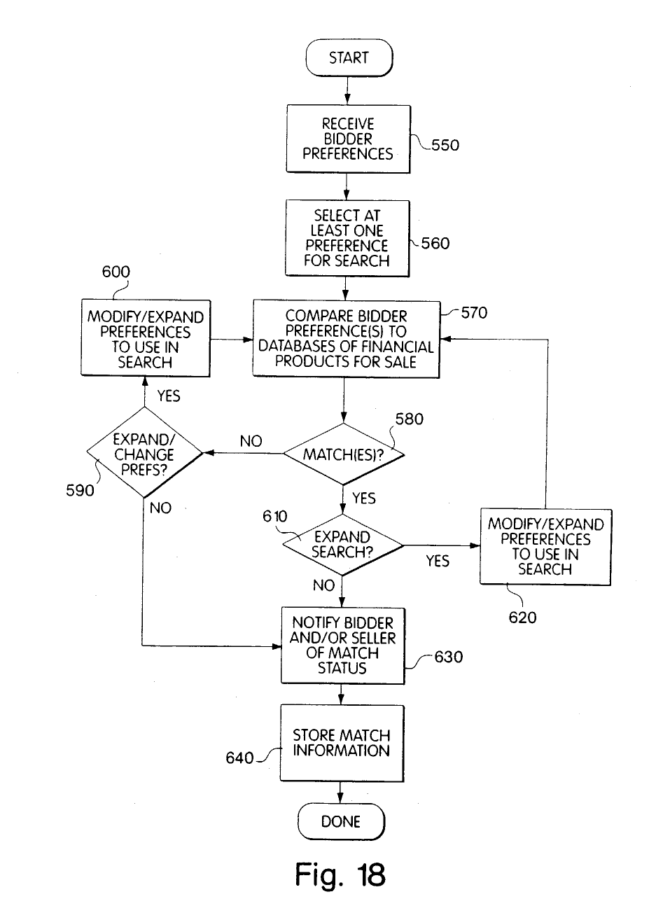

In at least one embodiment of the invention, the system 30 can perform searches of products or services automatically on behalf of any entity for which the system 30 has stored a set of preferences or a profile. This type of search can be done on a periodic basis, or every time a new financial product for sale or information about a financial product for sale is added to the system 30, or any time any characteristic of a given product or service changes, or on a basis set by a user (e.g., weekly, daily, etc.). FIG. 18 is a flowchart illustrating a process for automatically searching a database of financial products, in accordance with an embodiment of the invention.

As illustrated in FIG. 18, the system 30 receives one or more bidder preferences (step 550), representing one or more criteria that a bidder has for the type of product or service he is looking for. In at least one embodiment, the bidder himself provides the bidder preferences. In at least one embodiment, the system 30 extrapolates at least one bidder preference based on the profile of the bidder. In at least one embodiment, the system extrapolates at least one bidder preference based on a bidder's trading history.

The system 30 selects at least one preference on which to search (step 560), and searches its databases for products or services meeting the criteria in whole or in part (step 570). If no matches are located (step 580), the system can modify the criteria on which it searches (steps 590, 600). For example, if no matches were found using five criteria specified by a bidder, the system 30 could attempt a search using just four of the five criteria. In at least one embodiment, a user can specify whether or not the system 30 can attempt such changes to the criteria.

If matches were found (step 580), the system 30 can still attempt to determine whether the search should be expanded (step 610). For example, if just one or two matches were located, the system 30 may attempt to modify the criteria to expand the results to some predetermined number of matches (step 620).

The system 30 notifies bidders of any matches (or lack thereof) (step 630), and can, if desired, store the results of its searches (step 640). The notification can be by any suitable means, including email messages, postings to a personalized web page (which the system 30 can maintain for a bidder), telephone messages, fax messages, pager messages, letters, so-called “Instant” messages sent to a mobile communications device, and the like. The stored results can be used, for example, at a later time, such as when a bidder logs on to the system 30 and seeks more information about the products or services being sold.

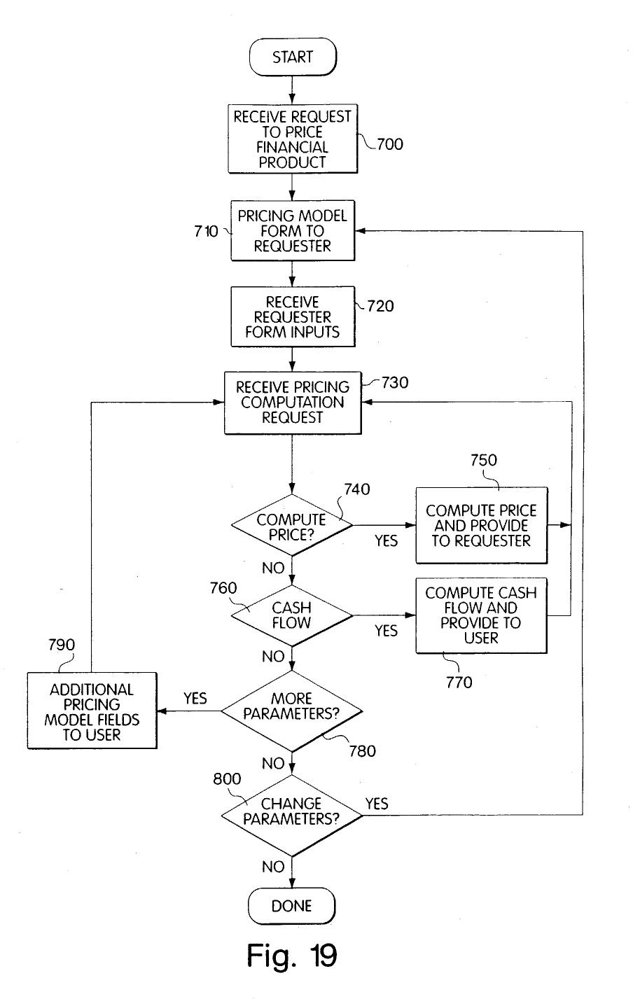

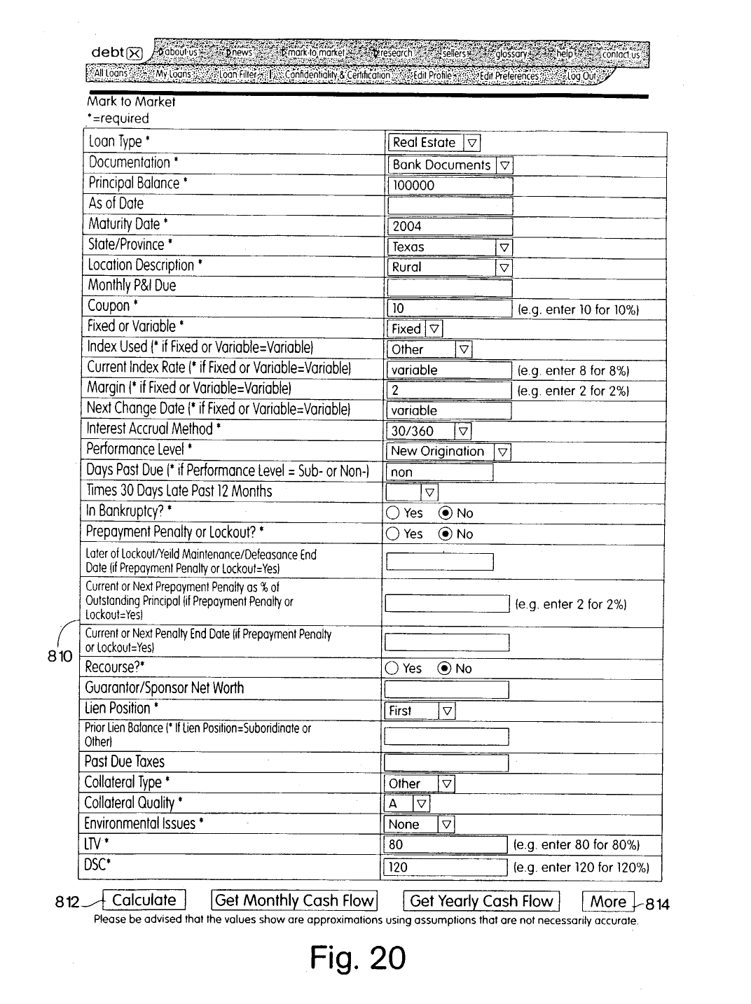

As noted previously, users of the system 30 (including at least Buyers 100, Sellers 102, and visitors/others) can price products or services offered for sale on the system 30. FIG. 19 is a flowchart illustrating a process for pricing a financial product, in accordance with an embodiment of the invention. As illustrated in FIG. 19, a user of the system can submit a request to the system 30 to price a product or service (step 700), and the system 30 provides the user with a pricing model form (step 710). FIG. 20 is a representative screen shot illustrating a pricing form 810 for pricing a product or service in accordance with an embodiment of the invention. As FIG. 20 indicates, users input the characteristics of the financial product they are interested in purchasing, such as the type of product, the principal balance, etc. Generally, the characteristics the user enters correspond to the information that the user has received about a financial product. However, in at least one embodiment, the user's entries can deviate from the listed information. For example, a user may want to calculate a cash flow for a financial product that assumes a different interest rate than currently listed for the product.

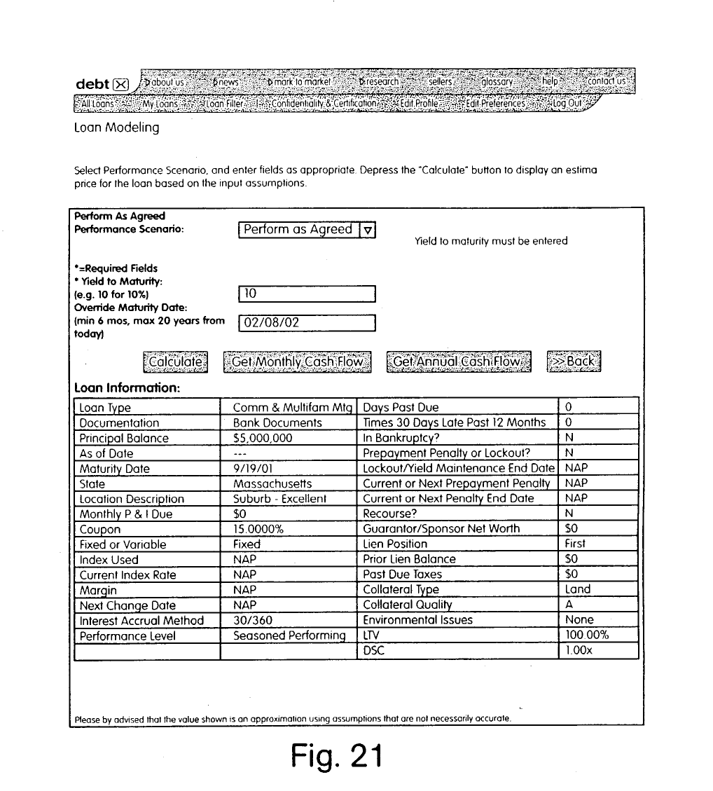

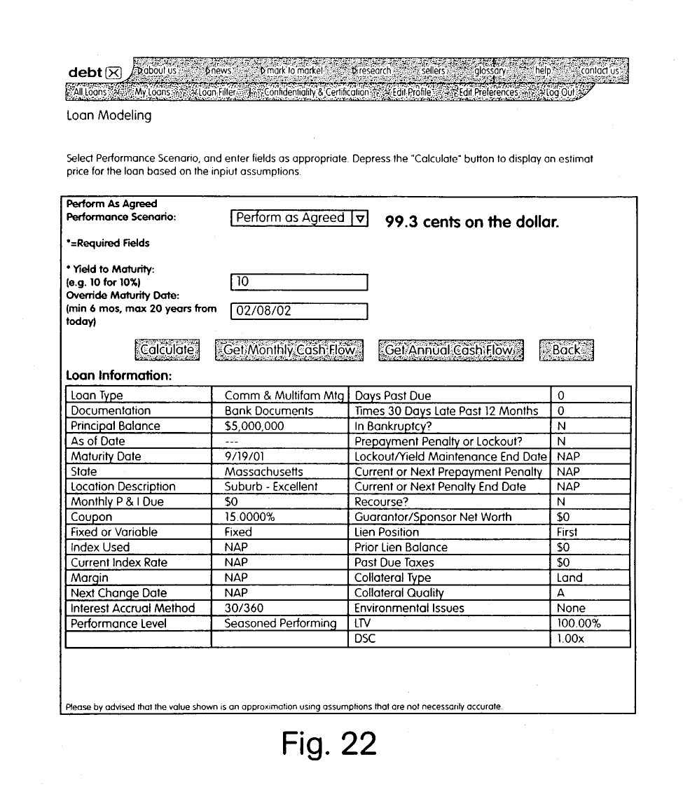

The system 30 receives the pricing computation request (step 730), and, if requested (step 740) computes a price (step 750) for the desired product or service. In at least one embodiment, the computation is done in substantially the same way as the computation done for a Seller 102 seeking a price (see FIG. 4). For example, in FIG. 20, if the user presses the “calculate” button 812, the system 30 returns a calculated price, such as in cents on the dollar, basis points, or other suitable measure, for the value of the financial product. FIG. 21 is a representative screen shot illustrating a form for performing a computation on a financial product, in accordance with an embodiment of the invention, and FIG. 22 is a representative screen shot illustrating the results of the computation requested in the screen shot of FIG. 21, in accordance with an embodiment of the invention. In FIG. 22, the computation results in a price of “99.3 cents on the dollar” for the listed financial product, which is a loan having a principal balance of five million dollars, performing as agreed.

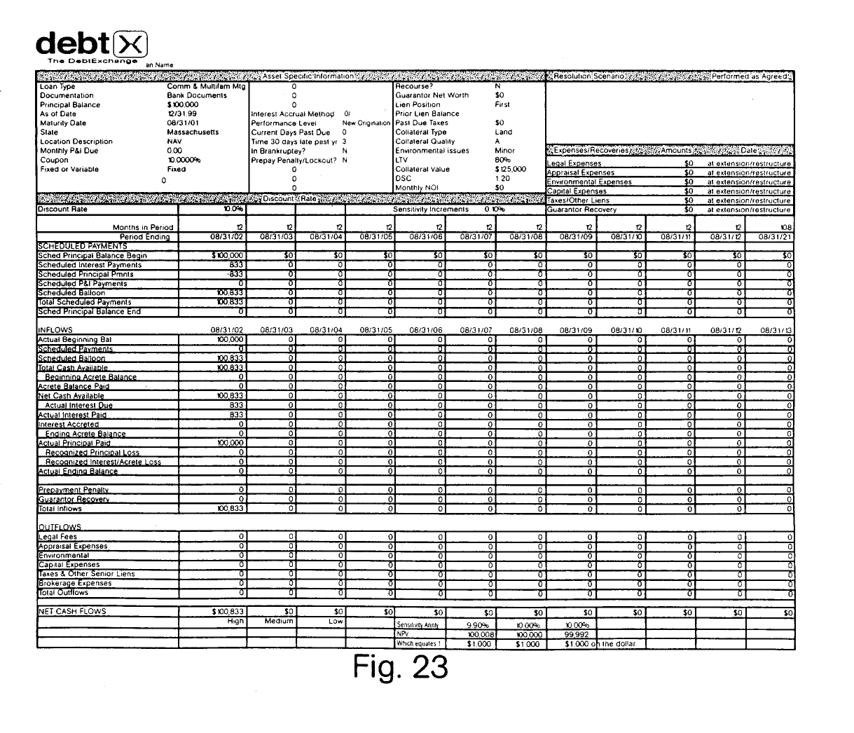

Referring to FIG. 19, if the user requests “cash flow” (step 760) the system 30 computes a cash flow, such as monthly or annually (step 770). FIG. 23 is a representative screen shot illustrating a spreadsheet showing yearly cash flow, in accordance with an embodiment of the invention.

Referring to FIG. 19, in at least one embodiment of the invention, a user can compute the price of a product or service based on addition parameters (step 780), which the user can provide or which the system 30 can provide (step 790). For example, the system 30 provides pull down menus permitting users to perform computations such as foreclosure, extension/restructure, and Direct Pay Off (DPO)/Early Payoff.

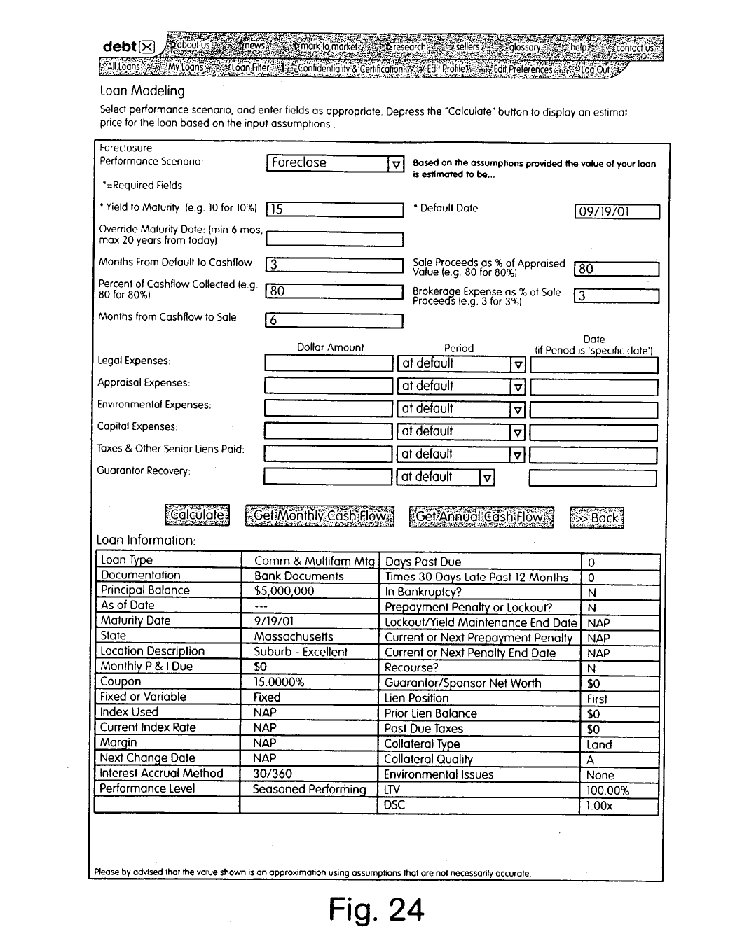

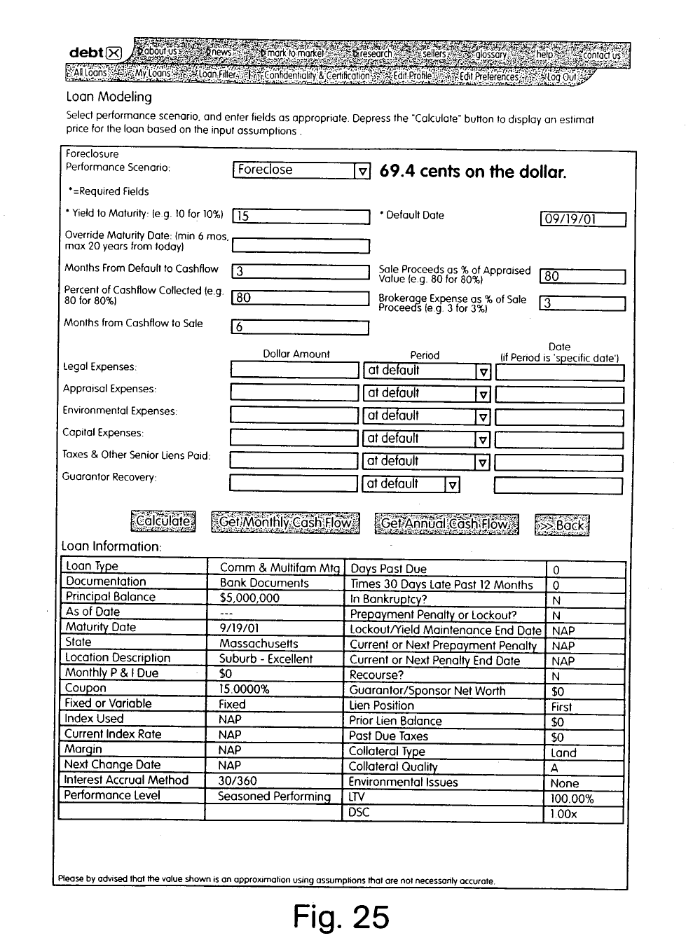

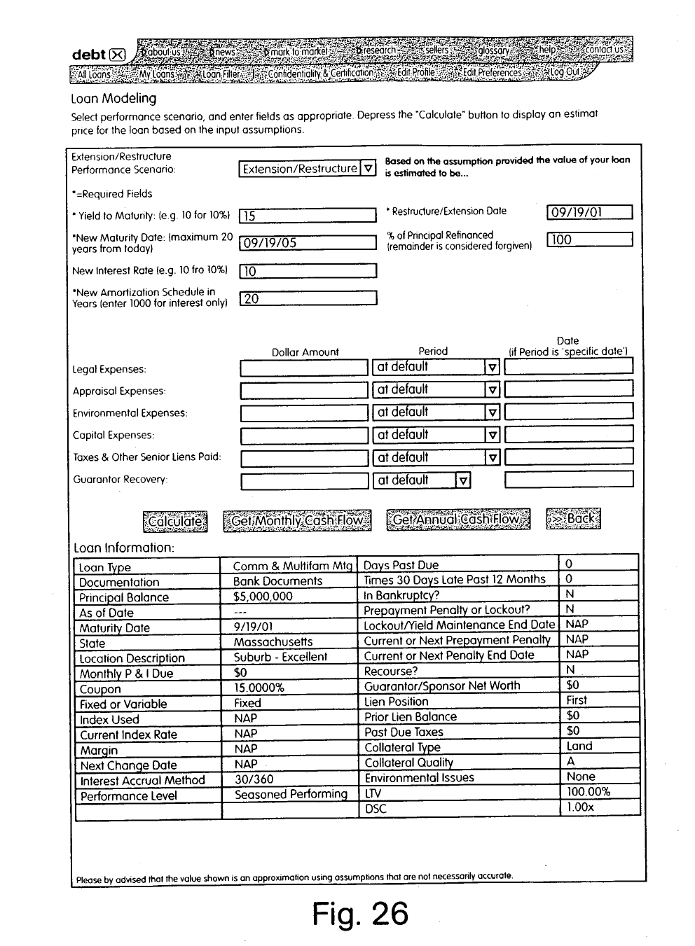

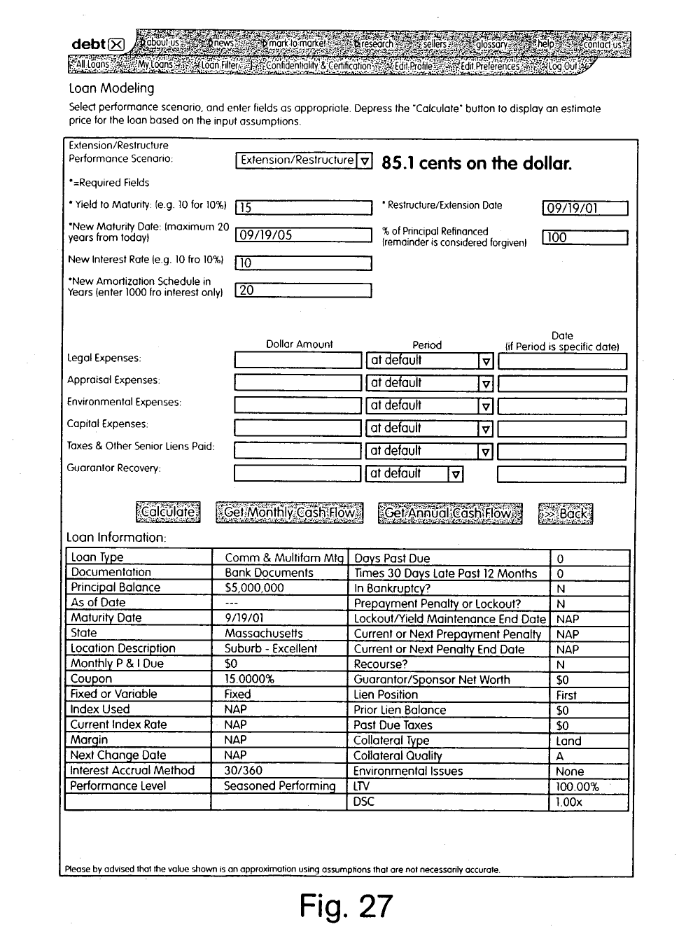

FIG. 24 is a representative screen shot illustrating a form for performing a foreclosure computation on a financial product, in accordance with an embodiment of the invention, and FIG. 25 is a representative screen shot illustrating the results of the computation requested in the screen shot of FIG. 23, in accordance with an embodiment of the invention. FIG. 26 is a representative screen shot illustrating a form for performing an extension/restructure computation on a financial product, in accordance with an embodiment of the invention, and FIG. 27 is a representative screen shot illustrating the results of the computation requested in the screen shot of FIG. 25, in accordance with an embodiment of the invention.

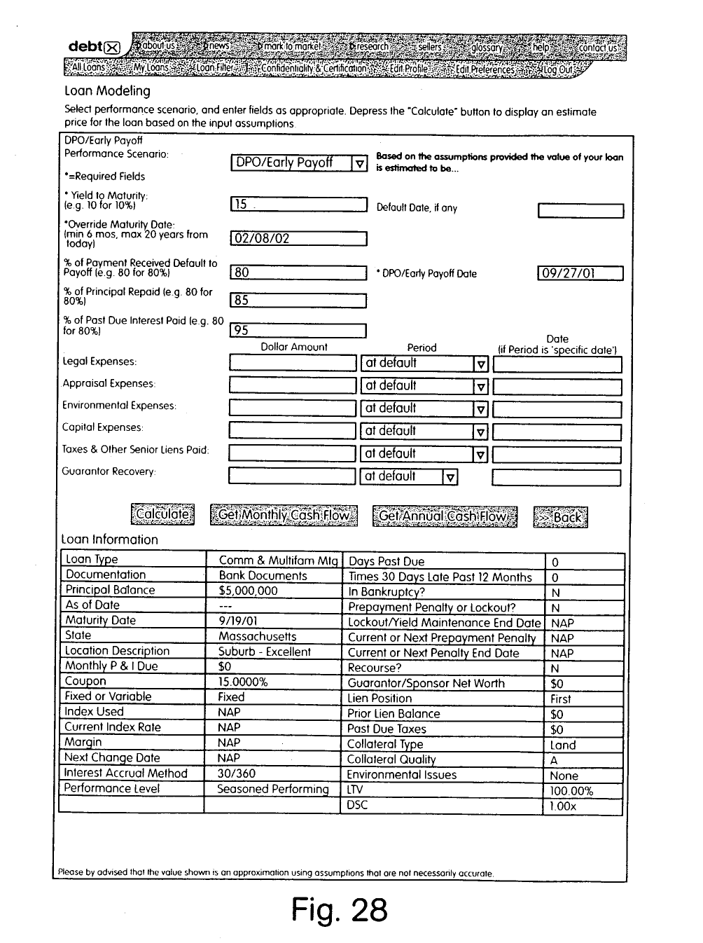

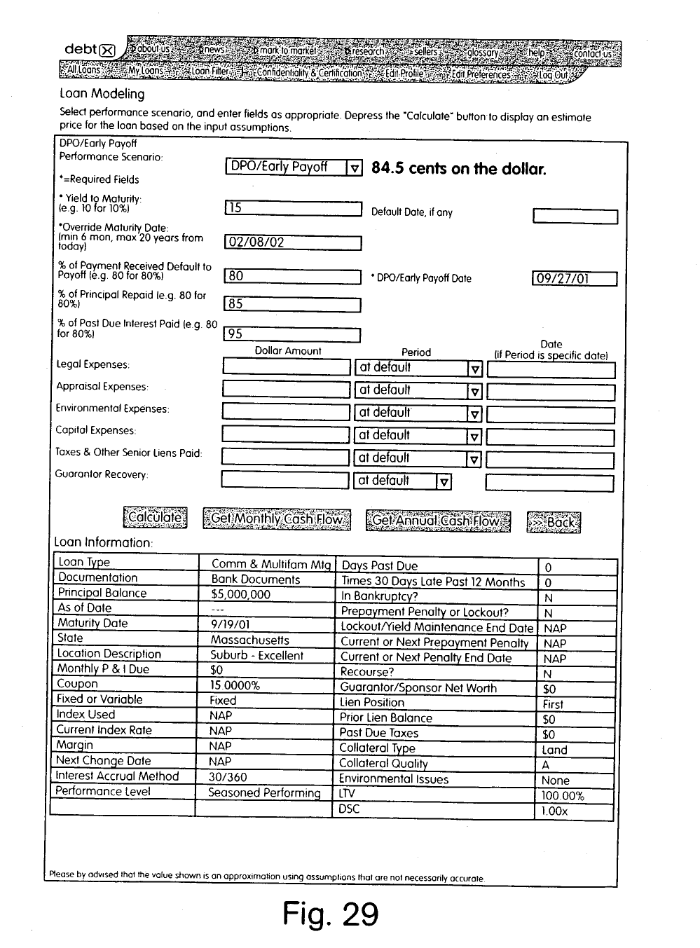

FIG. 28 is a representative screen shot illustrating a form for performing an DPO/Early Payoff computation on a financial product, in accordance with an embodiment of the invention, and FIG. 29 is a representative screen shot illustrating the results of the computation requested in the screen shot of FIG. 27, in accordance with an embodiment of the invention. Of course, the options provided are by way of example only and are not limiting. The additional parameters that can change the price computation can vary depending on the financial product.

In the preferred embodiment of the present invention, users are provided with the ability to bid on products and services which have been offered for auction by a Seller 102. FIG. 30 is a flowchart particularly illustrating a process for bidding on a financial product, however, the process in FIG. 30 can also be employed to auction off any type of product or service. Moreover, the process illustrated in FIG. 30 is more extensive than might otherwise be needed to implement such an auction.

The present invention illustrated by the embodiment in FIGS. 30A and 30B is implemented in accordance with a standard bidding policy to enable users to bid on a financial product, such as a loan, using the English forward auction format. However, in at least one embodiment of the present invention the Seller 102 can specify a bidding policy or bidding format to be employed in auctioning off their product or service. Table 4 lists examples of other bidding policies or bidding formats which can be used in accordance with some embodiments of the present invention. The various bidding policies or bidding formats listed in Table 4 can be implemented using various methods, in conjunction with the present invention:

TABLE 4
Example Bidding Policies and Formats

| | |
|---|---|
| Sealed Bid | Bids must be received on or before the stated bid deadline |
| | and are not reviewed prior to the deadline. No bidder is aware |
| | of other bid amounts or conditions. A Sealed Bid forum may |
| | or may not be subject to a Reserve Price. |
| Modified | Financial product is offered firm at a specified price for a |
| Sealed Bid | specified period. Converts to Sealed Bid after firm offer |
| | period expires. |
| Open | Bids are received on an ongoing basis up to the bid deadline. |
| Auction | All bids and conditions are posted for all existing and |
| | potential bidders to review. Bidders may make multiple bids |
| | on any product or service provided that each subsequent bid |
| | is an improvement over the most recent bid submitted. An |
| | Open Auction may or may not be subject to a Reserve Price. |
| Indicative | Indicative bidding is generally a two-stage process whereby |
| | the seller/broker solicits a first round indication of what a |
| | buyer might pay for an asset. After a review of the indicative |
| | bids, the seller/broker generally chooses one or more bidders |
| | to confirm or improve their bid, usually requiring this be done |
| | within a specified period of time. The bidders chosen to |
| | participate in this second round are generally chosen based |
| | upon their bids and/or the seller/broker's opinion of their |
| | ability to close. |
| Negotiated | Buyers and Sellers negotiate the final sale price. This may be |
| | conducted before or after a request for Indicative Bids. |
| Firm Offer | A firm price is listed and the financial product will not sell |
| | until a bidder agrees to the listed price. The seller has the |
| | right to accept or reject nonconforming bids. |

It should also be understood that the present invention can be implemented to accommodate virtually any transaction format that a Seller 102, Buyer 100, or other party (e.g., broker) wishes to utilize, including the ones listed in Table 4.

Although the present invention is modeled on the English forward bidding format, it is not a true English forward format because the bidding is not open. For example, while in a typical English forward auction all the bidders always know the current high bid at any given time and are able to see how other bidders are participating, in the present embodiment of the English forward auction, the bidding is anonymous to other bidders. Therefore, although a bidder or tracker can view the current high bid, the bidder/tracker does not know the identity of the other bidders. Nor can a given bidder/tracker view any bid history except their own on a given auction. This present embodiment of the typical English forward auction format is advantageous to the Seller because the bidders that take part in a given auction will submit higher bids in that auction than they would have if the auction had been open and they were able to view the bidding history of all bidders. The bidders will also submit bids that are higher than they would have if the auction had been conducted in a closed bidding format which employed sealed bids because the bidders are not able to ensure that their bid is in conformance with the bid's submitted by the other bidders.

The present embodiment of the English forward auction is also advantageous to bidders, when compared to a closed bid format, because the format of the present embodiment allows all bidders to know when they have been outbid, and view the amount they need to bid in order to become the current high bidder. Therefore, they are able to submit increasingly higher bids as necessary prior to the close of a given auction. By comparison, in a sealed bid auction, bidders will only submit a single bid without knowledge of competing bids. Consequently, a bidder does not know whether his bid is high enough to win. Historically, bidders with a greater need to obtain assets have been empowered by the English forward auction format and consequently have driven prices for a given item higher than expected. In the following two examples, neither bidder could have been able to achieve their goal of winning the auction, had it been held in a closed format, because they could not have increased their bids appropriately.

In a first example, the present embodiment of the auction system 30 auctioned off three consecutive offerings of similar assets on the same day. Eight bidders participated on the first auction. One of those eight bidders indicated that he would only participate in the latter two auctions if he won the first auction because he needed to win all three offerings. The reason this bidder needed to win all three offerings was because he needed to achieve a critical mass of loan products in order to implement his exit strategy. Therefore, because he was able to view the current high bid, he was able to out bid all his competitors and win the first offering. And upon winning the first offering, he needed to win the next two offerings to meet his objective. This increased need to win the second two offerings on the part of that bidder, maximized the proceeds for the seller of at least the second two auctions, if not all three.

In a second example, the auction system 30 of the present invention conducted two auctions on the same day. Although the portfolios of both financial products being offered were similar, there was enough differentiation in the underlying assets that each auction appealed to bidders differently. Because of internal goals and internal budgetary constraints, one bidder needed to win one of the offerings, but did not want to win both. Therefore, when she was unsuccessful in the first of the two auctions, she became highly motivated to win the second auction. Because of her heightened motivation to win the second offering, this bidder increased the going price high enough on the second auction to ensure a win. Accordingly, the modified English format employed by the present invention not only benefited the winning bidder by allowing her to know how much she needed to bid in order to win, but it also benefited the seller because the winning bidder bid more than she would have had the auction been a closed format.

Because the present invention is offered to users via computer, via wireless and/or via the Internet, it results in increased participation in the auctions than if those same auctions were offered or conducted by telephone, email and the like. Therefore, the increased participation in each auction aids in increasing the pricing premiums for each offering. Although simply increasing the number of bidders will not necessarily lead to higher proceeds, the increased level of participation will positively impact other competitive issues, thereby driving up the pricing premium. These competitive issues include cost of capital, the ability to diversify portfolio holdings, or the ability to locate similar product.

In regard to the auctioning of financial products, the present invention is particularly well suited to offerings containing homogenous pools of performing loans. The present invention is especially well suited to auctioning financial products containing performing loans when the valuation of the underlying assets can be accurately calculated within a relatively narrow range.

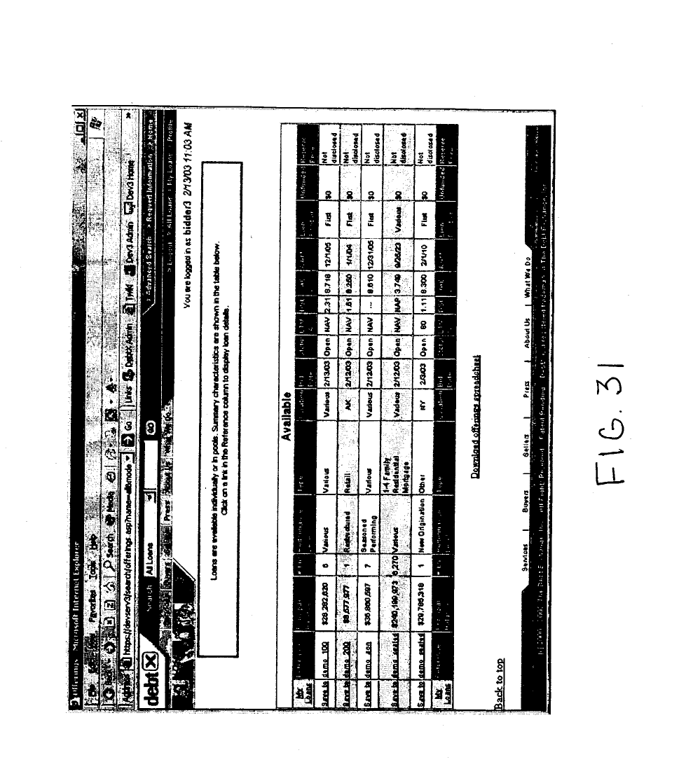

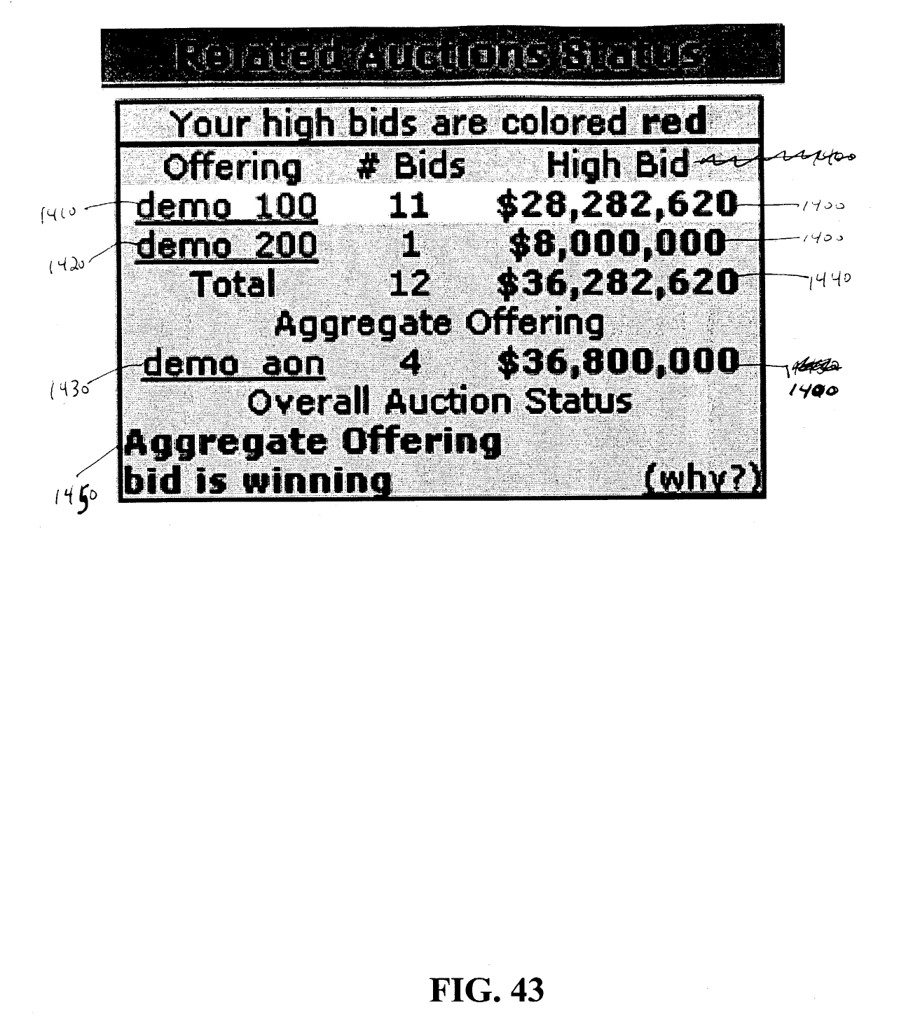

Referring again to FIGS. 30A and 30B, the auction process begins with a user selecting a certain type of loan that she is interested in from the list of available loans (step 900). FIG. 31 is a representative screen shot of the Loan Review Form illustrating a form for potential bidders to review loans that meet their selection criteria previously entered into the system 30, in accordance with an embodiment of the invention. After the user selects a loan of interest, the auction system 30 asks the user whether they wish to bid and/or track the selected loan (step 910). If the user decides to not bid and/or track the selected loan, the auction system 30 returns the user to the point where she can select a new loan to track or bid on. If the user does wish to bid and/or track the selected loan, the system 30 asks the user whether they want to only track the selected loan (step 930). If the user only wishes to track the loan, the system 30 adds the selected loan to the user's loan tracking screen (see FIG. 43) described herein (step 940).

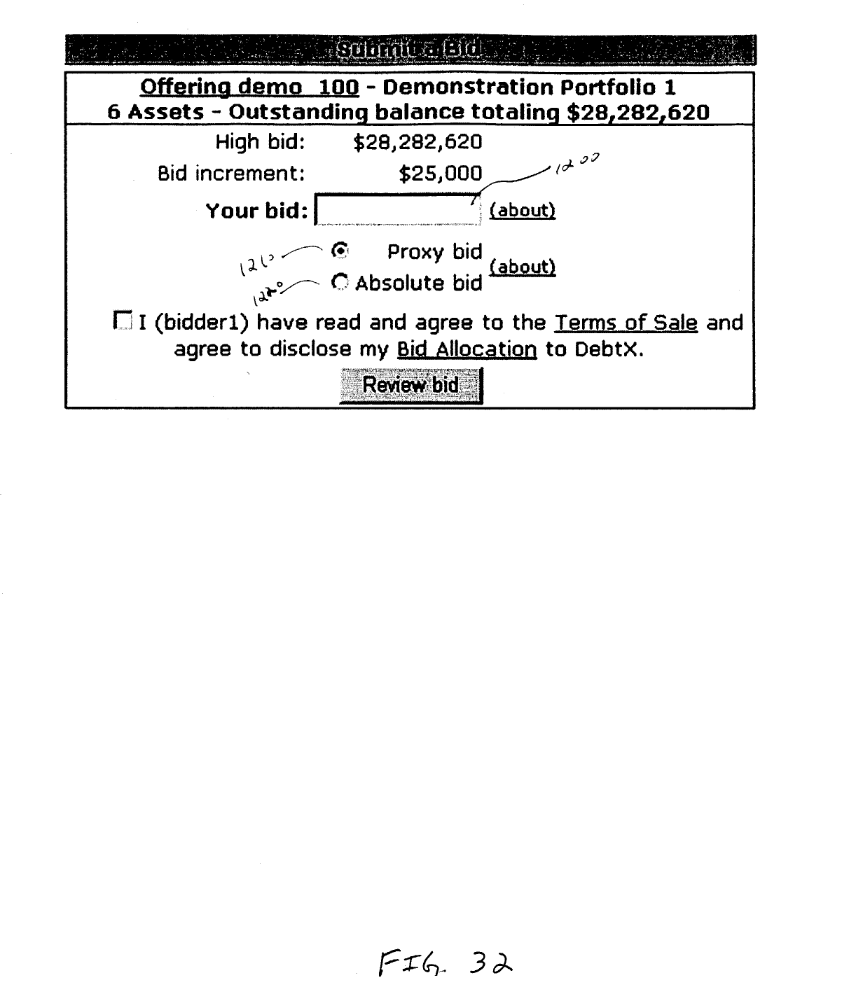

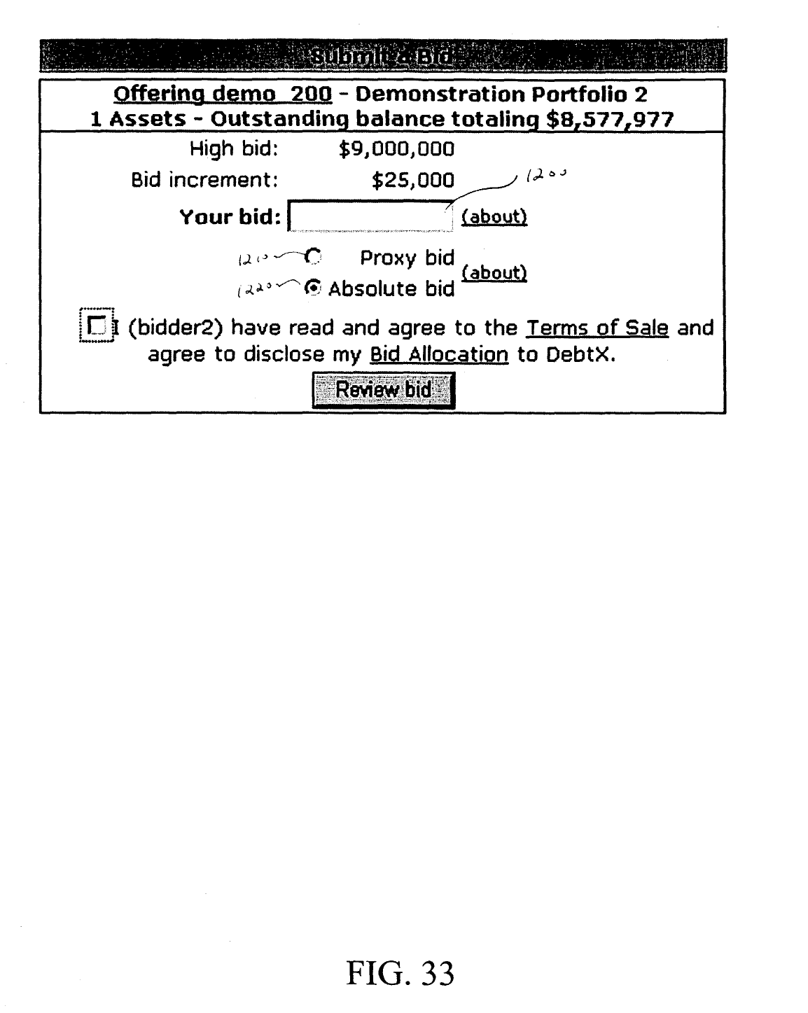

If the user decides to not only track the loan but bid on that loan, the auction system 30 asks the user to submit a bid (step 950). Next the auction system 30 prompts the bidder to select whether their bid is an absolute bid, or proxy bid. FIG. 32 is a representative screen shot of and illustrates the Submit A Big Form as prompted to the user, and asks the user to enter their bid 1200, and indicates the bid is a proxy bid 1210. FIG. 33 is a representative screen shot of the Submit A Bid form after the user selects the absolute bidding format 1220 in accordance with an embodiment of the present invention. The system 30 at this point could perform the “due diligence investigation” and conduct the “conditions to bid” inquiry discussed in the cross-referenced applications.

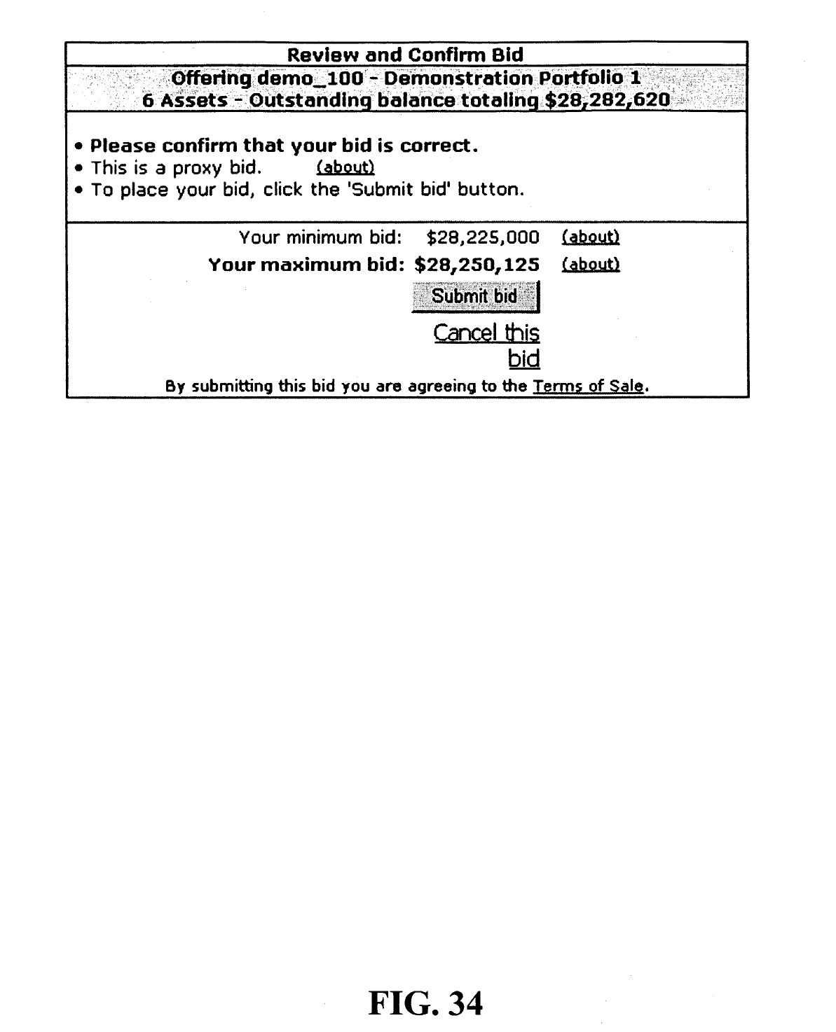

Also the system 30, after receiving the user's bid in steps 950-960, checks to determine if the user's bid is equal to or greater than the sum of the last bid plus the amount of the minimum bid (step 980). If the user's bid is not greater than or equal to the sum of the current high bid plus the minimum bid, the system 30 will inform the user of that fact (step 990), and instruct the bidder to return to the point where she can submit a new bid (step 1000). If the user's bid is greater than or equal to the sum of the current high bid plus the minimum bid, the system 30 will prompt the user to verify the specifics of their bid, which is now the new current high bid (step 1010). FIG. 34 is a representative screen shot of the Bid Verification Form illustrating a form for potential bidders to verify the criteria they are submitting as their bid on a previously selected loan, in accordance with an embodiment of the present invention. FIG. 34 can also be used in conjunction with confirming the submission of a proxy bid.

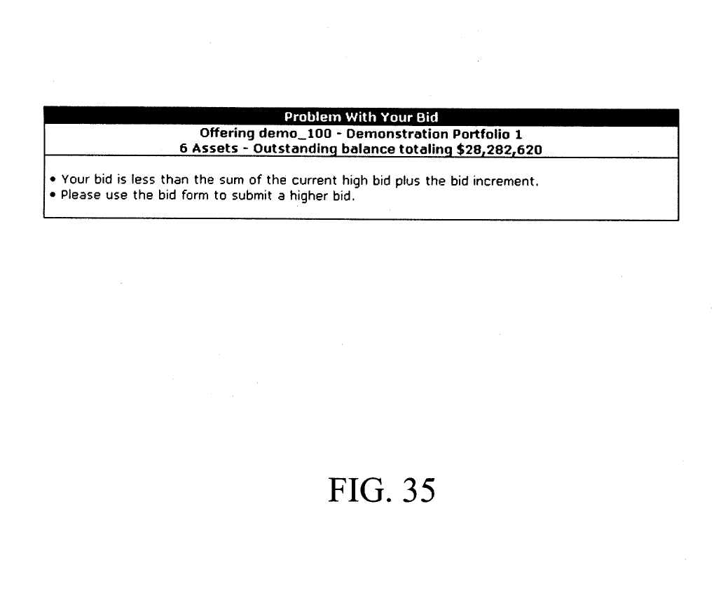

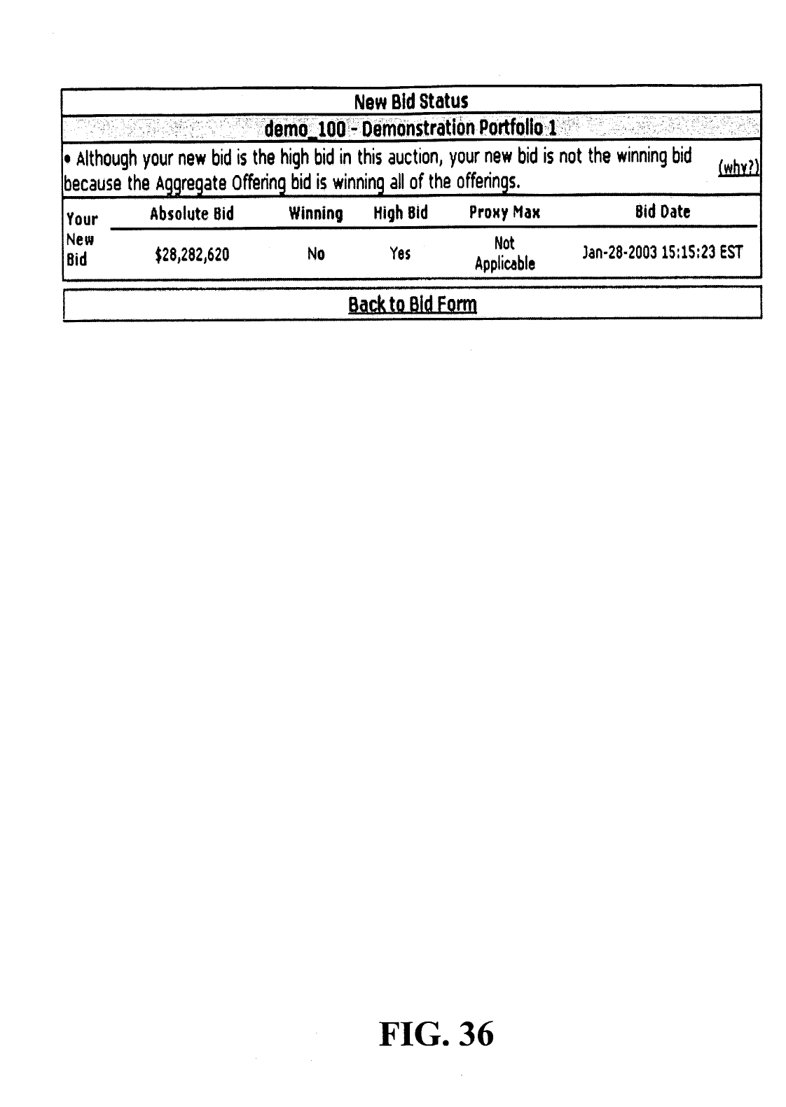

The system 30 next determines whether any of the previously submitted bids are a proxy bid (step 1020). If the system 30 had previously accepted a proxy bid, the system 30 then determines whether the previous proxy bid is equal to or greater than the new current high bid (step 1030). For purposes of illustration but not limitation, it can be assumed that the current high bid is equal to $100,000, and that the maximum value of a previously submitted proxy bid value is also $100,000. Because the proxy bid was submitted to the auction system 30 prior to the user's new current high bid, and because the two bids are equal in value, the system 30 accepts the proxy bidder as the new current high bidder (step 1040). The system 30 advises the user that she is not the current high bidder (step 1050), and then advises the proxy bidder that he is the current high bidder (step 1060). FIG. 35 is a representative screen shot of a type of the Bid Not Accepted Form illustrating a form which informs potential bidders that their bid had not been accepted by the auction system 30, and attempts to explain why. FIG. 36 is a representative screen shot of the Bid Confirmation Form illustrating a form that informs potential bidders that their bid had been accepted by the system 30. The Bid Confirmation Form will also inform the bidder whether they are the current high bidder or winning bidder on a item, and whether or not they hold the winning bid in an Aggregate Offering, if applicable.

Alternatively, a similar version of step 1060 is the situation where the proxy bidder had previously submitted a proxy bid with a maximum value of $100,001 and the user submitted a bid of $100,000. Even if the minimum bid is set at $10,000, because the proxy bid had been entered previous to the user's bid, and because the proxy bid is higher than the user's bid, the system 30 will accept the proxy bid as the new current high bid.

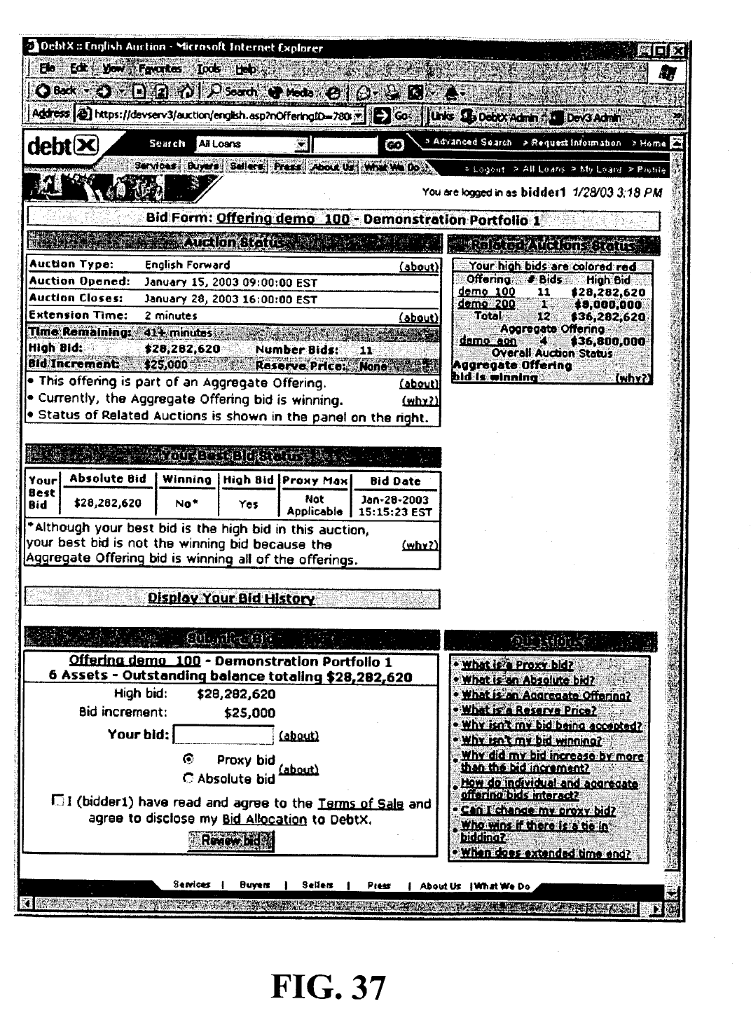

If there were no proxy bids submitted, or the previously submitted proxy bids were less than the user's bid entered in steps 950-960, the system 30 accepts the user's bid entered in steps 950-960 as the new current high bid (step 1070). Upon accepting the new current high bid, the system 30 advises the user that her bid submitted in steps 950-960 had been accepted and that she is the current high bidder (step 1080), see FIG. 36. The current high bidder can then monitor the status of her bid or bids using the form represented by FIG. 37 (step 1090). FIG. 37 is a representative screen shot of the Bid Status Form illustrating a form which informs potential bidders of the status of all items they have bid on up until that point, as well as informs them of the status of items that they are tracking. As discussed herein, the form illustrated by FIG. 37 contains detailed information on a specific loan, and provides highlight information on other loans in the “Related Auctions Status” section, that the bidder is interested in.

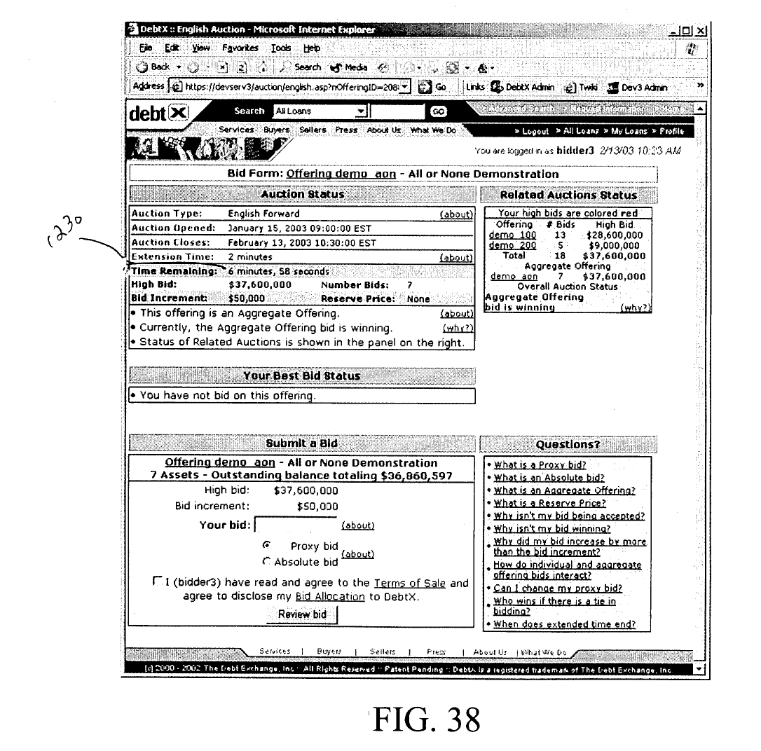

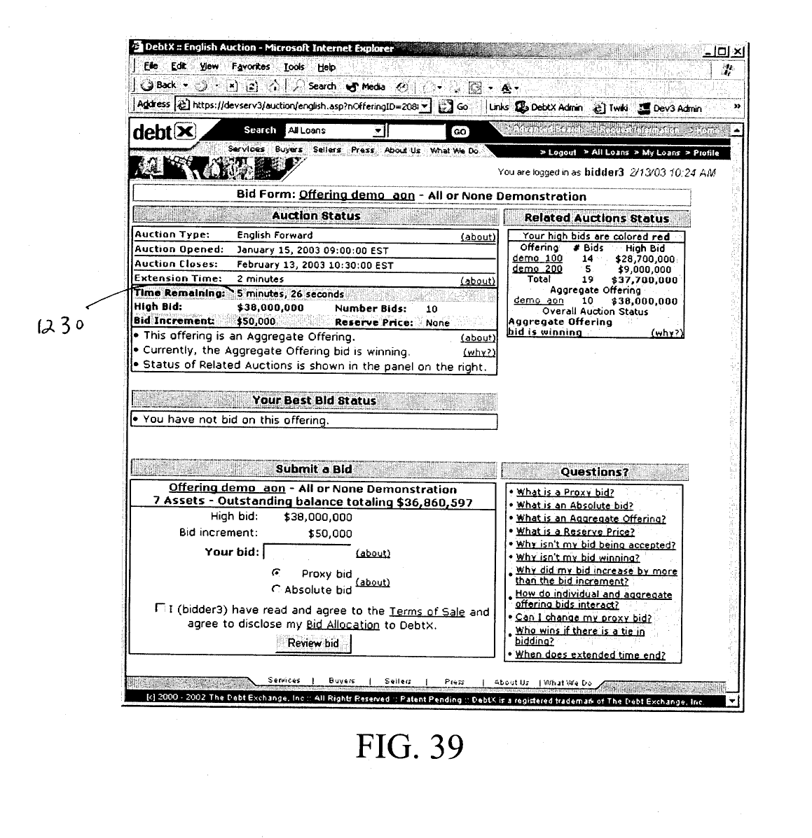

Upon accepting a new bid as the new current high bid, see steps 1040 and 1070, the auction system 30 also updates or refreshes the Bid Status Form of every user or bidder that has either bid on or is tracking that item (step 1100). FIG. 38 is a representative screen shot of the user's Bid Status Form prior to a proxy bid of $38,000,000 in regard to steps 1040 through 1060 being accepted. The “Time Remaining” 1230 informs the user that six minutes and fifty-eight seconds remain in the bidding. FIG. 39 is a representative screen shot of the user's Bid Status Form after the proxy bid of $38,000,000 in regard to steps 1040 through 1060 has been accepted. The “Time Remaining” 1230 informs the user that five minutes and twenty-six seconds remain in the auction.

An alternative embodiment of the present invention could simply send a page refresh to each user on an automated basis. For example, each user tracking and/or bidding on a loan could have their Bid Status Form (see FIG. 37) refreshed by the auction system 30 on a predetermined basis, such as every fifteen seconds.

The updating of all bidders' Bid Status Form once a new current high bid has been accepted by the auction system 30 or upon the expiration of a predetermined period of time is referred to herein as auto-refresh. This auto-refresh or update feature is important because as discussed herein, without that automatic update or refresh bidders/trackers who are interested in a certain product or service would not know that they are no longer the current high bidder. Similarly, without the automatic update or refresh, the bidders/trackers who are interested in a particular product of service might be misled into a false sense of security that the they could win an auction if they simply submitted an amount equal to the current high bid displayed on their screen plus the minimum bid, when in reality the current high bid surpassed that amount several minutes earlier.

One method in which the auto-refresh feature is made possible is because the system 30 previously stored the profile information of each user that is actively bidding on an offering's status, or that specified that they were tracking a specific loan regardless of whether they were tracking it live. Via the Custom Application Components 40, the User Profile database 50 and the Administration Components 44 or comparable modules, the system 30 is able to determine which product or service each and every bidder is tracking and/or bidding on. Therefore, when the current high bid associated with that product or service being tracked is increased via a new bid, the auction system 30 can auto-refresh or update each of the Bid Status Forms or other applicable forms for each Bidder tracking a given loan. Similarly, the system 30 can send via its other components, such as the Off The Shelf Application Components 42, an email, a page or other type of means by which a registered user of the system 30 tracking a given product or service learns that there is a new current high bid on that product or service of interest to them.

In another embodiment of the present invention, the auction system 30 can allow or deny access to the system 30 when a user attempts to log onto the system by combining, for example, their login information with the IP address of the location from which they are either attempting to login from, or bid from. For example, if a user previously registered with the system 30 and instructed the system 30 to only allow access from one location with a certain IP address or range of IP addresses, the system 30 would deny a login attempt from an unacceptable IP address. The system 30 could employ the information contained in at least the User Profile database 50 to accomplish this. Additionally, the user's IP address or user name allows the auction system 30 to track users as they move across the auction web site. Such tracking provides the auction house with various advantages, such as controlling a user's access, or data-mining the user's movements so that the auction house can market new products to that user.

As discussed herein and in the cross-referenced applications, the present invention auctions off various products and services. One of these products can be a financial product, such as a portfolio of loans. In a preferred embodiment of the present invention, these portfolios can be auctioned off as a whole, which is referred to as an aggregate offering. Alternatively, the system 30 can auction off each loan package individually, wherein each loan package might consist of several loans.

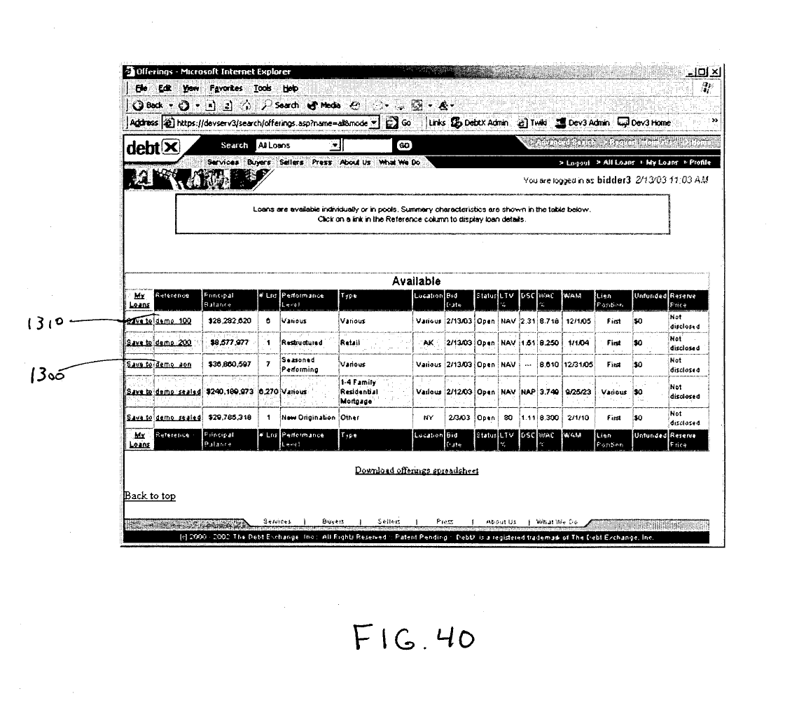

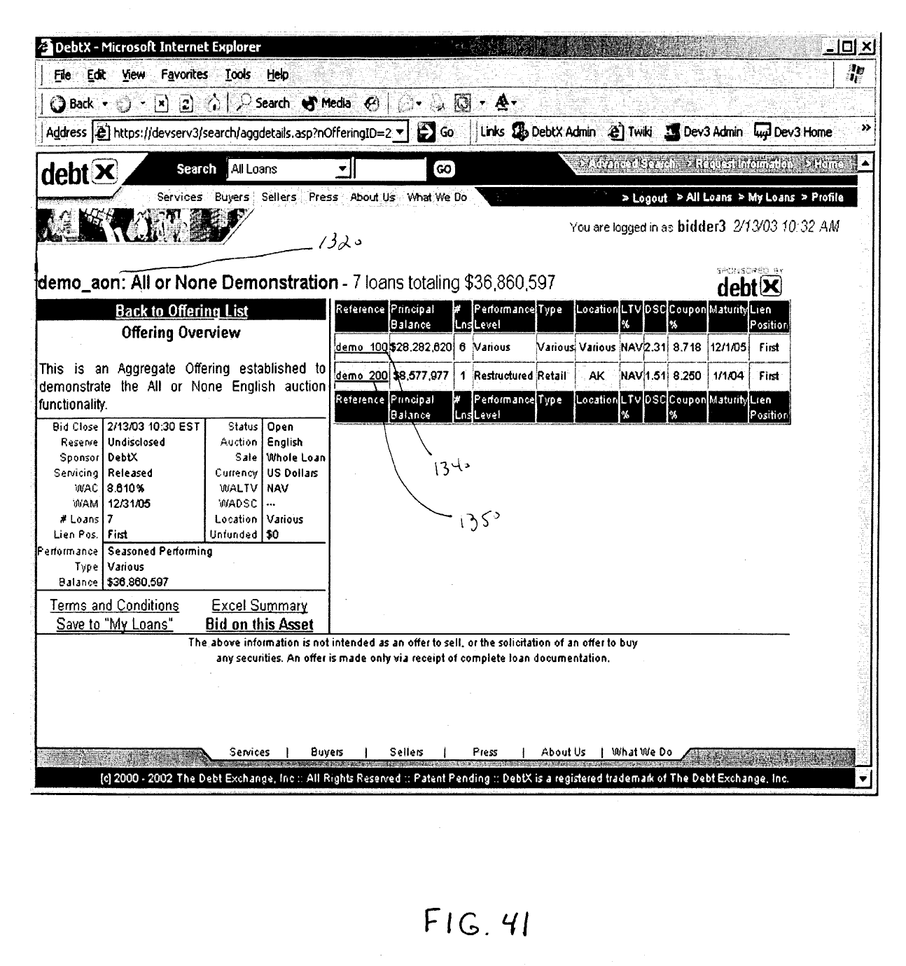

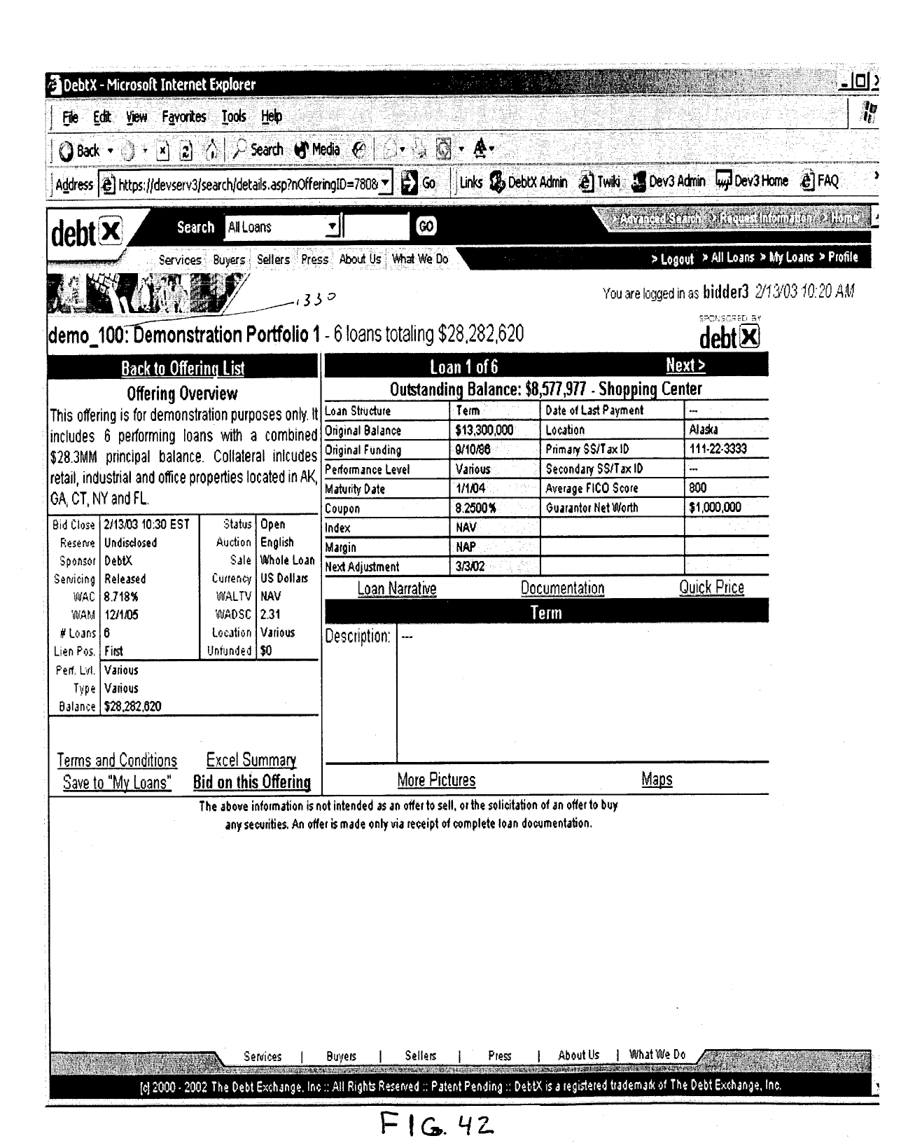

For example, FIG. 40 is a representative screen shot of the search results which match a user's criteria for a loan, which includes the loan offering “demo_aon” 1300, and demo_{—}100” 1310, in accordance with an embodiment of the present invention. FIG. 41 is a representative screen shot of the Aggregate Offering Form illustrating a form for potential bidders to review an offering (e.g., offering entitled “demo_aon“1320) containing several loans that can all be bid on at once, in accordance with an embodiment of the present invention. By comparison, FIG. 42 is a representative screen shot of an individual offering form, detailing a given loan pool (e.g., loan pool demo_{—}100 1330), which is a part of the aggregated loan portfolio “demo_aon,” in accordance with an embodiment of the present invention.

There are several advantages to both embodiments. For example, if a large heterogeneous portfolio of financial products can be divided into several smaller pools of homogenous loans, as shown in FIG. 42, it benefits the bidder because the smaller homogeneous offerings encourage participation by smaller bidders who would not otherwise be able to afford to bid on the desired properties because of the prohibitive size of the entire portfolio. Moreover, the smaller homogeneous pools do not prohibit the larger bidders from participating in the auction because they can instead bid on the larger grouped offering. This increased participation for the smaller homogeneous pools by both small and large bidders also provides a benefit to the seller because the total closing price of each smaller pool will typically be larger than if just the large heterogeneous pool was auctioned off. Additionally, the large heterogenous pool of loans can also be auctioned off and bid on by larger bidders.

In one embodiment the seller could structure the auction as an aggregate bid, which is also referred to as an All-or-None auction. The terms aggregate or All-or-None mean that in order for a bidder to win the auction, he must successfully bid on the entire loan portfolio, otherwise he wins none of the loans.

One way this could occur begins with the screen shot illustrated by FIG. 40, which is a representative screen shot of the Search Results Form illustrating a form that returns the search results for criteria selected by a bidder, in accordance with an embodiment of the present invention. As shown in FIG. 40, the system 30 returns the listed loan packages as satisfying a bidder's search criteria. By clicking or selecting each individual loan package, the auction system 30 will display certain information regarding that loan package. For example, if the bidder selects demo_aon 1300 in FIG. 40, the system 30 will display FIG. 41, showing that demo_aon 1320 is an aggregated offering which is comprised of two loan packages—“demo_{—}100 ” 1340 and “demo_{—}200 ” 1350. The total value of the aggregated loan is $36,860,597 because the sum of the two loans packages that comprise the demo_aon portfolio 1320 are valued at $28,282,620 for demo_{—}100 1340 and $8,577,977 for demo_{—}200 1350.

Alternatively, the bidder could choose to review individual loan packages. FIG. 42 depicts the first of six loans in the demo_{—}100 1330 loan package. Note that the outstanding balance of those six loans equals the value of the demo_{—}100 1330 portfolio.

Because the auction of the loan portfolio demo_aon 1320 is an aggregate or All-or-None offering comprised of the demo_{—}100 1340 and demo_{—}200 1350 loan packages, in order for one bidder to take the entire demo_aon 1320 portfolio, he would have to outbid the sum of the two closing bids on the demo_{—}100 1340 loan package and the demo_{—}200 1350 loan package. FIG. 43, which is a representative screen shot of the Related Auctions Status portion of the Bid Status Form as shown in FIG. 37, illustrates a form used by a Bidder or other user to keep track of all items they are interested in and/or have bid on, in accordance with an embodiment of the present invention. As illustrated in FIG. 43, the Bidder can see the High Bid 1400 for all three offerings that are related to the specific bid he is tracking (e.g., demo_{—}100 1410) using the Bid Status form in FIG. 37. For example, as illustrated in FIG. 43 the Bidder can view: the individual offerings demo_{—}100 1410 and demo_{—}200 1420; as well as the aggregate offering demo_aon 1420. Additionally, the auction system as illustrated in the Related Auction Status Form in FIG. 43 will inform the bidder what the sum 1440 of the high bids for the individual offerings are as compared to the highest bid 1400 for the aggregate offering. The auction system as illustrated by the Related Auction Status Form in FIG. 43 will also inform the bidder via the status portion 1450 whether or not the aggregate offering is currently the highest bid, or whether the sum of the individual loan packages making up the aggregate offering is the highest total.

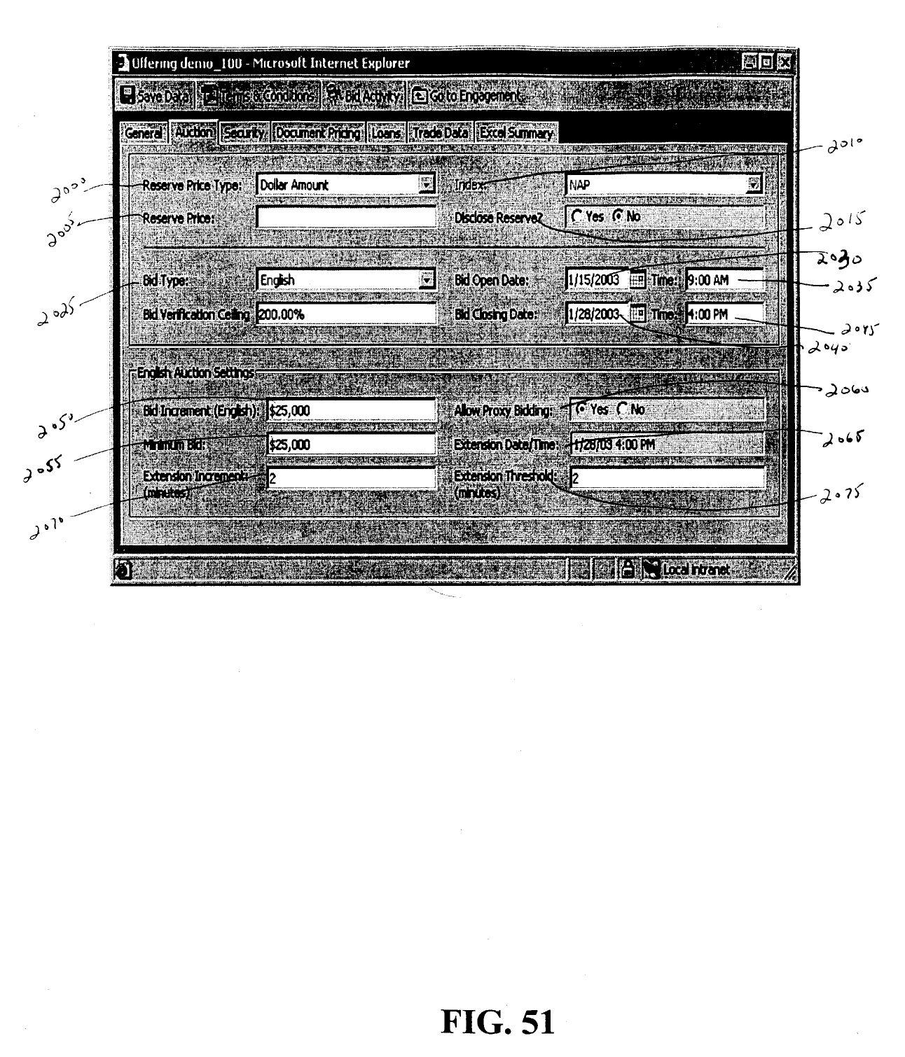

As discussed herein, the system 30 allows the Seller and/or the system administrator to select whether a given offering will be an aggregate sale or an individual sale (see FIG. 51). Once the Seller and/or system administrator sets how the item will be offered during the auction, the system 30 employs the Administration Components 44 to set the offering accordingly. The Administration Components 44 also provide other functional capabilities to the system administrator. For example, the system administrator can set how much information a Bidder or Seller gets to view about an auction. As described herein, the preferred system only allows any one bidder to view the current high bid and his own bid history, thereby preventing any bidder from seeing anyone else's bids. Operating an auction in this fashion typically results in the Seller receiving higher bids and pricing premiums than if the bidders were allowed to view each others' bids.

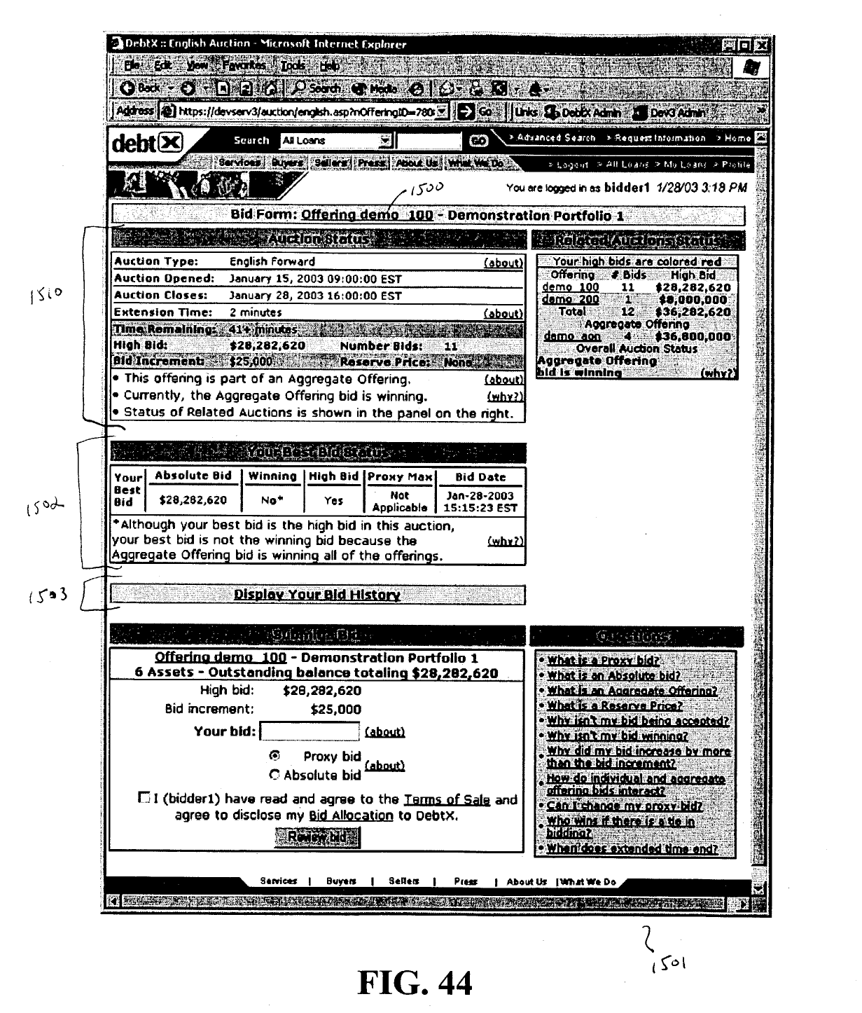

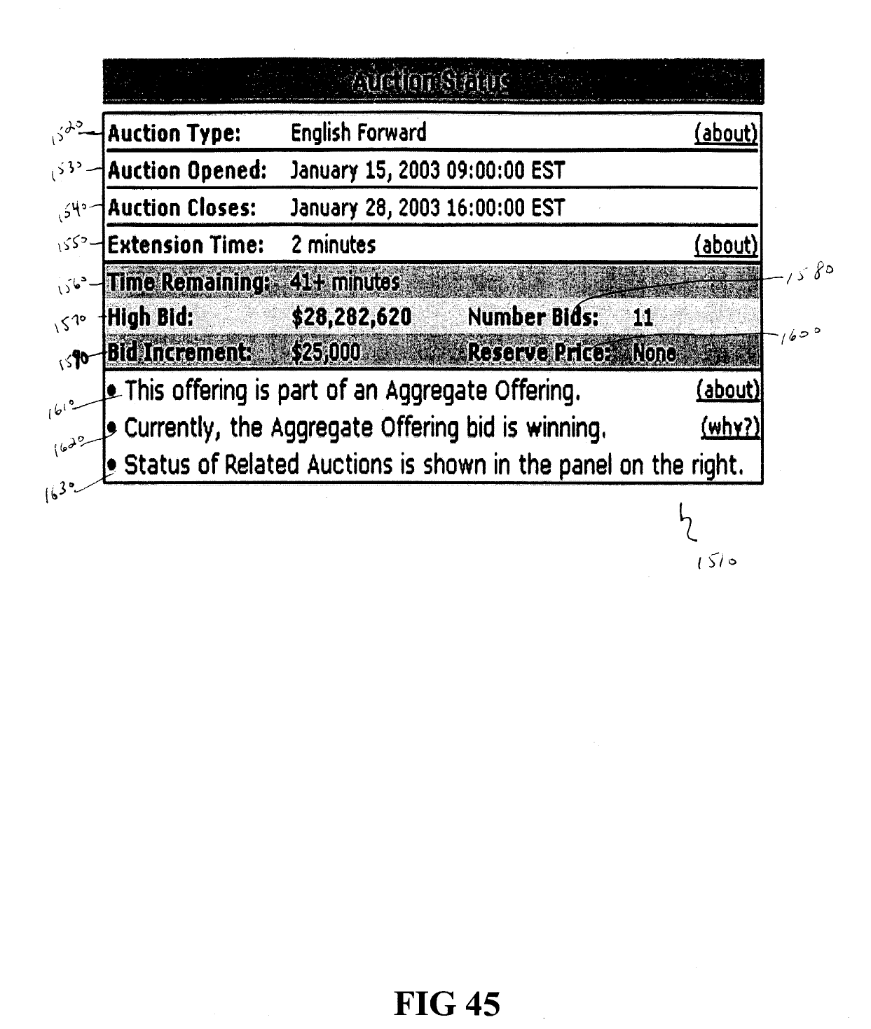

Another embodiment of the present invention involves the auction system 30 providing a bidder or a party tracking the progress of a given auction with updates on the status of that auction. For example, as illustrated generally by FIG. 44, which is a representative screen shot of the Bidder's Bid Form 1501 for a given loan which the user is tracking and/or bidding on, in accordance with an embodiment of the present invention, the product being tracked in FIG. 44 is the loan offering “demo_{—}100 ” 1500. FIG. 45, which is a representative screen shot of the Auction Status portion 1510 of the Bid Form shown in FIG. 44, is one of the components of the auction system 30 as illustrated in FIG. 44. The Auction Status portion 1510 of the Bid Form, as illustrated in FIG. 45, provides an update on a selected loan (e.g., demo_{—}100 ) to the user bidding and/or tracking that loan, in accordance with an embodiment of the present invention. Notably, FIG. 45 in regard to loan package demo_{—}100, informs the user as to: what type of auction it is 1520; when it opened 1530; when it closes 1540; the amount of extension time available 1550; the time remaining 1560; the current high bid 1570; the number of bids 1580; the bid increment 1590; whether there is a reserve price 1600; whether the offering is part of an Aggregate Offering 1610; whether the amount of the Aggregate Offering bid is greater than the sum of the individual bids 1620; and informs the Bidder that the status 1630 of the Related Auctions that he is interested in can be found in another portion of the Bid Form.

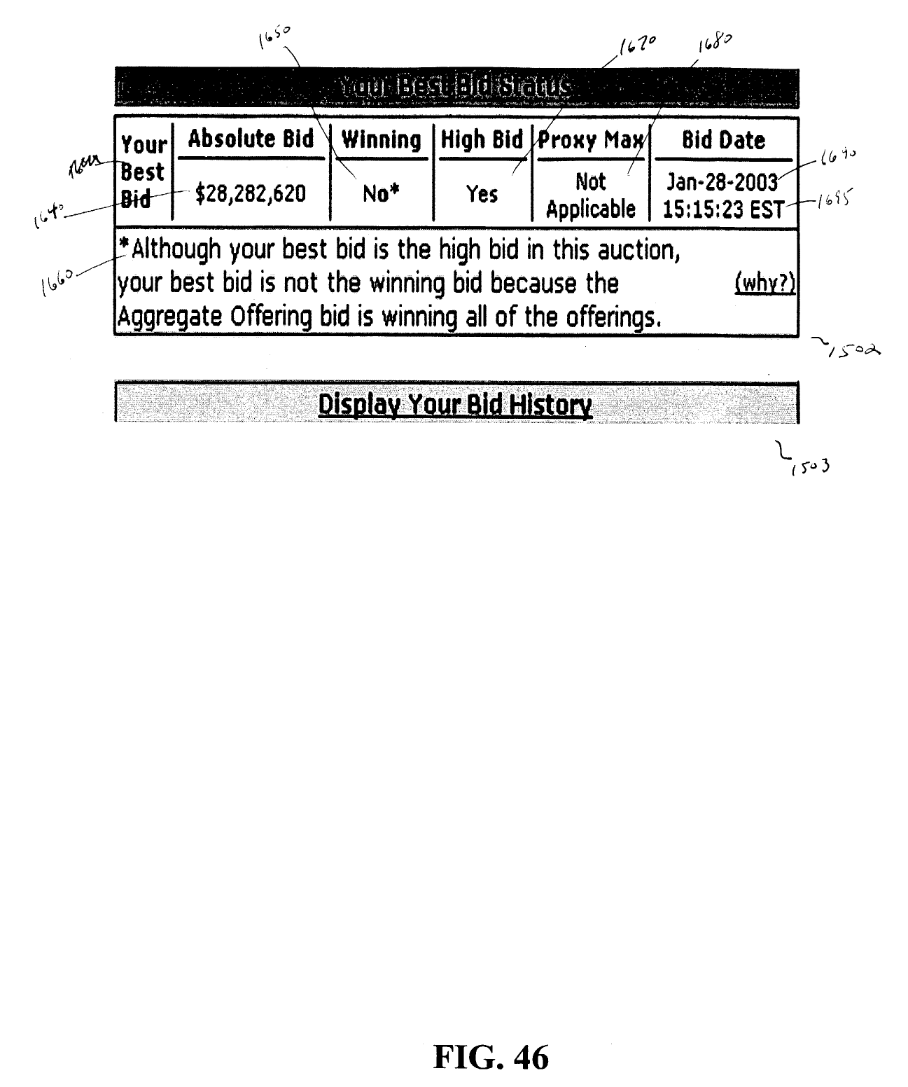

Another aspect of FIG. 44 is the Your Best Bid Status portion 1502. FIG. 46 is a representative screen shot of the Your Best Bid Status portion 1502 of FIG. 44, and displays for the Bidder certain information pertaining to his best bid on loan offering demo_{—}100. For example, it displays: the Bidder's best bid 1640 on the offering selected in FIG. 44; whether it is a currently winning bid 1650; if the bid in not the current winning bid, it provides an explanation 1660 as to why; whether it is the high bid 1670; what the Bidder's maximum proxy bid 1680 would be, if applicable; as well as the date 1690 and time 1695 of the his bid.

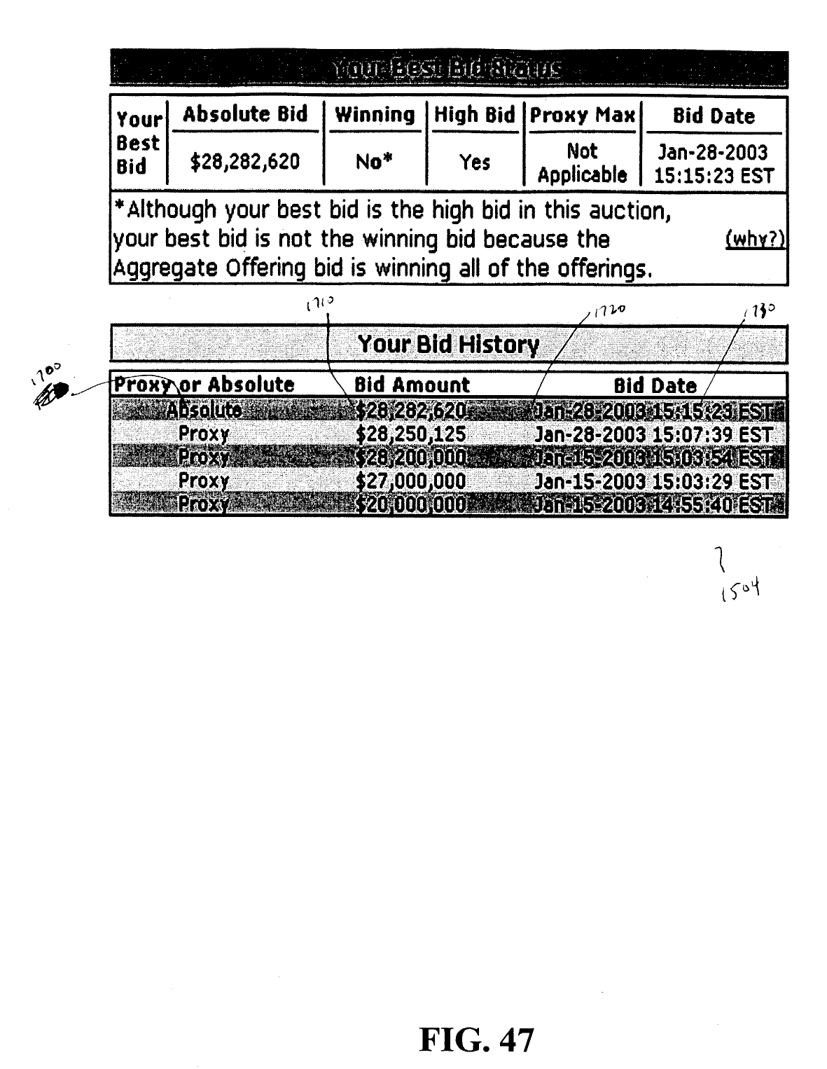

Another aspect of FIG. 44 is the Display Your Bid History link 1503. FIG. 46 is a representative screen shot of a portion of the Bid Status Form which provides the link 1503 to the display of the Bidder's history, in accordance with an embodiment of the present invention. For example, the auction system 30 displays, as illustrated in FIG. 46, what the relevant portion of the Bid Status screen would look like prior to the user selecting that link 1503. FIG. 47 is a representative screen shot of a portion of the Bid Status Form which provides the Your Bid History 1504 form, in accordance with an embodiment of the present invention.

For example, when the Bidder selects the Display Your Bid History link 1503 as illustrated in FIG. 46, in accordance with an embodiment of the present invention, the auction system 30 expands the Bid Status portion of the Bid Form and displays Your Bid History 1504, as shown in FIG. 47, all bids placed by the Bidder on a given loan, such as loan offering demo_{—}100. In one embodiment of the present invention the auction system 30 will provide the Bidder, as shown in FIG. 47, information regarding whether the bid on the product or service of interest was a Proxy or Absolute bid 1700; the bid amount 1710; and the bid time 1720 and date 1730. As discussed herein, the Bidder is only able to see his or her bid history and the bid history of any other Bidder.

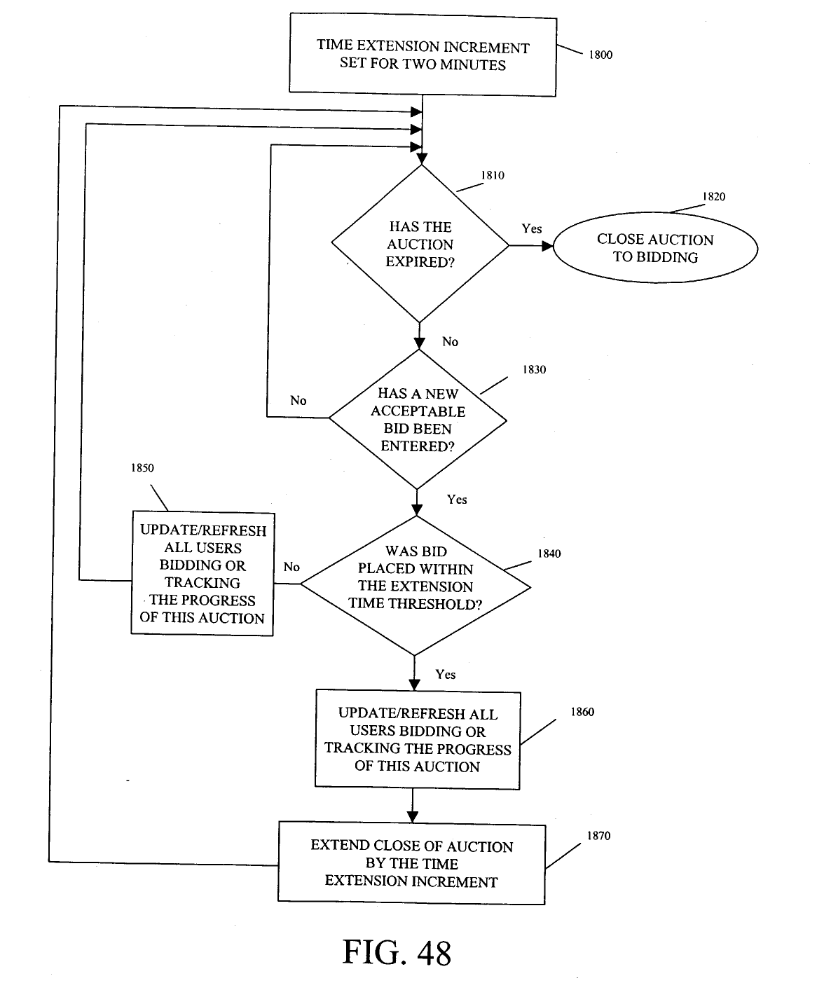

Another embodiment of the present invention concerns the ability of the system 30 to automatically extend the closing of given auction by a certain amount of time when a new bidder is either in the process of entering a bid, or has entered a bid within a predetermined period prior to the closing of the auction. For example, as illustrated in FIG. 48, which is a representative illustration of this time extension function of the auction system 30, in accordance with an embodiment of the present invention, the amount of time by which the closing of an auction of loan package demo_{—}100 can be extended is set by either the system administrator, the system 30 or the Seller (step 1800). For purposes of illustration only, the example illustrated in FIG. 48 contains a time extension increment equaling two minutes, and an extension time threshold equaling three minutes. Throughout the conduct of that auction, the auction system 30 checks to determine whether the time to submit a bid on demo_{—}100 has expired (step 1810). If the time in which to submit a bid has expired, the auction for loan package demo_{—}100 is closed to further bidding (step 1820).

If the auction for the loan package demo_{—}100 had not yet expired, the auction system 30 checks whether a new acceptable bid (i.e., exceeds the current high bid by at least the minimum bid) has been entered by any user bidding or tracking the progress of the auction of demo_{—}100 (step 1830). There are several embodiments in which this step can be accomplished. For example, for purposes of illustration only, the auction system 30 would only register that a new bid had been submitted if the Bidder actually typed in a bid in the “Your Bid” portion of the Submit A Bid Form (see FIG. 33) and clicked on the “Review Bid” link contained in the Submit A Bid Form. One skilled in the art would recognize that other embodiments are also possible.

If the auction system 30 determined that no bid had been entered, it would return to step 1810 and again determine whether the auction had expired. However, if the auction system 30 did determine that a new bid had been entered, the auction system 30 would then determine whether the Bidder placed that bid within the amount of time equal to or less than the time extension threshold value (step 1840). For example, if the time extension threshold was set to three minutes, and the time remaining before the auction closed equaled four minutes, then the bid had not been placed within the time extension threshold and the auction system 30 would return to step 1810 after updating and/or refreshing the status screens of all users tracking the progress of that auction (step 1850). Conversely, if the auction system 30 determined that a bid had been placed within thirty seconds of the auction closing, and was therefore within the three-minute time extension threshold, the auction system 30 would automatically update and/or refresh the status screens of all users tracking the progress of that auction (step 1860), and then the auction system would extend the closing of the auction by the time extension increment of two minutes (step 1870). Similarly, if the Bidder was attempting to place a bid thirty seconds before the close of the auction and was therefore within the time extension period, the auction system 30 would automatically extend the closing of the auction by the time extension increment of two minutes (step 1870). After extending the close of the auction by at least the time extension increment, if not by the sum of the time extension increment plus the time remaining prior to the close of the auction, the system 30 returns to step 1810. An alternative to steps 1850 and 1860 would be for the auction system 30 to update and/or refresh the screens of interested users after a predetermined time interval.

The preferred embodiment of the present invention includes the automatic extension feature to ensure that all bidders are able to continue submitting bids until they no longer want to participate. The automatic extension of the bidding feature benefits all the Bidders because they are not required to simply beat the other parties bidding in the same auction and see who could get their bid in closest to the closing of the auction. Instead, each Bidder can ensure their bid is accepted so long as it is entered prior to the close of the auction. The preferred embodiment of the present invention which includes the automatic extension feature also benefits Sellers because by not closing the bidding at an arbitrary time, at which point some bidders might be locked out, all bidders can continue to bid until the highest possible price is achieved for the product or service being offered. Because this preferred embodiment ensures that auctions only close when no bids have been submitted within a certain number of minutes of the auction closing, the auction will remain open until the bidding is done.

In one example of the system 30 employing the time extension embodiment, several auctions were held in which the time extension increment was set to five minutes. In one such auction the auction system 30 extended the closing of the auction three times for a total of fifteen extra minutes. These three extensions resulted in a two percent increase in proceeds to the Seller, and a sixteen percent increase in the total number of bids. In another such auction employing the time extension embodiment, the auction system 30 extended the closing of the auction twenty-four times for a total extension duration of one hundred and twenty minutes. These twenty-four extensions resulted in a thirteen percent increase in proceeds to the Seller, and a thirty-eight percent increase in the total number of bids.

As discussed herein and in the cross-referenced applications, the auction system 30 allows the system administrator to monitor the activity of all users. These users can be tracked by the user's information stored in and handled by, for example, the available databases 46-50, the Content Management System 38, the Custom Application Components 40 and the Administration Components 44. Similarly, the Sellers can use these modules and databases to track the progress of any selected auction it chooses. Moreover, the auction system 30 provides the ability for sellers and administrators to watch auction activity for all bidders on a live basis as the auction transpires.

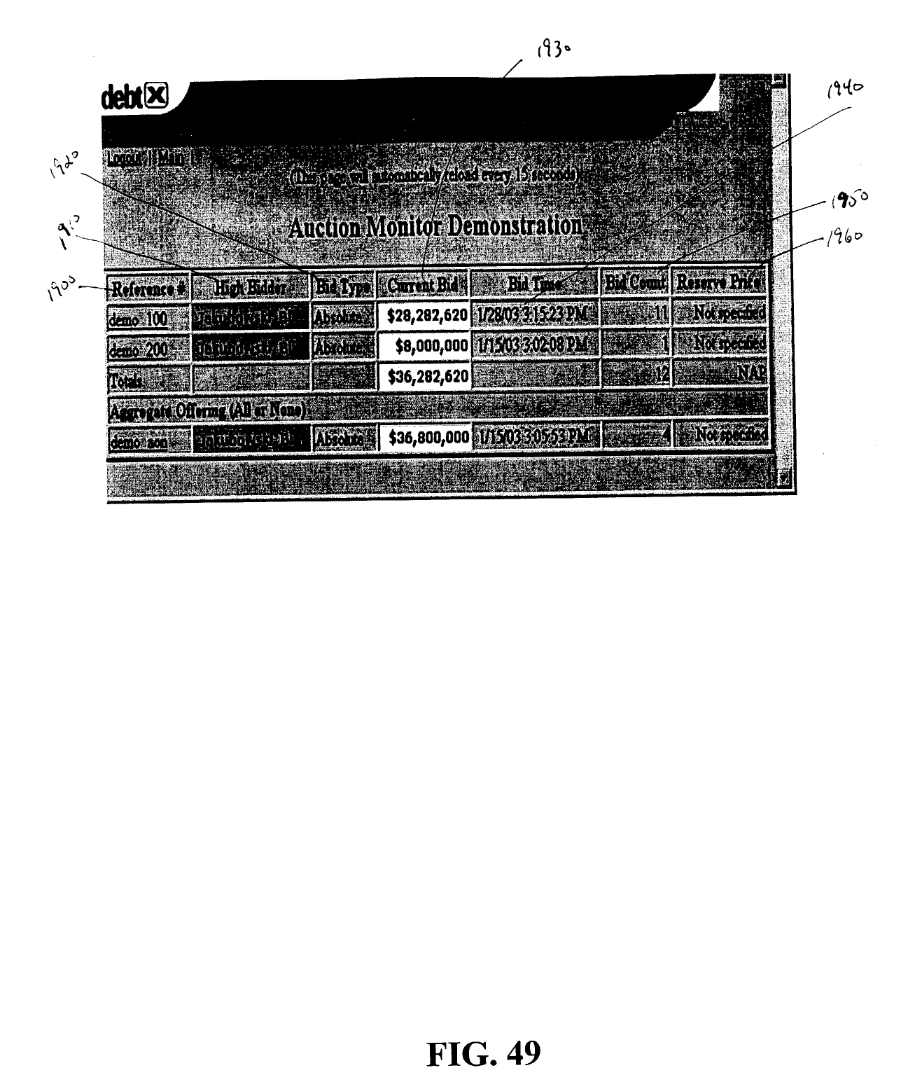

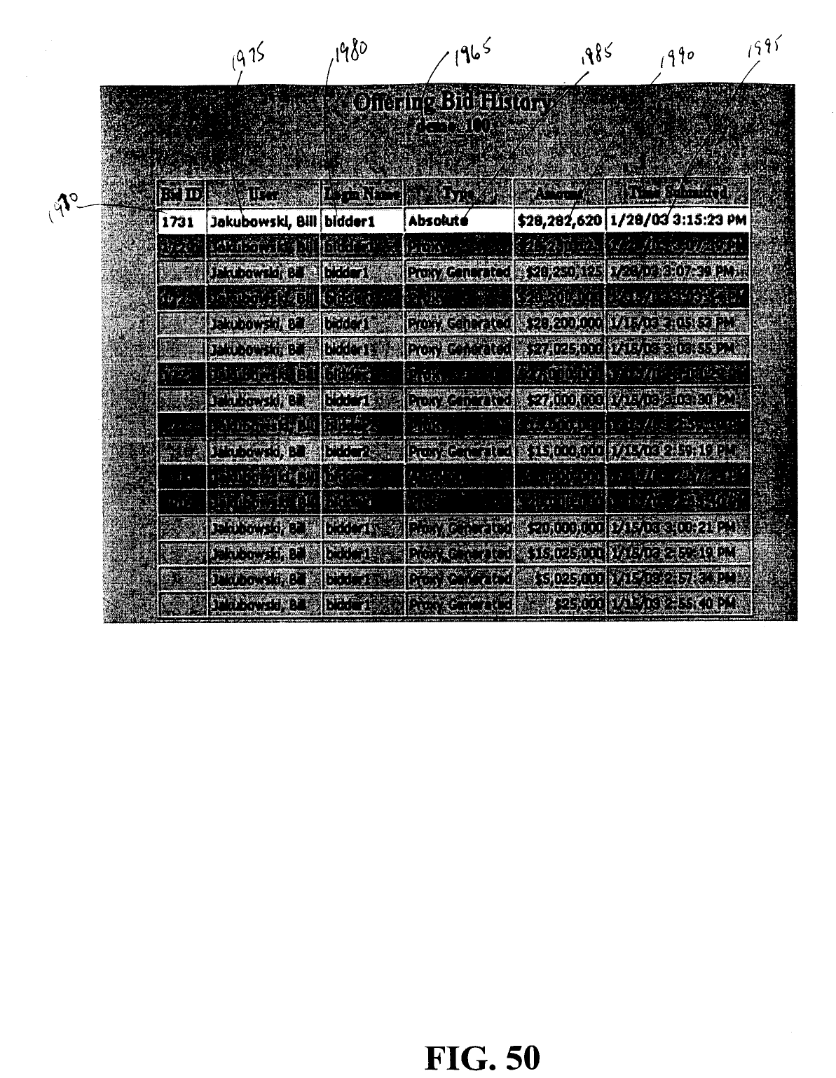

FIG. 49 is a representative screen shot of the summary view of the Auction Monitor Form, in accordance with an embodiment of the present invention. Similarly, FIG. 50 is a representative screen shot of the Offering Bid History which provides a detailed view of the bidding history of a specific product or service being auctioned, in accordance with an embodiment of the present invention. In an embodiment of present invention, the auction system 30 includes reporting capabilities in the form of EXCEL data export functions which can be communicated to the modules described herein. The Auction Monitor Form (see FIG. 49) and the Offering Bid History form (see FIG. 50) include the update and/or auto-refresh function described herein, in that these forms are automatically refreshed and updated either periodically or each time a new bid is accepted by the auction system 30. Refreshing the Auction Monitor Form and the Offering Bid History form ensures that not only the Bidders possess the most up to date information, but the Sellers and the system administrators possess that updated information as well.

As illustrated by FIG. 49 and FIG. 50, the auction system can display to the Sellers and the system administrators information which includes: title information; login status (e.g., login name, date, time); logout button; navigation to one or multiple offerings; navigation to offering list; and an auction clock (countdown time remaining). The summary information that could be displayed to the Seller and system administrator regarding the loans currently being auctioned (see FIG. 49) could include: the reference name for each loan 1900; the high bidder on that loan 1910; the type of auction it is 1920; the current high bid for that auction 1930; the date and time the high bidder placed its bid 1940; the number of bids placed 1950; and the reserve price associated with the item 1960 (if applicable). Similarly, the auction system 30 could provide detailed information for each summarized product or service. As illustrated in FIG. 50 for the financial product “demo_{—}100,” this detailed information could include: the loan identifier 1965; the identifier assigned to each bid on that offering 1970; the user placing that bid 1975; the login name associated with that user 1980; the type of bid placed 1985; the amount bid 1990; and the time and date 1995 each bid was placed.

The auction system 30 also allows the system administrator and/or seller with the proper privileges to configure the necessary settings for an auction of products and services. For example, FIG. 51 is a representative screen shot of the Setup Form for the loan package “demo_{—}100,” in accordance with an embodiment of the present invention. One embodiment of the present invention illustrates that the system administrator and/or seller can access and set at least the following attributes of a product or service being auctioned: reserve price type 2000; reserve price 2005; index 2010; whether the reserve should be disclosed 2015; bid type 2020; bid verification ceiling 2025; bid open date 2030 and time 2035; bid closing date 2040 and time 2045; bid increment 2050; minimum bid 2055; whether proxy bidding is allowed 2060; the time extension increment 2065; at what point the extension time threshold should begin 2070; and the amount of time the extension time threshold should be set at 2075.

By posting products and services to websites and portals associated with some embodiments of the invention, sellers of various products and services, and in particular financial products, are able to reach the broadest qualified investor audience in the most efficient manner. In addition, buyers of products and services, in particular buyers and investors in financial products, benefit from the ability to access and evaluate investment opportunities, from a central location.

Variations, modifications, and other implementations of what is described herein will occur to those of ordinary skill in the art without departing from the spirit and the scope of the invention as claimed.

It should be understood that virtually any aspect of the embodiments of the invention described herein can be implemented using software, hardware, or in a combination of hardware and software. For example, at least the listed descriptions of “logic,” referenced herein can be implemented in hardware, software or a combination.

As those skilled in the art will recognize, the invention described herein can be modified to accommodate and/or comply with any one or more of the above-described technologies and standards. In addition, variations, modifications, and other implementations of what is described herein can occur to those of ordinary skill in the art without departing from the spirit and the scope of the invention as claimed.

It should be understood that, in the Figures of this application, in some instances, a plurality of system elements or method steps may be shown as illustrative of a particular system element, and a single system element or method step may be shown as illustrative of a plurality of a particular systems elements or method steps. It should be understood that showing a plurality of a particular element or step is not intended to imply that a system or method implemented in accordance with the invention must comprise more than one of that element or step, nor is it intended by illustrating a single element or step that the invention is limited to embodiments having only a single one of that respective elements or steps. In addition, the; total number of elements or steps shown for a particular system element or method is not intended to be limiting; those skilled in the art will recognize that the number of a particular system element or method steps can, in some instances, be selected to accommodate the particular user needs.

It also should be noted that the previous illustrations of screen shots, together with the accompanying descriptions, are provided by way of example only and are not limiting. Those skilled in the art will recognize that many different designs of interfaces, screen shots, navigation patterns, and the like, are within the spirit and scope of the invention.

Although the invention has been described and pictured in a preferred form with a certain degree of particularity, it is understood that the present disclosure of the preferred form, has been made only by way of example, and that numerous changes in the details of construction and combination and arrangement of parts may be made without departing from the spirit and scope of the invention as hereinafter claimed.

1. A method for trading items over a computer network, comprising:
offering an item received from a seller in an auction;
receiving a bid for the item being offered;
displaying a received bid to all users of the auction; and
extending the closing of the auction by a period of time if a new bid is received during a predetermined period of time prior to the closing of the auction.

2. The method of claim 1 wherein the step of offering an item further comprises allowing a bidder to bid on a portion of the item or bid on the item in aggregate.

3. The method of claim 1 further comprising the step of updating the display of the received bid to display the current highest bid.

4. The method of claim 1 wherein the step of displaying a received bid further comprises revealing the bid history for the item to selected users.

5. The method of claim 1 further comprising the step of tracking a bidder by their identifying information.

6. A method for trading financial products over a computer network, comprising:
receiving seller information from a first client, the seller information relating to a financial product offered for sale on behalf of a seller, at least some of the seller information comprising due diligence information, the due diligence information capable of fulfilling at least a portion of a request for due diligence on the financial product;
storing the seller information about the financial product in a database;
providing a second client with an opportunity to obtain the due diligence information on behalf of a potential buyer of the financial product; and
storing a bid for the financial product from the second client in the database, if it can be shown that second client has obtained the due diligence information.

7. A computerized exchange for trading items, wherein the exchange is accessible using a computer network, comprising:
a server in operable communication with a bidder, the server programmed for receiving requests from a bidder to accept a bid for an item offered for sale;
a product and service information database in communication with the server for retrieving information on items meeting the bidder's search criteria; and
customer application components for accepting and displaying bids received from the bidder on the items meeting the bidder's search criteria.

8. A computerized exchange for trading financial products, wherein the exchange is accessible using a computer network, comprising:
a server in operable communication with a client, the server programmed for receiving requests from a client to price a financial product offered for sale;
a pricing engine in communication with the server, the pricing engine computing a price for the financial product offered for sale, the price based at least in part on at least one of the following: market information, information that the seller has provided about the financial product. information that the client provides about the financial product, due diligence information, and trade history information; and
a database storing information relating to the least one financial product offered for sale and the computed price for that financial product.

9. A computerized system for trading financial products, comprising:
means for receiving information about at least one item for sale, the information, including due diligence information capable of fulfilling at least a portion of a request for due diligence on the financial product;
means for displaying the information about the item to parties interested in purchasing items that match certain criteria;
means for determining whether the bid on the item is acceptable; and
means for displaying the bid information to users of the system once the bid has been accepted on the item.

10. A computerized system for trading financial products, comprising:
means for receiving information about at least one financial product for sale, the information, including due diligence information capable of fulfilling at least a portion of a request for due diligence on the financial product;
means for computing a price on the financial product, the price based at least in part on at least one of the following: market information, information received about the financial product, due diligence information, and trade history information;
means for providing a potential bidder on the financial product with the due diligence information and a price for the financial product; and
means for storing a bid on the financial product if the bidder has received the due diligence information on the financial product.
